(19) United States
(12) Patent Application Publication
(10) Pub. No.: US 2012/0081009 A1
(43) Pub. Date: Apr. 5, 2012

(54) Apparatus, Method and System for Providing AC Line Power to Lighting Devices

(75) Inventors: Anatoly Shteynberg, San Jose, CA (US); Dongsheng Zhou, San Jose, CA (US); Stephen F. Dreyer, Santa Clara, CA (US); Harlan Ohara, San Jose, CA (US); Sinan Doluca, Saratoga, CA (US)

(73) Assignee: EXCLARA INC., Santa Clara, CA (US)

(21) Appl. No.: 13/283,201

(22) Filed: Oct. 27, 2011

Related U.S. Application Data
(63) Continuation-in-part of application No. 12/478,293, filed on Jun. 4, 2009.
Application No. 12/478,293 is a continuation-in-part of application No. 12/729,081, filed on Mar. 22, 2010.
Application No. 12/729,081 is a continuation-in-part of application No. 12/478,293, filed on Jun. 4, 2009.
(60) Provisional application No. 61/491,062, filed on May 27, 2011.

(51) Int. Cl. H05B 37/02

(52) U.S. Cl. 315/122

(57) ABSTRACT

An apparatus, method and system are disclosed for providing AC line power to lighting devices such as light emitting diodes (“LEDs”). An exemplary apparatus comprises: a plurality of LEDs coupled in series to form a plurality of segments of LEDs; first and second current regulators; a current sensor; and a controller to monitor a current level through a series LED current path, and to provide for first or second segments of LEDs to be in or out of the series LED current path at different current levels. A voltage regulator is also utilized to provide a voltage during a zero-crossing interval of the AC voltage. In an exemplary embodiment, first and second segments of LEDs are both in the series LED current path regulated at a lower current level compared to when only the first segment of LEDs is in the series LED current path.

### CROSS-REFERENCE TO RELATED APPLICATIONS

This application is a conversion of and claims priority to U.S. Provisional patent application Ser. No. 61/491,062, filed May 27, 2011 (the “first related application”), and is a continuation-in-part of and claims priority to Anatoly Shteynberg et al., U.S. patent application Ser. No. 12/729,081, filed Mar. 22, 2010, entitled “Apparatus, Method and System for Providing AC Line Power to Lighting Devices” (the “second related application”), and also is a continuation-in-part of and claims priority to Anatoly Shteynberg et al., U.S. patent application Ser. No. 12/478,293, filed Jun. 4, 2009, entitled “Apparatus, Method and System for Providing AC Line Power to Lighting Devices” (the “third related application”), which are commonly assigned herewith, the entire contents of which are incorporated herein by reference with the same full force and effect as if set forth in their entireties herein, and with priority claimed for all commonly disclosed subject matter. The second related application, U.S. patent application Ser. No. 12/729,081, is also a continuation-in-part of and claims priority to the third related application, U.S. patent application Ser. No. 12/478,293.

### FIELD OF THE INVENTION

The present invention in general is related to power conversion, and more specifically, to a system, apparatus and method for providing AC line power to lighting devices, such as light emitting diodes (“LEDs”).

### BACKGROUND OF THE INVENTION

Widespread proliferation of solid state lighting systems (semiconductor, LED-based lighting sources) has created a demand for highly efficient power converters, such as LED drivers, with high conversion ratios of input to output voltages, to provide corresponding energy savings. A wide variety of off-line LED drivers are known, but are unsuitable for direct replacement of incandescent bulbs or compact fluorescent bulbs utilizable in a typical “Edison” type of socket, such as for a lamp or household lighting fixture, which is couplable to an alternating current (“AC”) input voltage, such as a typical (single-phase) AC line (or AC mains) used in a home or business.

Early attempts at a solution have resulted in prior art LED drivers which are non-isolated, have low efficiency, deliver relatively low power, and at most can deliver a constant current to the LEDs with no temperature compensation, no dimming arrangements or compatibility with existing prior art dimmer switches, and no voltage or current protection for the LEDs. In order to reduce the component count, such converters may be constructed without isolation transformers by using two-stage converters with the second stage running at a very low duty cycle (equivalently referred to as a duty ratio), thereby limiting the maximum operating frequency, resulting in an increase in the size of the converter (due to the comparatively low operating frequency), and ultimately defeating the purpose of removing coupling transformers. In other instances, the LED drivers utilize high brightness LEDs, requiring comparatively large currents to produce the expected light output, resulting in reduced system efficiency and increased energy costs.

Other prior art LED drivers are overly complicated. Some require control methods that are complex, some are difficult to design and implement, and others require many electronic components. A large number of components results in an increased cost and reduced reliability. Many drivers utilize a current mode regulator with a ramp compensation in a pulse width modulation (“PWM”) circuit. Such current mode regulators require relatively many functional circuits, while nonetheless continuing to exhibit stability problems when used in the continuous current mode with a duty cycle or ratio over fifty percent. Various prior art attempts to solve these problems utilized a constant off-time boost converter or hysteretic pulse train booster. While these prior art solutions addressed problems of instability, these hysteretic pulse train converters exhibited other difficulties, such as elevated electromagnetic interference, inability to meet other electromagnetic compatibility requirements, and relative inefficiency. Other attempts provide solutions outside the original power converter stages, adding additional feedback and other circuits, rendering the LED driver even larger and more complicated.

Another proposed solution provides a reconfigurable circuit to provide a preferred number of LEDs in each circuit based on a sensed voltage, but is also overly complicated, with a separate current regulator for each current path, with its efficiency compromised by its requirement of a significant number of diodes for path breaking Such complicated LED driver circuits result in an increased cost which renders them unsuitable for use by consumers as replacements for typical incandescent bulbs or compact fluorescent bulbs.

Other prior art LED bulb replacement solutions are incapable of responding to different input voltage levels. Instead, multiple, different products are required, each for different input voltage levels (110V, 110V, 220V, 230V).

This is a significant problem in many parts of the world, however, because typical AC input voltage levels have a high variance (of RMS levels), such as ranging from 85V to 135V for what is supposed to be 110V. As a consequence, in such prior art devices, output brightness varies significantly, with a variation of 85V to 135V resulting in a 3-fold change in output luminous flux. Such variations in output brightness are unacceptable for typical consumers.

Another significant problem with prior art devices used with a standard AC input voltage is significant underutilization: because of the variable applied AC voltage, the LEDs are not conducting during the entire AC cycle. More specifically, when the input voltage is comparatively low during the AC cycle, there is no LED current, and no light emitted. For example, there may only be LED current during the approximately middle third of a rectified AC cycle, with no LED current during the first and last 60 degrees of a 180 degree rectified AC cycle. In these circumstances, LED utilization may be as low as twenty percent, which is comparatively very low, especially given the comparatively high costs involved.

There are myriad other issues with prior art attempts at LED drivers for consumer applications. For example, some require the use of a large, expensive resistor to limit the excursion of current, resulting in corresponding power losses, which can be quite significant and which may defeat some of the purposes of switching to solid state lighting.

Accordingly, a need remains for an apparatus, method and system for supplying AC line power to one or more LEDs, including LEDs for high brightness applications, while simultaneously providing an overall reduction in the size and cost of the LED driver and increasing the efficiency and utilization of LEDs. Such an apparatus, method and system should be able to function properly over a relatively wide AC input voltage range, while providing the desired output voltage or current, and without generating excessive internal voltages or placing components under high or excessive voltage stress. In addition, such an apparatus, method and system should provide significant power factor correction when connected to an AC line for input power. Also, it would be desirable to provide such an apparatus, method and system for controlling brightness, color temperature and color of the lighting device.

### SUMMARY OF THE INVENTION

The exemplary embodiments of the present invention provide numerous advantages for supplying power to non-linear loads, such as LEDs. The various exemplary embodiments supply AC line power to one or more LEDs, including LEDs for high brightness applications, while simultaneously providing an overall reduction in the size and cost of the LED driver and increasing the efficiency and utilization of LEDs. Exemplary apparatus, method and system embodiments adapt and function properly over a relatively wide AC input voltage range, while providing the desired output voltage or current, and without generating excessive internal voltages or placing components under high or excessive voltage stress. In addition, various exemplary apparatus, method and system embodiments provide significant power factor correction when connected to an AC line for input power. Exemplary embodiments also substantially reduce the capacitance at the output of the LEDs, thereby significantly improving reliability. Lastly, various exemplary apparatus, method and system embodiments provide the capability for controlling brightness, color temperature and color of the lighting device.

Indeed, several significant advantages of the exemplary embodiment should be emphasized. First, exemplary embodiments are capable of implementing power factor correction, which results both in a substantially increased output brightness and significant energy savings. Second, the utilization of the LEDs is quite high, with at least some LEDs in use during the vast majority of every part of an AC cycle. With this high degree of utilization, the overall number of LEDs may be reduced to nonetheless produce a light output comparable to other devices with more LEDs.

An exemplary method embodiment is disclosed for providing power to a plurality of light emitting diodes couplable to receive an AC voltage, the plurality of light emitting diodes coupled in series to form a plurality of segments of light emitting diodes each comprising at least one light emitting diode, with the plurality of segments of light emitting diodes coupled to a corresponding plurality of switches to switch a selected segment of light emitting diodes into or out of a series light emitting diode current path. This exemplary method embodiment comprises: monitoring a first parameter; during a first part of an AC voltage interval, when the first parameter has reached a first predetermined level, switching a corresponding segment of light emitting diodes into the series light emitting diode current path; and during a second part of the AC voltage interval, when the first parameter has decreased to a second predetermined level, switching a corresponding segment of light emitting diodes out of the series light emitting diode current path.

In an exemplary embodiment, the first parameter is a current level of the series light emitting diode current path. In various exemplary embodiments, the method may further comprise maintaining the current level of the series light emitting diode current path substantially constant at the first predetermined level. Also in various exemplary embodiments, the method may further comprise: during the first part of an AC voltage interval, when the first parameter has reached a third predetermined level, switching a next corresponding segment of light emitting diodes into the series light emitting diode current path, and during a second part of the AC voltage interval, when the first parameter has decreased to a fourth predetermined level, switching a corresponding segment of light emitting diodes out of the series light emitting diode current path.

Various exemplary method embodiments may also further comprise: during the first part of the AC voltage interval, as a light emitting diode current successively reaches a predetermined peak level, successively switching a corresponding segment of light emitting diodes into the series light emitting diode current path; and during the second part of the AC voltage interval, as the rectified AC voltage level decreases to a corresponding voltage level, switching the corresponding segment of light emitting diodes out of the series light emitting diode current path. In various exemplary embodiments, the switching of the corresponding segment of light emitting diodes out of the series light emitting diode current path is in a reverse order to the switching of the corresponding segment of light emitting diodes into the series light emitting diode current path.

In an exemplary method embodiment, time or time intervals may be utilized as parameters. For example, the first parameter and the second parameter may be time, or one or more time intervals, or time-based, or one or more clock cycle counts. Also for example, the exemplary method embodiment may further comprise: determining a first plurality of time intervals corresponding to a number of segments of light emitting diodes for the first part of the AC voltage interval; and determining a second plurality of time intervals corresponding to the number of segments of light emitting diodes for the second part of the AC voltage interval. For such an exemplary embodiment, the method may further include, during the first part of the AC voltage interval, at the expiration of each time interval of the first plurality of time intervals, switching a next segment of light emitting diodes into the series light emitting diode current path; and during the second part of the AC voltage interval, at the expiration of each time interval of the second plurality of time intervals, in a reverse order, switching the next segment of light emitting diodes out of the series light emitting diode current path.

Various exemplary method embodiments may also further comprise determining whether the AC voltage is phase modulated, such as by a dimmer switch. Such an exemplary method embodiment may further comprise, when the AC voltage is phase modulated, switching a segment of light emitting diodes into the series light emitting diode current path which corresponds to a phase modulated AC voltage level; or when the AC voltage is phase modulated, switching a segment of light emitting diodes into the series light emitting diode current path which corresponds to a time interval of the phase modulated AC voltage. In addition, exemplary method embodiments, when the AC voltage is phase modulated, may further comprise maintaining a parallel light emitting diode current path through a first switch concurrently with switching a next segment of light emitting diodes into the series light emitting diode current path through a second switch.

Various exemplary method embodiments may also further comprise determining whether the AC voltage is phase modulated. The method may further comprise, when the AC voltage is phase modulated, switching a segment of light emitting diodes into the series light emitting diode current path which corresponds to a phase modulated AC voltage level; when the AC voltage is phase modulated, switching a segment of light emitting diodes into the series light emitting diode current path which corresponds to a phase modulated AC current level; when the AC voltage is phase modulated, switching a segment of light emitting diodes into the series light emitting diode current path which corresponds to a time interval of the phase modulated AC voltage; or when the AC voltage is phase modulated, maintaining a parallel light emitting diode current path through a first switch concurrently with switching a next segment of light emitting diodes into the series light emitting diode current path through a second switch.

Various exemplary embodiments may also provide for power factor correction. Such an exemplary method embodiment may further comprise determining whether sufficient time remains in the first part of the AC voltage interval for a light emitting diode current to reach a predetermined peak level if a next segment of light emitting diodes is switched into the series light emitting diode current path, and when sufficient time remains in the first part of the AC voltage interval for the light emitting diode current to reach the predetermined peak level, switching the next segment of light emitting diodes into the series light emitting diode current path. Similarly, when sufficient time does not remain in the first part of the AC voltage interval for the light emitting diode current to reach the predetermined peak level, the exemplary method embodiment may further include not switching the next segment of light emitting diodes into the series light emitting diode current path.

Also in various exemplary embodiments, the method may further comprise: switching a plurality of segments of light emitting diodes to form a first series light emitting diode current path; and switching a plurality of segments of light emitting diodes to form a second series light emitting diode current path in parallel with the first series light emitting diode current path.

In an exemplary embodiment, selected segments of light emitting diodes of the plurality of segments of light emitting diodes may each comprise light emitting diodes having light emission spectra of different colors or wavelengths. For such an exemplary embodiment, the method may further comprise selectively switching the selected segments of light emitting diodes into the series light emitting diode current path to provide a corresponding lighting effect, and/or selectively switching the selected segments of light emitting diodes into the series light emitting diode current path to provide a corresponding color temperature.

In an exemplary embodiment, an apparatus is disclosed which is couplable to receive an AC voltage, with the apparatus comprising: a rectifier to provide a rectified AC voltage; a plurality of light emitting diodes coupled in series to form a plurality of segments of light emitting diodes; a plurality of switches correspondingly coupled to the plurality of segments of light emitting diodes to switch a selected segment of light emitting diodes into or out of a series light emitting diode current path; a current sensor to sense a light emitting diode current level; and a controller coupled to the plurality of switches and to the current sensor, the controller, during a first part of a rectified AC voltage interval and when the light emitting diode current level has increased to a first predetermined current level, to switch a corresponding segment of light emitting diodes into the series light emitting diode current path; and during a second part of a rectified AC voltage interval and when the light emitting diode current level has decreased to a second predetermined current level, the controller to switch the corresponding segment of light emitting diodes out of the series light emitting diode current path.

In an exemplary embodiment, the controller further is to maintain the light emitting diode current level substantially constant at the first predetermined level. During the first part of an AC voltage interval, when the light emitting diode current level has reached a third predetermined level, the controller further is to switch a next corresponding segment of light emitting diodes into the series light emitting diode current path, and during a second part of the AC voltage interval, when the light emitting diode current level has decreased to a fourth predetermined level, the controller further is to switch a corresponding segment of light emitting diodes out of the series light emitting diode current path.

In such an exemplary apparatus embodiment, the apparatus may further comprise a plurality of resistors, each resistor of the plurality of resistors coupled in series to a corresponding switch of the plurality of switches. Each resistor may be coupled on a high voltage side of the corresponding switch, or each resistor may be coupled on a low voltage side of the corresponding switch. The exemplary apparatus may further comprise a switch and a resistor coupled in series with at least one segment of light emitting diodes of the plurality of segments of light emitting diodes.

In an exemplary embodiment, an ultimate segment of light emitting diodes of the plurality of segments of light emitting diodes is always coupled in the series light emitting diode current path. The controller may be further coupled to a plurality of segments of light emitting diodes to receive corresponding node voltage levels. In another exemplary embodiment, at least one switch of the plurality of switches is coupled to the rectifier to receive the rectified AC voltage.

In another exemplary apparatus embodiment, during the first part of the rectified AC voltage interval, as the light emitting diode current level reaches the predetermined peak level, the controller further may determine and store a corresponding value of the rectified AC voltage level and successively switch a corresponding segment of light emitting diodes into the series light emitting diode current path; and during the second part of a rectified AC voltage interval, as the rectified AC voltage level decreases to a corresponding value, the controller further may switch the corresponding segment of light emitting diodes out of the series light emitting diode current path, and may do so in a reverse order to the switching of the corresponding segments of light emitting diodes into the series light emitting diode current path.

In various exemplary embodiments, the controller further may determine whether the rectified AC voltage is phase modulated. In such an exemplary embodiment, the controller, when the rectified AC voltage is phase modulated, further may switch a segment of light emitting diodes into the series light emitting diode current path which corresponds to the rectified AC voltage level, or may switch a segment of light emitting diodes into the series light emitting diode current path which corresponds to a time interval of the rectified AC voltage level. In another exemplary apparatus embodiment, the controller, when the rectified AC voltage is phase modulated, further may maintain a parallel light emitting diode current path through a first switch concurrently with switching a next segment of light emitting diodes into the series light emitting diode current path through a second switch.

In various exemplary embodiments, the controller may also implement a form of power factor correction. In such an exemplary apparatus embodiment, the controller further may determine whether sufficient time remains in the first part of the rectified AC voltage interval for the light emitting diode current level to reach the predetermined peak level if a next segment of light emitting diodes is switched into the series light emitting diode current path. For such an exemplary embodiment, the controller, when sufficient time remains in the first part of the rectified AC voltage interval for the light emitting diode current level to reach the predetermined peak level, further may switch the next segment of light emitting diodes into the series light emitting diode current path; and when sufficient time does not remain in the first part of the rectified AC voltage interval for the light emitting diode current level to reach the predetermined peak level, the controller further may not switch the next segment of light emitting diodes into the series light emitting diode current path.

In another exemplary embodiment, the controller further is to switch a plurality of segments of light emitting diodes to form a first series light emitting diode current path, and to switch a plurality of segments of light emitting diodes to form a second series light emitting diode current path in a parallel with the first series light emitting diode current path.

In various exemplary embodiments, the apparatus may operate at a rectified AC voltage frequency of substantially about 100 Hz, 120 Hz, 300 Hz, 360 Hz, or 400 Hz. In addition, the apparatus may further comprise a plurality of phosphor coatings or layers, with each phosphor coating or layer coupled to a corresponding light emitting diode of the plurality of light emitting diodes, and with each phosphor coating or layer having a luminous or light emitting decay time constant between about 2 to 3 msec.

Another exemplary apparatus is couplable to receive an AC voltage, with the apparatus comprising: a first plurality of light emitting diodes coupled in series to form a first plurality of segments of light emitting diodes; a first plurality of switches coupled to the first plurality of segments of light emitting diodes to switch a selected segment of light emitting diodes into or out of a first series light emitting diode current path in response to a control signal; a current sensor to determine a light emitting diode current level; and a controller coupled to the plurality of switches and to the current sensor, the controller, during a first part of an AC voltage interval and in response to the light emitting diode current level, to generate a first control signal to switch a corresponding segment of light emitting diodes of the first plurality of segments of light emitting diodes into the first series light emitting diode current path; and during a second part of the AC voltage interval and in response to the light emitting diode current level, to switch a corresponding segment of light emitting diodes of the first plurality of segments of light emitting diodes out of the first series light emitting diode current path.

In an exemplary apparatus embodiment, the apparatus may further comprise: a second plurality of light emitting diodes coupled in series to form a second plurality of segments of light emitting diodes; and a second plurality of switches coupled to the second plurality of segments of light emitting diodes to switch a selected segment of the second plurality of segments of light emitting diodes into or out of a second series light emitting diode current path; wherein the controller is further coupled to the second plurality of switches, and further is to generate corresponding control signals to switch a plurality of segments of the second plurality of segments of light emitting diodes to form the second series light emitting diode current path in parallel with the first series light emitting diode current path. The second series light emitting diode current path may have a polarity opposite the first series light emitting diode current path, or a first current flow through the first series light emitting diode current path has an opposite direction to second current flow through the second series light emitting diode current path.

In yet another of the various exemplary embodiments, the apparatus may further comprise a current limiting circuit; a dimming interface circuit; a DC power source circuit coupled to the controller, and/or a temperature protection circuit.

Another exemplary method embodiment is disclosed for providing power to a plurality of light emitting diodes couplable to receive an AC voltage, the plurality of light emitting diodes coupled in series to form a plurality of segments of light emitting diodes each comprising at least one light emitting diode, with the plurality of segments of light emitting diodes coupled to a corresponding plurality of switches to switch a selected segment of light emitting diodes into or out of a series light emitting diode current path. This exemplary method embodiment comprises: in response to a first parameter during a first part of an AC voltage interval, determining and storing a value of a second parameter and switching a corresponding segment of light emitting diodes into the series light emitting diode current path; and during a second part of the AC voltage interval, monitoring the second parameter and when the current value of the second parameter is substantially equal to the stored value, switching a corresponding segment of light emitting diodes out of the series light emitting diode current path.

In an exemplary embodiment, the AC voltage comprises a rectified AC voltage, and the exemplary method further comprises: determining when the rectified AC voltage is substantially close to zero; and generating a synchronization signal. The exemplary method also may further comprise: determining the AC voltage interval from at least one determination of when the rectified AC voltage is substantially close to zero.

In various exemplary embodiments, the method may further comprise rectifying the AC voltage to provide a rectified AC voltage. For example, in such an exemplary embodiment, the first parameter may be a light emitting diode current level and the second parameter may be a rectified AC input voltage level. Other parameter combinations are also within the scope of the claimed invention, including LED current levels, peak LED current levels, voltage levels, optical brightness levels, for example. In such exemplary embodiments, the method may further comprise, when a light emitting diode current level has reached a predetermined peak value during the first part of the AC voltage interval, determining and storing a first value of the rectified AC input voltage level and switching a first segment of light emitting diodes into the series light emitting diode current path; monitoring the light emitting diode current level; and when the light emitting diode current subsequently has reached the predetermined peak value during the first part of the AC voltage interval, determining and storing a second value of the rectified AC input voltage level and switching a second segment of light emitting diodes into the series light emitting diode current path. (Such predetermined values may be determined in a wide variety of ways, such as specified in advance off line or specified or calculated ahead of time while the circuit is operating, such as during a previous AC cycle). The exemplary method also may further comprise: monitoring the rectified AC voltage level; when the rectified AC voltage level has reached the second value during the second part of the AC voltage interval, switching the second segment of light emitting diodes out of the series light emitting diode current path; and when the rectified AC voltage level has reached the first value during the second part of the AC voltage interval, switching the first segment of light emitting diodes out of the series light emitting diode current path.

Also in various exemplary embodiments, the method may further comprise, during the first part of the AC voltage interval, as a light emitting diode current successively reaches a predetermined peak level, determining and storing a corresponding value of the rectified AC voltage level and successively switching a corresponding segment of light emitting diodes into the series light emitting diode current path; and during the second part of the AC voltage interval, as the rectified AC voltage level decreases to a corresponding voltage level, switching the corresponding segment of light emitting diodes out of the series light emitting diode current path. For such an exemplary method embodiment, the switching of the corresponding segment of light emitting diodes out of the series light emitting diode current path may be in a reverse order to the switching of the corresponding segment of light emitting diodes into the series light emitting diode current path.

In another exemplary embodiment, the method may further comprise: when a light emitting diode current has reached a predetermined peak level during the first part of the AC voltage interval, determining and storing a first value of the rectified AC input voltage level; and when the first value of the rectified AC input voltage is substantially equal to or greater than a predetermined voltage threshold, switching the corresponding segment of light emitting diodes into the series light emitting diode current path.

In various exemplary embodiments, the method may further comprise monitoring a light emitting diode current level; during the second part of the AC voltage interval, when the light emitting diode current level is greater than a predetermined peak level by a predetermined margin, determining and storing a new value of the second parameter and switching the corresponding segment of light emitting diodes into the series light emitting diode current path.

In another exemplary method embodiment, the method may further comprise: switching a plurality of segments of light emitting diodes to form a first series light emitting diode current path; and switching a plurality of segments of light emitting diodes to form a second series light emitting diode current path in parallel with the first series light emitting diode current path.

Various exemplary embodiments may also provide for a second series light emitting diode current path which has a direction or polarity opposite the first series light emitting diode current path, such as for conducting current during a negative part of an AC cycle, when the first series light emitting diode current path conducts current during a positive part of the AC cycle. For such an exemplary embodiment, the method may further comprise, during a third part of the AC voltage interval, switching a second plurality of segments of light emitting diodes to form a second series light emitting diode current path having a polarity opposite the series light emitting diode current path formed in the first part of the AC voltage interval; and during a fourth part of the AC voltage interval switching the second plurality of segments of light emitting diodes out of the second series light emitting diode current path.

Another exemplary embodiment is an apparatus couplable to receive an AC voltage. An exemplary apparatus comprises: a rectifier to provide a rectified AC voltage; a plurality of light emitting diodes coupled in series to form a plurality of segments of light emitting diodes; a plurality of switches correspondingly coupled to the plurality of segments of light emitting diodes to switch a selected segment of light emitting diodes into or out of a series light emitting diode current path; a current sensor to sense a light emitting diode current level; a voltage sensor to sense a rectified AC voltage level; a memory to store a plurality of parameters; and a controller coupled to the plurality of switches, to the memory, to the current sensor and to the voltage sensor, during a first part of a rectified AC voltage interval and when the light emitting diode current level has reached a predetermined peak light emitting diode current level, the controller to determine and store in the memory a corresponding value of the rectified AC voltage level and to switch a corresponding segment of light emitting diodes into the series light emitting diode current path; and during a second part of a rectified AC voltage interval, the controller to monitor the rectified AC voltage level and when the current value of the rectified AC voltage level is substantially equal to the stored corresponding value of the rectified AC voltage level, to switch the corresponding segment of light emitting diodes out of the series light emitting diode current path.

In such an exemplary apparatus embodiment, when the rectified AC voltage level is substantially close to zero, the controller further is to generate a corresponding synchronization signal. In various exemplary embodiments, the controller further may determine the rectified AC voltage interval from at least one determination of the rectified AC voltage level being substantially close to zero.

In an exemplary embodiment, the controller, when the light emitting diode current level has reached the predetermined peak light emitting diode current level during the first part of a rectified AC voltage interval, further is to determine and store in the memory a first value of the rectified AC voltage level, switch a first segment of light emitting diodes into the series light emitting diode current path, monitor the light emitting diode current level, and when the light emitting diode current level subsequently has reached the predetermined peak light emitting diode current level during the first part of the rectified AC voltage interval, the controller further is to determine and store in the memory a second value of the rectified AC voltage level and switch a second segment of light emitting diodes into the series light emitting diode current path.

In such an exemplary apparatus embodiment, the controller further is to monitor the rectified AC voltage level and when the rectified AC voltage level has reached the stored second value during the second part of a rectified AC voltage interval, to switch the second segment of light emitting diodes out of the series light emitting diode current path, and when the rectified AC voltage level has reached the stored first value during the second part of a rectified AC voltage interval, to switch the first segment of light emitting diodes out of the series light emitting diode current path.

In another exemplary apparatus embodiment, the controller further is to monitor the light emitting diode current level and when the light emitting diode current level has again reached the predetermined peak level during the first part of a rectified AC voltage interval, the controller further may determine and store in the memory a corresponding next value of the rectified AC voltage level and switch a next segment of light emitting diodes into the series light emitting diode current path. In such an exemplary apparatus embodiment, the controller further may monitor the rectified AC voltage level and when the rectified AC voltage level has reached the next rectified AC voltage level during the second part of a rectified AC voltage interval, to switch the corresponding next segment of light emitting diodes out of the series light emitting diode current path.

In various exemplary embodiments, the controller further may monitor a light emitting diode current level; and during the second part of the rectified AC voltage interval, when the light emitting diode current level is greater than a predetermined peak level by a predetermined margin, the controller further may determine and store another corresponding value of the rectified AC voltage level and switch the corresponding segment of light emitting diodes into the series light emitting diode current path.

Also in various exemplary embodiments, the controller further may switch a plurality of segments of light emitting diodes to form a first series light emitting diode current path, and to switch a plurality of segments of light emitting diodes to form a second series light emitting diode current path in a parallel with the first series light emitting diode current path.

As mentioned above, in various exemplary embodiments, selected segments of light emitting diodes of the plurality of segments of light emitting diodes may each comprise light emitting diodes having light emission spectra of different colors or wavelengths. In such an exemplary apparatus embodiment, the controller further may selectively switch the selected segments of light emitting diodes into the series light emitting diode current path to provide a corresponding lighting effect, and/or selectively switch the selected segments of light emitting diodes into the series light emitting diode current path to provide a corresponding color temperature.

Another exemplary apparatus embodiment is also couplable to receive an AC voltage, with the exemplary apparatus comprising: a first plurality of light emitting diodes coupled in series to form a first plurality of segments of light emitting diodes; a first plurality of switches coupled to the first plurality of segments of light emitting diodes to switch a selected segment of light emitting diodes into or out of a first series light emitting diode current path in response to a control signal; a memory; and a controller coupled to the plurality of switches and to the memory, the controller, in response to a first parameter and during a first part of an AC voltage interval, to determine and store in the memory a value of a second parameter and to generate a first control signal to switch a corresponding segment of light emitting diodes of the first plurality of segments of light emitting diodes into the first series light emitting diode current path; and during a second part of the AC voltage interval, when a current value of the second parameter is substantially equal to the stored value, to generate a second control signal to switch a corresponding segment of light emitting diodes of the first plurality of segments of light emitting diodes out of the first series light emitting diode current path.

In an exemplary embodiment, the first parameter and the second parameter comprise at least one of the following: a time parameter, or one or more time intervals, or a time-based parameter, or one or more clock cycle counts. In such an exemplary apparatus embodiment, the controller further may determine a first plurality of time intervals corresponding to a number of segments of light emitting diodes of the first plurality of segments of light emitting diodes for the first part of the AC voltage interval, and may determine a second plurality of time intervals corresponding to the number of segments of light emitting diodes for the second part of the AC voltage interval.

In another exemplary embodiment, the controller further may retrieve from the memory a first plurality of time intervals corresponding to a number of segments of light emitting diodes of the first plurality of segments of light emitting diodes for the first part of the AC voltage interval, and a second plurality of time intervals corresponding to the number of segments of light emitting diodes for the second part of the AC voltage interval.

For such exemplary embodiments, the controller, during the first part of the AC voltage interval, at the expiration of each time interval of the first plurality of time intervals, further may generate a corresponding control signal to switch a next segment of light emitting diodes into the series light emitting diode current path, and during the second part of the AC voltage interval, at the expiration of each time interval of the second plurality of time intervals, in a reverse order, may generate a corresponding control signal to switch the next segment of light emitting diodes out of the series light emitting diode current path.

In various exemplary embodiments, the apparatus may further comprise a rectifier to provide a rectified AC voltage. For such exemplary embodiments, the controller may, when the rectified AC voltage is substantially close to zero, generate a corresponding synchronization signal. Also for such exemplary embodiments, the controller further may determine the AC voltage interval from at least one determination of the rectified AC voltage being substantially close to zero.

Also in various exemplary embodiments, the apparatus may further comprise a current sensor coupled to the controller; and a voltage sensor coupled to the controller. For example, the first parameter may be a light emitting diode current level and the second parameter may be a voltage level.

For such exemplary embodiments, the controller, when a light emitting diode current has reached a predetermined peak level during the first part of the AC voltage interval, further may determine and store in the memory a first value of the AC voltage level and generate the first control signal to switch a first segment of the first plurality of segments of light emitting diodes into the first series light emitting diode current path; and when the light emitting diode current subsequently has reached the predetermined peak level during the first part of the AC voltage interval, the controller further may determine and store in the memory a next value of the AC voltage level and to generate a next control signal switch a next segment of the first plurality of segments of light emitting diodes into the first series light emitting diode current path. When the AC voltage level has reached the next value during the second part of a rectified AC voltage interval, the controller further may generate another control signal to switch the next segment out of the first series light emitting diode current path; and when the AC voltage level has reached the first value during the second part of a rectified AC voltage interval, may generate the second control signal to switch the first segment out of the first series light emitting diode current path.

In various exemplary embodiments, during the first part of the AC voltage interval, as a light emitting diode current successively reaches a predetermined peak level, the controller further may determine and store a corresponding value of the AC voltage level and successively generate a corresponding control signal to switch a corresponding segment of the first plurality of segments of light emitting diodes into the first series light emitting diode current path; and during the second part of the AC voltage interval, as the AC voltage level decreases to a corresponding voltage level, the controller further may successively generate a corresponding control signal to switch the corresponding segment of the first plurality of segments of light emitting diodes out of the first series light emitting diode current path. For example, the controller further may successively generate a corresponding control signal to switch the corresponding segment out of the first series light emitting diode current path in a reverse order to the switching of the corresponding segment into the first series light emitting diode current path.

In various exemplary embodiments, the controller further may determine whether the AC voltage is phase modulated. For such exemplary embodiments, the controller, when the AC voltage is phase modulated, further may generate a corresponding control signal to switch a segment of the first plurality of segments of light emitting diodes into the first series light emitting diode current path which corresponds to a phase modulated AC voltage level and/or to a time interval of the phase modulated AC voltage level. For such exemplary embodiments, the controller, when the AC voltage is phase modulated, further may generate corresponding control signals to maintain a parallel second light emitting diode current path through a first switch concurrently with switching a next segment of the first plurality of segments of light emitting diodes into the first series light emitting diode current path through a second switch.

In another of the various exemplary embodiments, the controller further may determine whether sufficient time remains in the first part of the AC voltage interval for a light emitting diode current to reach a predetermined peak level if a next segment of the first plurality of segments of light emitting diodes is switched into the first series light emitting diode current path, and if so, further may generate a corresponding control signal to switch the next segment of the first plurality of segments of light emitting diodes into the first series light emitting diode current path.

In yet another of the various exemplary embodiments, during the second part of the AC voltage interval and when the light emitting diode current level is greater than a predetermined peak level by a predetermined margin, the controller further may determine and store a new value of the second parameter and generate a corresponding control signal to switch the corresponding segment of the first plurality of segments of light emitting diodes into the first series light emitting diode current path.

In various exemplary embodiments, the controller further may generate corresponding control signals to switch a plurality of segments of the first plurality of segments of light emitting diodes to form a second series light emitting diode current path in parallel with the first series light emitting diode current path.

In various exemplary embodiments, the apparatus may further comprise a second plurality of light emitting diodes coupled in series to form a second plurality of segments of light emitting diodes; and a second plurality of switches coupled to the second plurality of segments of light emitting diodes to switch a selected segment of the second plurality of segments of light emitting diodes into or out of a second series light emitting diode current path; wherein the controller is further coupled to the second plurality of switches, and further may generate corresponding control signals to switch a plurality of segments of the second plurality of segments of light emitting diodes to form the second series light emitting diode current path in parallel with the first series light emitting diode current path. For example, the second series light emitting diode current path may have a polarity opposite the first series light emitting diode current path. Also for example, a first current flow through the first series light emitting diode current path may have an opposite direction to second current flow through the second series light emitting diode current path. Also for example, the controller further may generate corresponding control signals to switch a plurality of segments of the first plurality of segments of light emitting diodes to form the first series light emitting diode current path during a positive polarity of the AC voltage and further may generate corresponding control signals to switch a plurality of segments of the second plurality of segments of light emitting diodes to form the second series light emitting diode current path during a negative polarity of the AC voltage.

In various exemplary apparatus embodiments, the first plurality of switches may comprise a plurality of bipolar junction transistors or a plurality of field effect transistors. Also in various exemplary apparatus embodiments, the apparatus also may further comprise a plurality of tri-state switches, comprising: a plurality of operational amplifiers correspondingly coupled to the first plurality of switches; a second plurality of switches correspondingly coupled to the first plurality of switches; and a third plurality of switches correspondingly coupled to the first plurality of switches.

Various exemplary embodiments may also provide for various switching arrangements or structures. In various exemplary embodiments, each switch of the first plurality of switches is coupled to a first terminal of a corresponding segment of the first plurality of segments of light emitting diodes and coupled to a second terminal of the last segment of the first plurality of segments of light emitting diodes. In another of the various exemplary embodiments, each switch of the first plurality of switches is coupled to a first terminal of a corresponding segment of the first plurality of segments of light emitting diodes and coupled to a second terminal of the corresponding segment of the first plurality of segments of light emitting diodes.

In yet another of the various exemplary embodiments, the apparatus may further comprise a second plurality of switches. For such an exemplary embodiment, each switch of the first plurality of switches may be coupled to a first terminal of the first segment of the first plurality of segments of light emitting diodes and coupled to a second terminal of a corresponding segment of the first plurality of segments of light emitting diodes; and wherein each switch of the second plurality of switches may be coupled to a second terminal of a corresponding segment of the first plurality of segments of light emitting diodes and coupled to a second terminal of the last segment of the first plurality of segments of light emitting diodes.

In yet another exemplary embodiment, selected segments of light emitting diodes of the plurality of segments of light emitting diodes each comprise light emitting diodes having light emission spectra of different colors. For such exemplary embodiments, the controller further may generate corresponding control signals to selectively switch the selected segments of light emitting diodes into the first series light emitting diode current path to provide a corresponding lighting effect, and/or to provide a corresponding color temperature.

In various exemplary embodiments, the controller may further comprises: a first analog-to-digital converter couplable to a first sensor; a second analog-to-digital converter couplable to a second sensor; a digital logic circuit; and a plurality of switch drivers correspondingly coupled to the first plurality of switches. In another exemplary embodiment, the controller may comprise a plurality of analog comparators.

In various exemplary embodiments, the first parameter and the second parameter comprise at least one of the following parameters: a time period, a peak current level, an average current level, a moving average current level, an instantaneous current level, a peak voltage level, an average voltage level, a moving average voltage level, an instantaneous voltage level, an average output optical brightness level, a moving average output optical brightness level,a peak output optical brightness level, or an instantaneous output optical brightness level. In addition, in another exemplary embodiment, the first parameter and the second parameter are the same parameter, such as a voltage level or a current level.

Another exemplary apparatus embodiment is couplable to receive an AC voltage, with the apparatus comprising: a first plurality of light emitting diodes coupled in series to form a first plurality of segments of light emitting diodes; a first plurality of switches coupled to the first plurality of segments of light emitting diodes to switch a selected segment of light emitting diodes into or out of a first series light emitting diode current path in response to a control signal; at least one sensor; and a control circuit coupled to the plurality of switches and to the at least one sensor, the controller, in response to a first parameter and during a first part of an AC voltage interval, to determine a value of a second parameter and to generate a first control signal to switch a corresponding segment of light emitting diodes of the first plurality of segments of light emitting diodes into the first series light emitting diode current path; and during a second part of the AC voltage interval, when a current value of the second parameter is substantially equal to a corresponding determined value, to generate a second control signal to switch a corresponding segment of light emitting diodes of the first plurality of segments of light emitting diodes out of the first series light emitting diode current path.

In an exemplary embodiment, the control circuit further is to calculate or obtain from a memory a first plurality of time intervals corresponding to a number of segments of light emitting diodes of the first plurality of segments of light emitting diodes for the first part of the AC voltage interval, and to calculate or obtain from a memory a second plurality of time intervals corresponding to the number of segments of light emitting diodes for the second part of the AC voltage interval. In such an exemplary embodiment, during the first part of the AC voltage interval, at the expiration of each time interval of the first plurality of time intervals, the control circuit further is to generate a corresponding control signal to switch a next segment of light emitting diodes into the series light emitting diode current path, and during the second part of the AC voltage interval, at the expiration of each time interval of the second plurality of time intervals, in a reverse order, to generate a corresponding control signal to switch the next segment of light emitting diodes out of the series light emitting diode current path.

In another exemplary embodiment, the apparatus further comprises a memory to store a plurality of determined values. In various exemplary embodiments, the first parameter is a light emitting diode current level and the second parameter is a voltage level, and wherein during the first part of the AC voltage interval, as a light emitting diode current successively reaches a predetermined level, the control circuit further is to determine and store in the memory a corresponding value of the AC voltage level and successively generate a corresponding control signal to switch a corresponding segment of the first plurality of segments of light emitting diodes into the first series light emitting diode current path; and during the second part of the AC voltage interval, as the AC voltage level decreases to a corresponding voltage level, the controller further is to successively generate a corresponding control signal to switch the corresponding segment of the first plurality of segments of light emitting diodes out of the first series light emitting diode current path. In another exemplary embodiment, the first parameter and the second parameter are the same parameter comprising a voltage or a current level, and wherein during the first part of the AC voltage interval, as the voltage or current level successively reaches a predetermined level, the control circuit further is to successively generate a corresponding control signal to switch a corresponding segment of the first plurality of segments of light emitting diodes into the first series light emitting diode current path; and during the second part of the AC voltage interval, as the voltage or current level decreases to a corresponding level, the controller further is to successively generate a corresponding control signal to switch the corresponding segment of the first plurality of segments of light emitting diodes out of the first series light emitting diode current path.

Another exemplary apparatus embodiment is couplable to receive an AC voltage, with the apparatus comprising: a rectifier to provide a rectified AC voltage; a plurality of light emitting diodes coupled in series to form a plurality of segments of light emitting diodes; a plurality of switches, each switch of the plurality of switches coupled to a first terminal of a corresponding segment of the first plurality of segments of light emitting diodes and coupled to a second terminal of the last segment of the first plurality of segments of light emitting diodes; a current sensor to sense a light emitting diode current level; a voltage sensor to sense a rectified AC voltage level; a memory to store a plurality of parameters; and a controller coupled to the plurality of switches, to the memory, to the current sensor and to the voltage sensor, during a first part of a rectified AC voltage interval and when the light emitting diode current level has reached a predetermined peak light emitting diode current level, the controller to determine and store in the memory a corresponding value of the rectified AC voltage level and to generate corresponding control signals to switch a corresponding segment of light emitting diodes into the series light emitting diode current path; and during a second part of a rectified AC voltage interval and when the current value of the rectified AC voltage level is substantially equal to the stored corresponding value of the rectified AC voltage level, the controller to generate corresponding control signals to switch the corresponding segment of light emitting diodes out of the series light emitting diode current path.

Another exemplary embodiment provides a method of providing power to a plurality of light emitting diodes couplable to receive an AC voltage, the plurality of light emitting diodes coupled in series to form a plurality of segments of light emitting diodes each comprising at least one light emitting diode, the plurality of segments of light emitting diodes coupled to a plurality of current regulators, with the method comprising: monitoring and regulating a current level through a series light emitting diode current path; providing for a first segment of light emitting diodes to be in or out of the series light emitting diode current path at about a first predetermined current level or until the current level has reached about the first predetermined current level; and providing for a second segment of light emitting diodes to be in or out of the series light emitting diode current path at about a second predetermined current level or until the current level has reached about the second predetermined current level.

In various exemplary embodiments, the method may further comprise, during a zero crossing interval of the AC voltage, using a voltage regulator, providing a voltage or a current sufficient for at least one light emitting diode to be on and conducting, and during a peak interval of the AC voltage, charging the voltage regulator. In an exemplary embodiment, the voltage regulator comprises at least one capacitor coupled to a diode. In another exemplary embodiment, the method may further comprise regulating the current level of the series light emitting diode current path to be less than or equal to a maximum current level.

In an exemplary embodiment, the steps of providing for the first and second segments of light emitting diodes to be in or out of the series light emitting diode current path further comprise: turning off a first current regulator coupled to the first segment of light emitting diodes; and turning on a second current regulator coupled to the second segment of light emitting diodes or coupled to the first segment of light emitting diodes. In an exemplary embodiment, the first current regulator comprises a first current source and the second current regulator comprises a second current source. Also in an exemplary embodiment, the method may further comprise controlling or setting the first current regulator at about the first predetermined current level; and controlling or setting the second current regulator at about the second predetermined current level.

In various exemplary embodiments, the method may further comprise providing for the first, the second or a third segment of light emitting diodes to be in or out of the series light emitting diode current path at about a third predetermined current level or until the current level has reached about the third predetermined current level. The first, second and third predetermined current levels may be sequential or non-sequential current levels.

In an exemplary embodiment, the steps of providing for the first, second and third segments of light emitting diodes to be in or out of the series light emitting diode current path may further comprise: regulating the current level of the series light emitting diode current path at about the first predetermined current level or until the current level has reached about the first predetermined current level, the series light emitting diode current path comprising the first segment of light emitting diodes and not the second segment of light emitting diodes; regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level; and regulating the current level of the series light emitting diode current path at about the third predetermined current level or until the current level has reached about the third predetermined current level, the series light emitting diode current path comprising the third segment of light emitting diodes coupled in series to the second segment of light emitting diodes coupled in series to the first segment of light emitting diodes, wherein the third predetermined current level is greater than the first predetermined current level.

In various exemplary embodiments, the steps of providing for the first, second and third segments of light emitting diodes to be in or out of the series light emitting diode current path may further comprise: regulating the current level of the series light emitting diode current path at about the first predetermined current level or until the current level has reached about the first predetermined current level, the series light emitting diode current path comprising the first segment of light emitting diodes and not the second segment of light emitting diodes; regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is greater than the first predetermined current level; and regulating the current level of the series light emitting diode current path at about the third predetermined current level or until the current level has reached about the third predetermined current level, the series light emitting diode current path comprising the third segment of light emitting diodes coupled in series to the second segment of light emitting diodes, wherein the third predetermined current level is greater than the second predetermined current level.

In various exemplary embodiments, the steps of providing for the first and second segments of light emitting diodes to be in or out of the series light emitting diode current path may further comprise: regulating the current level of the series light emitting diode current path at about the first predetermined current level or until the current level has reached about the first predetermined current level, the series light emitting diode current path comprising the first segment of light emitting diodes without the second segment of light emitting diodes; and regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level.

In another exemplary embodiment, the steps of providing for the first and second segments of light emitting diodes to be in or out of the series light emitting diode current path may further comprise: regulating the current level of the series light emitting diode current path at about the first predetermined current level or until the current level has reached about the first predetermined current level, the series light emitting diode current path comprising the first segment of light emitting diodes without the second segment of light emitting diodes; and regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is higher than the first predetermined current level.

In another exemplary embodiment, the steps of providing for the first and second segments of light emitting diodes to be in or out of the series light emitting diode current path may further comprise: turning off a first current regulator coupled to the first segment of light emitting diodes, the first current regulator providing for a maximum current at about the first predetermined current level; and turning on a second current regulator coupled to the second segment of light emitting diodes, the second segment of light emitting diodes coupled in series to the first segment of light emitting diodes in the series light emitting diode current path, the second current regulator providing for a maximum current at the second predetermined current level, wherein the second predetermined current level is lower than the first predetermined current level.

In another exemplary embodiment, the steps of providing for the first and second segments of light emitting diodes to be in or out of the series light emitting diode current path may further comprise: turning off a first current regulator coupled to the first segment of light emitting diodes, the first current regulator providing for a maximum current at about the first predetermined current level; and turning on a second current regulator coupled to the second segment of light emitting diodes, the second segment of light emitting diodes coupled in series to the first segment of light emitting diodes in the series light emitting diode current path, the second current regulator providing for a maximum current at the second predetermined current level, wherein the second predetermined current level is higher than the first predetermined current level.

In various exemplary embodiments, the method may further comprise providing for a next segment of light emitting diodes to be in or out of the series light emitting diode current path at about a next predetermined current level or until the current level has reached about the next predetermined current level.

In various exemplary embodiments, providing for the first segment of light emitting diodes to be in or out of the series light emitting diode current path and providing for the second segment of light emitting diodes to be in or out of the series light emitting diode current path may occur in a first order during a first part of an AC voltage interval and in a second order during a second part of the AC voltage interval, wherein the second order is the reverse of the first order.

In another exemplary embodiment, the method may further comprise determining whether the AC voltage is phase modulated; and when the AC voltage is phase modulated, providing for the first segment of light emitting diodes to be in or out of the series light emitting diode current path corresponding to a phase modulated AC current level; and/or when the AC voltage is phase modulated, maintaining a parallel light emitting diode current path concurrently with providing for the second segment of light emitting diodes to be in or out of the series light emitting diode current path.

In various exemplary embodiments, the method may further comprise providing for the first segment of light emitting diodes to be in a first series light emitting diode current path; and providing for the second segment of light emitting diodes to be in a second series light emitting diode current path in parallel with the first series light emitting diode current path.

In another exemplary embodiment, the method may further comprise, during a first part of an AC voltage interval, providing for the first segment of light emitting diodes to be in a first series light emitting diode current path and providing for the second segment of light emitting diodes to be in a second series light emitting diode current path in parallel with the first segment of light emitting diodes; with an increasing voltage level during the first part of the AC voltage interval, providing for a third segment of light emitting diodes to be in the first series light emitting diode current path and providing for a fourth segment of light emitting diodes to be in a third series light emitting diode current path in parallel with the third segment of light emitting diodes; with an increasing voltage level during the first part of the AC voltage interval, providing for the second segment of light emitting diodes to be in the first series light emitting diode current path; and with an increasing voltage level during the first part of the AC voltage interval, providing for the fourth segment of light emitting diodes to be in the first series light emitting diode current path.

Also in another exemplary embodiment, the method may further comprise, with a decreasing voltage level during a second part of the AC voltage interval, providing for the fourth segment of light emitting diodes to be in parallel with the third segment of light emitting diodes; with a decreasing voltage level during the second part of the AC voltage interval, providing for the second segment of light emitting diodes to be in parallel with the first segment of light emitting diodes; and with a decreasing voltage level during the second part of the AC voltage interval, providing for the third and fourth segments of light emitting diodes to be out of the first series light emitting diode current path.

In various exemplary embodiments, selected segments of light emitting diodes of the plurality of segments of light emitting diodes may each comprise light emitting diodes having light emission spectra of different colors or wavelengths.

Another exemplary apparatus embodiment is couplable to receive an AC voltage, the apparatus comprising: a plurality of light emitting diodes coupled in series to form a plurality of segments of light emitting diodes; a first current regulator coupled to a first segment of light emitting diodes of the plurality of segments of light emitting diodes; a second current regulator coupled to a second segment of light emitting diodes of the plurality of segments of light emitting diodes; a current sensor; and a controller coupled to the first and second current regulators and to the current sensor, the controller to monitor a current level through a series light emitting diode current path, to provide for the first segment of light emitting diodes to be in or out of the series light emitting diode current path at about a first predetermined current level or until the current level has reached about the first predetermined current level; and to provide for the second segment of light emitting diodes to be in or out of the series light emitting diode current path at about a second predetermined current level or until the current level has reached about the second predetermined current level.

Another exemplary apparatus embodiment may further comprise a voltage regulator to provide a voltage or a current sufficient for at least one light emitting diode to be on and conducting during a zero crossing interval of the AC voltage. The voltage regulator may be charged during a peak interval of the AC voltage. In an exemplary embodiment, the voltage regulator comprises at least one capacitor coupled to a diode. In another exemplary embodiment, the voltage regulator may comprise: a first capacitor coupled to the first or second segment of light emitting diodes; a first diode coupled to the first capacitor; a second capacitor coupled in series to the first diode and the first capacitor; and a second diode coupled to the second capacitor and to the first or second segment of light emitting diodes. In various exemplary embodiments, the voltage regulator is coupled to the first or second current regulator.

In another exemplary embodiment, the controller further is to regulate the current level of the series light emitting diode current path to be less than or equal to a maximum current level.

In various exemplary embodiments, the controller further may provide for the first and second segments of light emitting diodes to be in or out of the series light emitting diode current path by respectively turning off or on the first current regulator and turning on or off the second current regulator.

In an exemplary embodiment, the first current regulator comprises a first current source and the second current regulator comprises a second current source. In various exemplary embodiments, the first current source and the second current source each comprise a transistor. In another exemplary embodiment, the first current source and the second current source each comprise an operational amplifier coupled to a transistor. In another exemplary embodiment, the first current source and the second current source each comprise an operational amplifier coupled to a plurality of transistors.

In various exemplary embodiments, the controller further may control or set the first current regulator at about the first predetermined current level and control or set the second current regulator at about the second predetermined current level.

Also in various exemplary embodiments, the apparatus may further comprise a third current regulator coupled to a third segment of light emitting diodes of the plurality of segments of light emitting diodes; wherein the controller further is to provide for the first, second or third segment of light emitting diodes to be in or out of the series light emitting diode current path at about a third predetermined current level or until the current level has reached about the third predetermined current level. The first, second and third predetermined current levels may be sequential or non-sequential current levels.

In an exemplary embodiment, the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level; and to turn on the third current regulator and turn off the second current regulator to control the current level of the series light emitting diode current path at about the third predetermined current level or until the current level has reached about the third predetermined current level, the series light emitting diode current path comprising the third segment of light emitting diodes coupled in series to the second segment of light emitting diodes coupled in series to the first segment of light emitting diodes, wherein the third predetermined current level is greater than the first predetermined current level.

In another exemplary embodiment, the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is greater than the first predetermined current level; and to turn on the third current regulator and turn off the second current regulator to control the current level of the series light emitting diode current path at about the third predetermined current level or until the current level has reached about the third predetermined current level, the series light emitting diode current path comprising the third segment of light emitting diodes coupled in series to the second segment of light emitting diodes coupled in series to the first segment of light emitting diodes, wherein the third predetermined current level is greater than the second predetermined current level.

In yet another exemplary embodiment, the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; and to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level.

In another exemplary embodiment, the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; and to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is greater than the first predetermined current level.

In various exemplary embodiments, the controller further may provide for a next segment of light emitting diodes to be in or out of the series light emitting diode current path at about a next predetermined current level or until the current level has reached about the next predetermined current level. The controller further may provide for the first segment of light emitting diodes to be in or out of the series light emitting diode current path and provide for the second segment of light emitting diodes to be in or out of the series light emitting diode current path in a first order during a first part of an AC voltage interval and in a second order during a second part of the AC voltage interval, wherein the second order is the reverse of the first order.

In another exemplary embodiment, the controller further may determine whether the AC voltage is phase modulated; and when the AC voltage is phase modulated, to provide for the first segment of light emitting diodes to be in or out of the series light emitting diode current path corresponding to a phase modulated AC current level.

In various exemplary embodiments, the controller further may provide for a parallel light emitting diode current path concurrently with providing for the first or second segment of light emitting diodes to be in or out of the series light emitting diode current path. For example, the controller may provide for the first segment of light emitting diodes to be in a first series light emitting diode current path; and to provide for the second segment of light emitting diodes to be in a second series light emitting diode current path in parallel with the first series light emitting diode current path.

Another exemplary apparatus embodiment may further comprise a rectifier couplable to receive the AC voltage.

In various exemplary embodiments, selected segments of light emitting diodes of the plurality of segments of light emitting diodes each comprise light emitting diodes having light emission spectra of different colors or wavelengths. The controller may selectively provide for the selected segments of light emitting diodes to be in or out of the series light emitting diode current path to provide a corresponding lighting effect, and/or the controller further may selectively provide for the selected segments of light emitting diodes to be in or out of the series light emitting diode current path to provide a corresponding color temperature.

In various exemplary embodiments, the apparatus operates at about a rectified AC voltage frequency selected from the group consisting of: 100 Hz, 120 Hz, 300 Hz, 360 Hz, 400 Hz, and combinations thereof.

Another exemplary apparatus embodiment may further comprise a plurality of phosphor coatings or layers, each phosphor coating or layer coupled to a corresponding light emitting diode of the plurality of light emitting diodes, each phosphor coating or layer having a luminous decay time constant between about 2 to 3 msec.

Another exemplary apparatus embodiment may further comprise a third segment of light emitting diodes; a fourth segment of light emitting diodes; a plurality of switches, each switch of the plurality of switches coupled to at least one of the first, second, third or fourth first segments of light emitting diodes and coupled to the controller;wherein during a first part of an AC voltage interval, the controller is to provide for the first segment of light emitting diodes to be in a first series light emitting diode current path and provide for the second segment of light emitting diodes to be in a second series light emitting diode current path in parallel with the first segment of light emitting diodes; with an increasing voltage level during the first part of the AC voltage interval, the controller is to provide for the third segment of light emitting diodes to be in the first series light emitting diode current path and providing for the fourth segment of light emitting diodes to be in a third series light emitting diode current path in parallel with the third segment of light emitting diodes; with an increasing voltage level during the first part of the AC voltage interval, the controller is to provide for the second segment of light emitting diodes to be in the first series light emitting diode current path; and with an increasing voltage level during the first part of the AC voltage interval, the controller is to provide for the fourth segment of light emitting diodes to be in the first series light emitting diode current path.

In addition, in various exemplary embodiments, with a decreasing voltage level during a second part of the AC voltage interval, the controller may provide for the fourth segment of light emitting diodes to be in parallel with the third segment of light emitting diodes; with a decreasing voltage level during the second part of the AC voltage interval, the controller is to provide for the second segment of light emitting diodes to be in parallel with the first segment of light emitting diodes; and with a decreasing voltage level during the second part of the AC voltage interval, the controller is to provide for the third and fourth segments of light emitting diodes to be out of the first series light emitting diode current path.

Lastly, in another exemplary embodiment, an apparatus is couplable to receive an AC voltage, the apparatus comprising: a plurality of light emitting diodes coupled in series to form at least one segment of light emitting diodes; a first current regulator coupled at a light emitting diode cathode of the at least one segment of light emitting diodes; a second current regulator coupled at a light emitting diode anode of the at least one segment of light emitting diodes; a current sensor; a voltage regulator to provide a voltage or a current sufficient for at least one light emitting diode to be on and conducting; and a controller coupled to the first and second current regulators and to the current sensor, the controller to monitor a current level through the at least one segment of light emitting diodes, to turn on the second current regulator to provide current through the at least one segment of light emitting diodes and to charge the voltage regulator, and to turn on the first current regulator to provide current through the at least one segment of light emitting diodes and to discharge the voltage regulator.

Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a circuit and block diagram a first exemplary system and a first exemplary apparatus in accordance with the teachings of the present invention.

FIG. 2 is a graphical diagram illustrating a first exemplary load current waveform and input voltage levels in accordance with the teachings of the present invention.

FIG. 3 is a graphical diagram illustrating a second exemplary load current waveform and input voltage levels in accordance with the teachings of the present invention.

FIG. 4 is a block and circuit diagram illustrating a second exemplary system and a second exemplary apparatus in accordance with the teachings of the present invention.

FIG. 5 is a block and circuit diagram illustrating a third exemplary system and a third exemplary apparatus in accordance with the teachings of the present invention.

FIG. 6 is a block and circuit diagram illustrating a fourth exemplary system and a fourth exemplary apparatus in accordance with the teachings of the present invention.

FIG. 7 is a block and circuit diagram illustrating a fifth exemplary system and a fifth exemplary apparatus in accordance with the teachings of the present invention.

FIG. 8 is a block and circuit diagram illustrating a sixth exemplary system and a sixth exemplary apparatus in accordance with the teachings of the present invention.

FIG. 9 is a block and circuit diagram illustrating a first exemplary current limiter in accordance with the teachings of the present invention.

FIG. 10 is a circuit diagram illustrating a second exemplary current limiter in accordance with the teachings of the present invention.

FIG. 11 is a circuit diagram illustrating a third exemplary current limiter and a temperature protection circuit in accordance with the teachings of the present invention.

FIG. 12 is a circuit diagram illustrating a fourth exemplary current limiter in accordance with the teachings of the present invention.

FIG. 13 is a block and circuit diagram illustrating a first exemplary interface circuit in accordance with the teachings of the present invention.

FIG. 14 is a block and circuit diagram illustrating a second exemplary interface circuit in accordance with the teachings of the present invention.

FIG. 15 is a block and circuit diagram illustrating a third exemplary interface circuit in accordance with the teachings of the present invention.

FIG. 16 is a block and circuit diagram illustrating a fourth exemplary interface circuit in accordance with the teachings of the present invention.

FIG. 17 is a block and circuit diagram illustrating a fifth exemplary interface circuit in accordance with the teachings of the present invention.

FIG. 18 is a circuit diagram illustrating a first exemplary DC power source circuit in accordance with the teachings of the present invention.

FIG. 19 is a circuit diagram illustrating a second exemplary DC power source circuit in accordance with the teachings of the present invention.

FIG. 20 is a circuit diagram illustrating a third exemplary DC power source circuit in accordance with the teachings of the present invention.

FIG. 21 is a block diagram illustrating an exemplary controller in accordance with the teachings of the present invention.

FIG. 22 is a flow diagram illustrating a first exemplary method in accordance with the teachings of the present invention.

FIG. 23, divided into FIGS. 23A, 23B, and 23C, is a flow diagram illustrating a second exemplary method in accordance with the teachings of the present invention.

FIG. 24 is a block and circuit diagram illustrating a seventh exemplary system and a seventh exemplary apparatus in accordance with the teachings of the present invention.

FIG. 25 is a block and circuit diagram illustrating an eighth exemplary system and an eighth exemplary apparatus in accordance with the teachings of the present invention.

FIG. 26 is a block and circuit diagram illustrating a ninth exemplary system and a ninth exemplary apparatus in accordance with the teachings of the present invention.

FIG. 27 is a block and circuit diagram illustrating a tenth exemplary system and a tenth exemplary apparatus in accordance with the teachings of the present invention.

FIG. 28 is a block and circuit diagram illustrating an eleventh exemplary system and an eleventh exemplary apparatus in accordance with the teachings of the present invention.

FIG. 29 is a block and circuit diagram illustrating a twelfth exemplary system and a twelfth exemplary apparatus in accordance with the teachings of the present invention.

FIG. 30 is a block and circuit diagram illustrating a thirteenth exemplary system and a thirteenth exemplary apparatus in accordance with the teachings of the present invention.

FIG. 31, divided into FIG. 31A and FIG. 31B, is a flow diagram illustrating a third exemplary method in accordance with the teachings of the present invention.

FIG. 32 is a block and circuit diagram illustrating a fourteenth exemplary system and a fourteenth exemplary apparatus in accordance with the teachings of the present invention.

FIG. 33 is a graphical diagram illustrating exemplary voltage and current waveforms without additional voltage regulation.

FIG. 34 is a graphical diagram illustrating exemplary voltage, current and light output waveforms using an exemplary voltage regulator.

FIG. 35 is a block and circuit diagram illustrating a fifteenth exemplary system and a fifteenth exemplary apparatus in accordance with the teachings of the present invention.

FIG. 36 is a graphical diagram illustrating exemplary voltage, current and light output waveforms with non-sequential current regulation and using an exemplary voltage regulator.

FIG. 37 is a graphical diagram illustrating exemplary voltage, current and light output waveforms with non-sequential current regulation and using an exemplary voltage regulator.

FIG. 38 is a block and circuit diagram illustrating a sixteenth exemplary system and a sixteenth exemplary apparatus in accordance with the teachings of the present invention.

FIG. 39 is a block and circuit diagram illustrating a seventeenth exemplary system and a seventeenth exemplary apparatus in accordance with the teachings of the present invention.

FIG. 40 is a block and circuit diagram illustrating an eighteenth exemplary system and an eighteenth exemplary apparatus in accordance with the teachings of the present invention.

FIG. 41 is a block and circuit diagram illustrating a nineteenth exemplary system and a nineteenth exemplary apparatus in accordance with the teachings of the present invention.

FIG. 42 is a block and circuit diagram illustrating a twentieth exemplary system and a twentieth exemplary apparatus in accordance with the teachings of the present invention.

FIG. 43 is a flow diagram illustrating a fourth exemplary method in accordance with the teachings of the present invention.

FIG. 44 is a block and circuit diagram illustrating a first exemplary second current regulator or current source in accordance with the teachings of the present invention.

FIG. 45 is a block and circuit diagram illustrating a second exemplary second current regulator or current source in accordance with the teachings of the present invention.

FIG. 46 is a block and circuit diagram illustrating a third exemplary second current regulator or current source in accordance with the teachings of the present invention.

### DETAILED DESCRIPTION OF EXEMPLARY EMBODIMENTS

While the present invention is susceptible of embodiment in many different forms, there are shown in the drawings and will be described herein in detail specific exemplary embodiments thereof, with the understanding that the present disclosure is to be considered as an exemplification of the principles of the invention and is not intended to limit the invention to the specific embodiments illustrated. In this respect, before explaining at least one embodiment consistent with the present invention in detail, it is to be understood that the invention is not limited in its application to the details of construction and to the arrangements of components set forth above and below, illustrated in the drawings, or as described in the examples. Methods and apparatuses consistent with the present invention are capable of other embodiments and of being practiced and carried out in various ways. Also, it is to be understood that the phraseology and terminology employed herein, as well as the abstract included below, are for the purposes of description and should not be regarded as limiting.

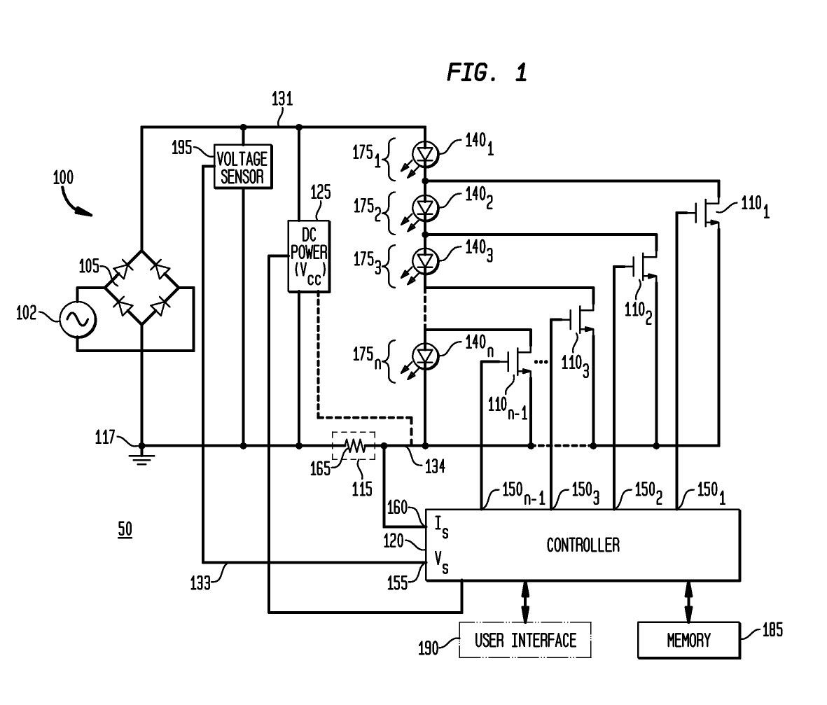

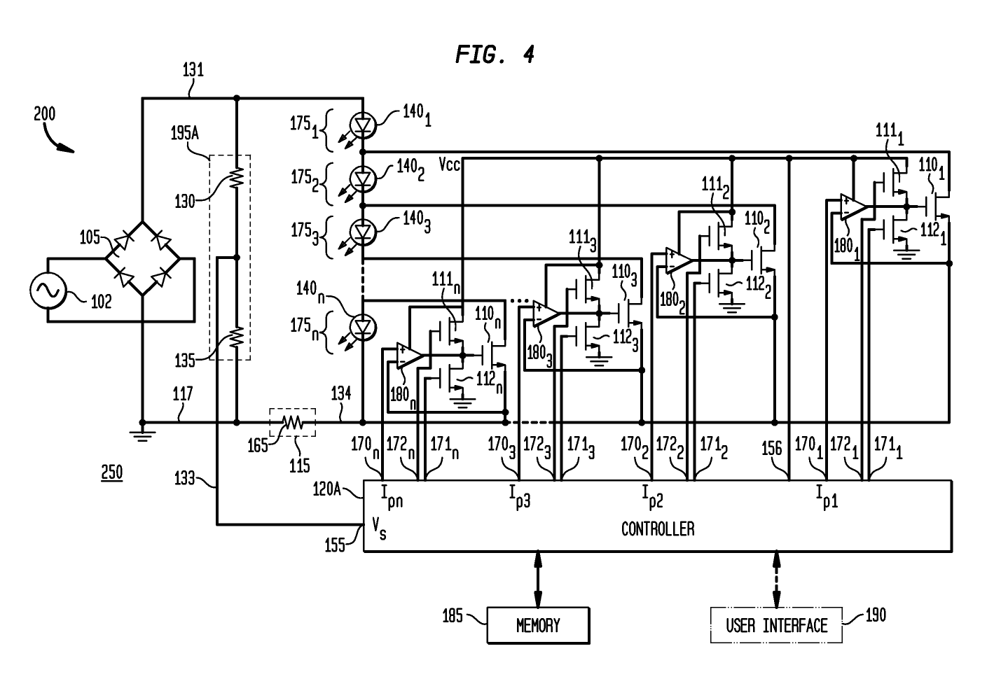

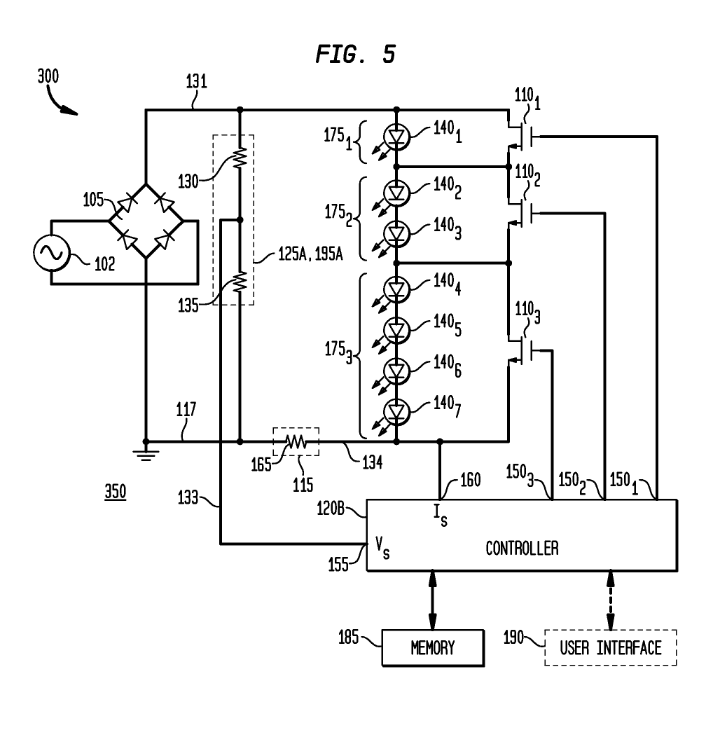

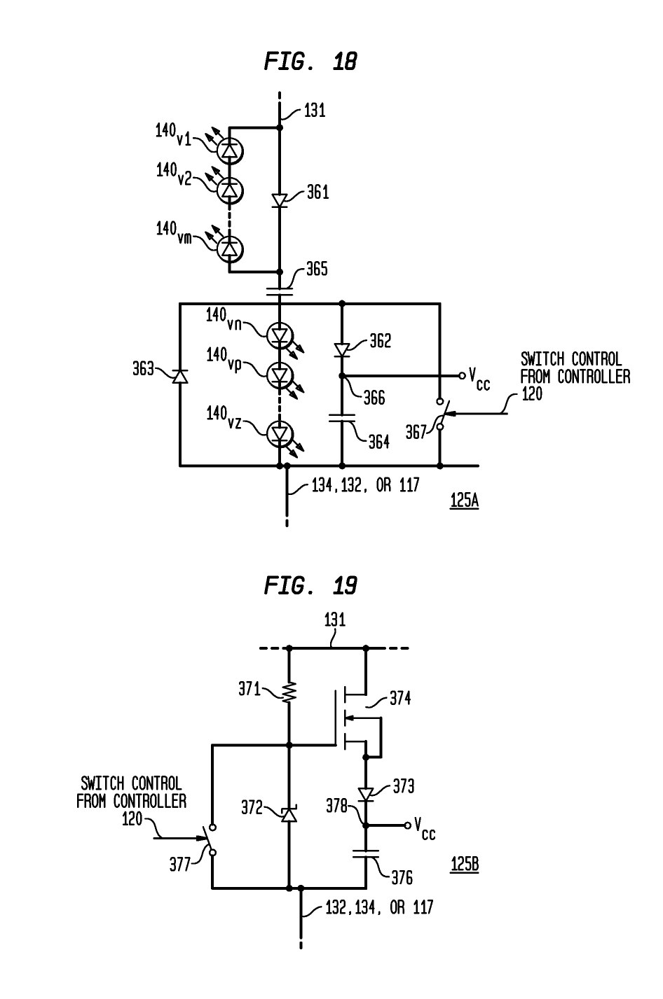

FIG. 1 is a circuit and block diagram a first exemplary system 50 and a first exemplary apparatus 100 in accordance with the teachings of the present invention. First exemplary system 50 comprises the first exemplary apparatus 100 (also referred to equivalently as an off line AC LED driver) coupled to an alternating current (“AC”) line 102, also referred to herein equivalently as an AC power line or an AC power source, such as a household AC line or other AC mains power source provided by an electrical utility. While exemplary embodiments are described with reference to such an AC voltage or current, it should be understood that the claimed invention is applicable to any time-varying voltage or current, as defined in greater detail below. The first exemplary apparatus 100 comprises a plurality of LEDs 140, a plurality of switches 110 (illustrated as MOSFETs, as an example), a controller 120, a (first) current sensor 115, a rectifier 105, and as options, a voltage sensor 195 and a DC power source (“Vcc”) for providing power to the controller 120 and other selected components. Exemplary DC power source circuits 125 may be implemented in a wide variety of configurations and may be provided in a wide variety of locations within the various exemplary apparatuses (100, 200, 300, 400, 500, 600, 700, 800, 900, 1000, 1100, 1200, 1300), with several exemplary DC power source circuits 125 illustrated and discussed with reference to FIGS. 18 -20. Also for example, exemplary DC power sources 125 may be coupled into the exemplary apparatuses in a wide variety of ways, such as between nodes 131 and 117 or between nodes 131 and 134, for example and without limitation. Exemplary voltage sensors 195 also may be implemented in a wide variety of configurations and may be provided in a wide variety of locations within the various exemplary apparatuses (100, 200, 300, 400, 500, 600, 700, 800, 900, 1000, 1100, 1200, 1300), with an exemplary voltage sensor 195A implemented as a voltage divider circuit illustrated and discussed with reference to FIGS. 4 and 5. Also for example, exemplary voltage sensor 195 may be coupled into the exemplary apparatuses in a wide variety of ways, such as between nodes 131 and 117 or in other locations, for example and without limitation. Also optional, a memory 185 may be included, such as to store various time periods, current or voltage levels; in various exemplary embodiments, controller 120 may already include various types of memory 185 (e.g., registers), such that memory 185 may not be a separate component. A user interface 190 (for user input of various selections such as light output, for example) also may be included as an option in various exemplary embodiments, such as for input of desired or selected lighting effects. Not separately illustrated in the Figures, equivalent implementations may also include isolation, such as through the use of isolation transformers, and are within the scope of the claimed invention.

It should be noted that any of the switches 110 of the plurality of switches 110 may be any type or kind of switch or transistor, in addition to the illustrated re-channel MOSFETs, including without limitation a bipolar junction transistor (“BJT”), a p-channel MOSFET, various enhancement or depletion mode FETs, etc., and that a plurality of other power switches of any type or kind also may be utilized in the circuitry, depending on the selected embodiment.

The rectifier 105, illustrated as a bridge rectifier, is coupled to the AC line 102, to provide a full (or half) wave rectified input voltage (“V_{IN}”)and current to a first light emitting diode 140₁ of a plurality of series-coupled light emitting diodes (“LEDs”) 140, illustrated as LEDs 140₁, 140₂, 140₃, through 140ₙ, which are arranged or configured as a plurality of series-coupled segments (or strings) 175 (illustrated as LED segments 175₁, 175₂, 175₃, through 175ₙ). (Rectifier 105 may be a full-wave rectifier, a full-wave bridge, a half-wave rectifier, an electromechanical rectifier, or another type of rectifier.) While each LED segment 175 is illustrated in FIG. 1 as having only one corresponding LED 140 for ease of illustration, it should be understood that each such LED segment 175 typically comprises a corresponding plurality of series-coupled LEDs 140, from one to “m” LEDs 140 in each LED segment 175, which are successively coupled in series. It should also be understood that the various LED segments 175 may be comprised of the same (equal) number of LEDs 140 or differing (unequal) numbers of LEDs 140, and all such variations are considered equivalent and within the scope of the present invention. For example and without limitation, in an exemplary embodiment, as many as five to seven LEDs 140 are included in each of nine LED segments 175. The various LED segments 175, and the corresponding LEDs 140 which comprise them, are successively coupled in series to each other, with a first LED segment 175₁ coupled in series to a second LED segment 175₂, which in turn is coupled in series to a third LED segment 175₃, and so on, with a penultimate LED segment 175,ₙ₋₁ coupled in series to the last or ultimate LED segment 175ₙ.

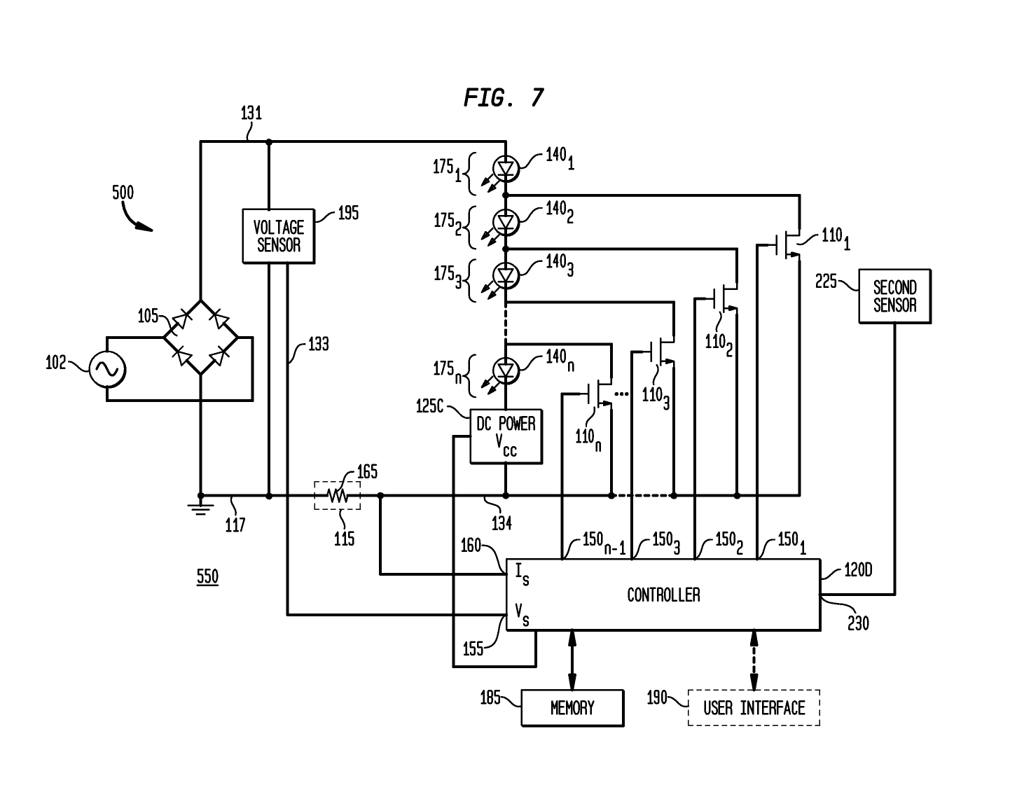

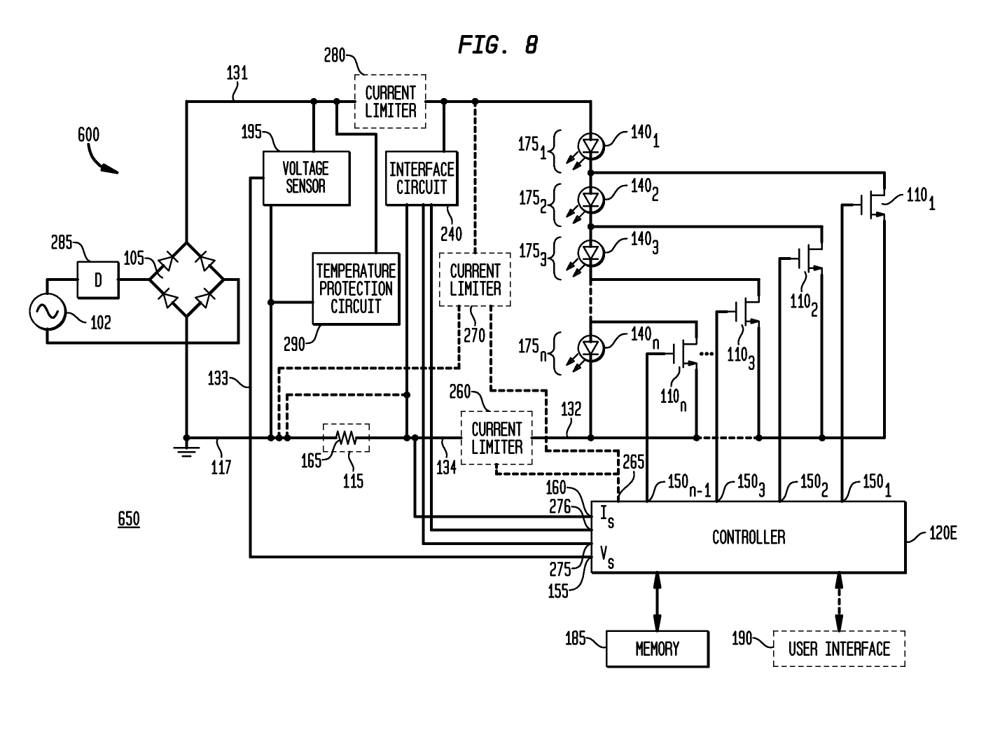

As illustrated, rectifier 105 is directly coupled to an anode of a first LED 140₁, although other coupling arrangements are also within the scope of the present invention, such as coupling through a resistance or other components, such as coupling to a current limiter circuit 280, or an interface circuit 240, or a DC power source 125 as illustrated and as discussed in greater detail below. Equivalent implementations are also available without use of a rectifier 105, and are discussed below. Current sensor 115 is illustrated and embodied as a current sense resistor 165, as an exemplary type of current sensor, and all current sensor variations are considered equivalent and within the scope of the claimed invention. Such a current sensor 115 may also be provided in other locations within the apparatus 100, with all such configuration variations considered equivalent and within the scope of the invention as claimed. As current sensor 115 is illustrated as coupled to a ground potential 117, feedback of the level of current through the LED segments 175 and/or switches 110 (“I_{S}”) can be provided using only one input 160 of controller 120; in other embodiments, additional inputs may also be utilized, such as for input of two or more voltage levels utilized for current sensing, for example and without limitation. Other types of sensors may also be utilized, such as an optical brightness sensor (such as second sensor 225 in FIG. 7), in lieu of or in addition to current sensor 115 and/or voltage sensor 195, for example and without limitation. In addition, a current sense resistor 165 may also function as a current limiting resistor. A wide variety of DC power sources 125 for the controller 120 may be implemented, and all such variations are considered equivalent and within the scope of the claimed invention.

The controller 120 (and the other controllers 120A-120I discussed below) may be implemented as known or becomes known in the art, using any type of circuitry, as discussed in greater detail below, and more generally may also be considered to be a control circuit. For example and without limitation, the controller 120 (and the other controllers 120A-120I) or an equivalent control circuit may be implemented using digital circuitry, analog circuitry, or a combination of both digital and analog circuitry, with or without a memory circuit. The controller 120 is utilized primarily to provide switching control, to monitor and respond to parameter variations (e.g., LED 140 current levels, voltage levels, optical brightness levels, etc.), and may also be utilized to implement any of various lighting effects, such as dimming or color temperature control.

The switches 110, illustrated as switches 110₁, 110₂, 110₃, through 110ₙ₋₁, may be any type of switch, such as the illustrated MOSFETs as an exemplary type of switch, with other equivalent types of switches 110 discussed in greater detail below, and all such variations are considered equivalent and within the scope of the claimed invention. The switches 110 are correspondingly coupled to a terminal of LED segments 175. As illustrated, corresponding switches 110 are coupled in a one-to-one correspondence to a cathode of an LED 140 at a terminal of each LED segment 175, with the exception of the last LED segment 175ₙ. More particularly, in this exemplary embodiment, a first terminal of each switch 110 (e.g., a drain terminal) is coupled to a corresponding terminal (cathode in this illustration) of a corresponding LED 140 of each LED segment 175, and a second terminal of each switch 110 (e.g., a source terminal) is coupled to the current sensor 115 (or, for example, to a ground potential 117, or to another sensor, a current limiter (discussed below) or to another node (e.g., 132)). A gate of each switch 110 is coupled to a corresponding output 150 of (and is under the control of) a controller 120, illustrated as outputs 150₁, 150₂, 150₃, through 150ₙ₋₁. In this first exemplary apparatus 100, each switch 110 performs a current bypass function, such that when a switch 110 is on and conducting, current flows through the corresponding switch and bypasses remaining (or corresponding) one or more LED segments 175. For example, when switch 110₁ is on and conducting and the remaining switches 110 are off, current flows through LED segment 175₁ and bypasses LED segments 175₂ through 175ₙ; when switch 110₂ is on and conducting and the remaining switches 110 are off, current flows through LED segments 175₁ and 175₂, and bypasses LED segments 175₃ through 175ₙ; when switch 110₃ is on and conducting and the remaining switches 110 are off, current flows through LED segments 175₁, 175₂, and 175₃, and bypasses the remaining LED segments (through 175ₙ); and when none of the switches 110 is on and conducting (all switches 110 are off), current flows through all of the LED segments 175₁, 175₂, 175₃ through 175ₙ.

Accordingly, the plurality of LED segments 175₁, 175₂, 175₃ through 175ₙ are coupled in series, and are correspondingly coupled to the plurality of switches 110 (110₁ through 110ₙ₋₁). Depending on the state of the various switches, selected LED segments 175 may be coupled to form a series LED 140 current path, also referred to herein equivalently as a series LED 140 path, such that electrical current flows through the selected LED segments 175 and bypasses the remaining (unselected) LED segments 175 (which, technically, are still physically coupled in series to the selected LED segments 175, but are no longer electrically coupled in series to the selected LED segments 175, as current flow to them has been bypassed or diverted). Depending on the circuit configuration, if all switches 110 are off, then all of the LED segments 175 of the plurality of LED segments 175 have been coupled to form the series LED 140 current path, i.e., no current flow to the LED segments 175 has been bypassed or diverted. For the illustrated circuit configuration, and depending on the circuit configuration (e.g., the location of various switches 110) at least one of the LED segments 175 of the plurality of LED segments 175 is coupled to form the series LED 140 current path, i.e., when there is current flow, it is always going through at least one LED segments 175 for this configuration.

Under the control of the controller 120, the plurality of switches 110 may then be considered to switch selected LED segments 175 in or out of the series LED 140 current path from the perspective of electrical current flow, namely, an LED segment 175 is switched into the series LED 140 current path when it is not being bypassed by a switch 110, and an LED segment 175 is switched out of the series LED 140 current path when it is being bypassed by or through a switch 110. Stated another way, an LED segment 175 is switched into the series LED 140 current path when the current it receives has not been bypassed or routed elsewhere by a switch 110, and an LED segment 175 is switched out of the series LED 140 current path when it does not receive current because the current is being routed elsewhere by a switch 110.

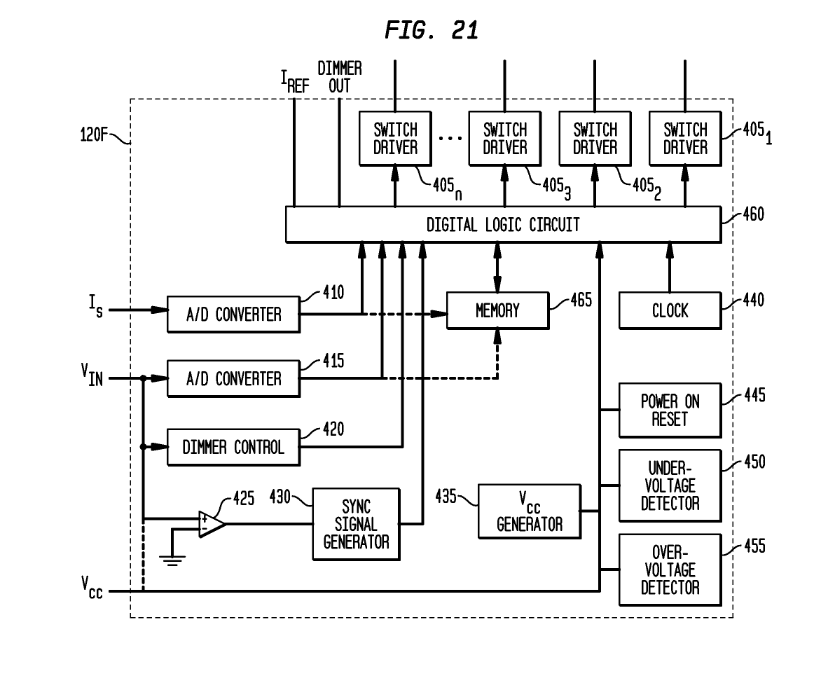

Similarly, it is to be understood that the controller generates corresponding control signals to the plurality of switches 110 to selectively switch corresponding LED segments 175 of the plurality of LED segments 175 into or out of the series LED 140 current path, such as a comparatively high voltage signal (binary logic one) to a corresponding gate or base of a switch 110 when embodied as a FET or BJT, and such as a comparatively low voltage signal (binary logic zero) to a corresponding gate or base of a switch 110 also when embodied as a FET or BJT. Accordingly, a reference to the controller 110 “switching” an LED segment 175 into or out of the series LED 140 current path is to be understood to implicitly mean and include the controller generating corresponding control signals to the plurality of switches 110 and/or to any intervening driver or buffer circuits (illustrated in FIG. 21 as switch drivers 405) to switch the LED segment 175 into or out of the series LED 140 current path.

An advantage of this switching configuration is that by default, in the event of an open-circuit switch failure, LED segments 175 are electrically coupled into the series LED 140 current path, rather than requiring current flow through a switch in order for an LED segment 175 to be in the series LED 140 current path, such that the lighting device continues to operate and provide output light.

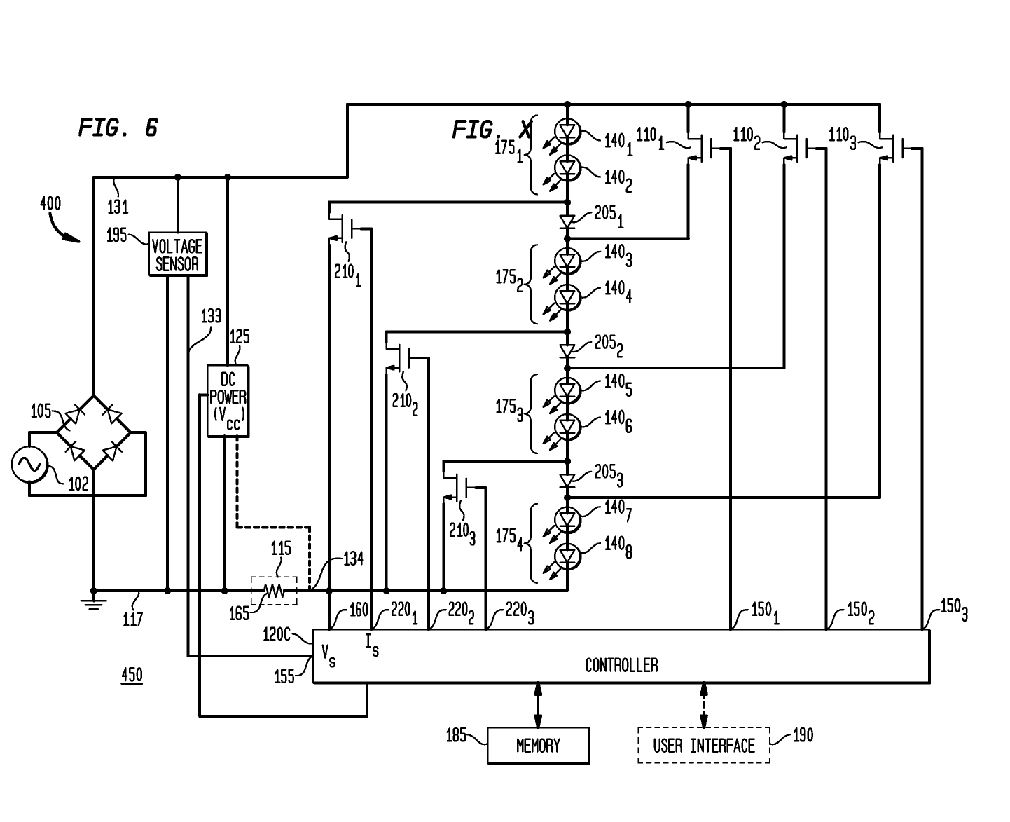

Various other exemplary embodiments, however, such as apparatus 400 discussed below with reference to FIG. 6, also provide for switching of LED segments 175 into and out of both parallel and series LED 140 current paths, such as one or more LED segments 175 switched into a first series LED 140 current path, one or more LED segments 175 switched into a second series LED 140 current path, which then may be switched to be in parallel with each other, for example and without limitation. Accordingly, to accommodate the various circuit structures and switching combinations of the exemplary embodiments, an “LED 140 current path” will mean and include either or both a series LED 140 current path or a parallel LED 140 current path, and/or any combinations thereof. Depending upon the various circuit structures, those having skill in the electronic arts will recognize which LED 140 current paths may be a series LED 140 current path and which may be a parallel LED 140 current path, or a combination of both.

Given this switching configuration, a wide variety of switching schemes are possible, with corresponding current provided to one or more LED segments 175 in any number of corresponding patterns, amounts, durations, and times, with current provided to any number of LED segments 175, from one LED segment 175 to several LED segments 175 to all LED segments 175. For example, for a time period t₁ (e.g., a selected starting time and a duration), switch 110₁ is on and conducting and the remaining switches 110 are off, and current flows through LED segment 175₁ and bypasses LED segments 175₂ through 175ₙ; for a time period t₂, switch 110₂ is on and conducting and the remaining switches 110 are off, and current flows through LED segments 175₁ and 175₂, and bypasses LED segments 175₃ through 175ₙ; for a time period t₃, switch 110₃ is on and conducting and the remaining switches 110 are off, and current flows through LED segments 175₁, 175₂, and 175₃, and bypasses the remaining LED segments (through 175ₙ); and for a time period tₙ, none of the switches 110 is on and conducting (all switches 110 are off), and current flows through all of the LED segments 175₁, 175₂, 175₃ through 175ₙ.

In a first exemplary embodiment, a plurality of time periods t₁ through tₙ and/or corresponding input voltage levels (V_{IN}) (V_{IN1}, V_{IN2}, through V_{INn}) and/or other parameter levels are determined for switching current (through switches 110), which substantially correspond to or otherwise track (within a predetermined variance or other tolerance or desired specification) the rectified AC voltage (provided by AC line 102 via rectifier 105) or more generally the AC voltage, such that current is provided through most or all LED segments 175 when the rectified AC voltage is comparatively high, and current is provided through fewer, one or no LED segments 175 when the rectified AC voltage is comparatively low or close to zero. Those having skill in the electronic arts will recognize and appreciate that a wide variety of parameter levels may be utilized equivalently, such as time periods, peak current or voltage levels, average current or voltage levels, moving average current or voltage levels, instantaneous current or voltage levels, output (average, peak, or instantaneous) optical brightness levels, for example and without limitation, and that any and all such variations are within the scope of the claimed invention. In a second exemplary embodiment, a plurality of time periods t₁ through tₙ and/or corresponding input voltage levels (V_{IN}) (V_{IN1}, V_{JN2}, through V_{INn}) and/or other parameter levels (e.g., output optical brightness levels) are determined for switching current (through switches 110) which correspond to a desired lighting effect such as dimming (selected or input into apparatus 100 via coupling to a dimmer switch or user input via (optional) user interface 190), such that current is provided through most or all LED segments 175 when the rectified AC voltage is comparatively high and a higher brightness is selected, and current is provided through fewer, one or no LED segments 175 when a lower brightness is selected. For example, when a comparatively lower level of brightness is selected, current may be provided through comparatively fewer or no LED segments 175 during a given or selected time interval.

In another exemplary embodiment, the plurality of LED segments 175 may be comprised of different types of LEDs 140 having different light emission spectra, such as light emission having wavelengths in the red, green, blue, amber, etc., visible ranges. For example, LED segment 175₁ may be comprised of red LEDs 140, LED segment 175₂ may be comprised of green LEDs 140, LED segment 175₃ may be comprised of blue LEDs 140, another LED segment 175ₙ₋₁ may be comprised of amber or white LEDs 140, and so on. In such an exemplary embodiment, a plurality of time periods t₁ through tₙ and/or corresponding input voltage levels (V_{IN}) (V_{IN1}, V_{IN2}, through V_{INn}) and/or other parameter levels are determined for switching current (through switches 110) which correspond to another desired, architectural lighting effect such as ambient or output color control, such that current is provided through corresponding LED segments 175 to provide corresponding light emissions at corresponding wavelengths, such a red, green, blue, amber, and corresponding combinations of such wavelengths (e.g., yellow as a combination of red and green). Those having skill in the art will recognize innumerable switching patterns and types of LEDs 140 which may be utilized to achieve any selected lighting effect, any and all of which are within the scope of the invention as claimed.

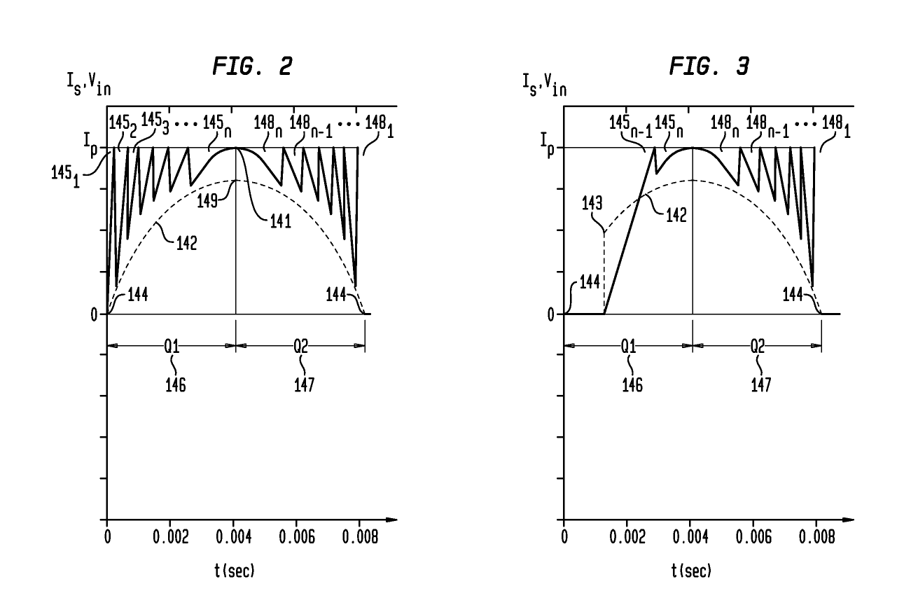

In a first exemplary embodiment mentioned above, in which a plurality of time periods t₁ through tₙ and/or corresponding input voltage levels (V_{IN}) (V_{IN1}, V_{IN2}, through V_{INn}) and/or other parameter levels are determined for switching current (through switches 110) which substantially correspond to or otherwise track (within a predetermined variance or other tolerance or desired specification) the rectified AC voltage (provided by AC source 102 via rectifier 105), the controller 120 periodically adjusts the number of serially-coupled LED segments 175 to which current is provided, such that current is provided through most or all LED segments 175 when the rectified AC voltage is comparatively high, and current is provided through fewer, one or no LED segments 175 when the rectified AC voltage is comparatively low or close to zero. For example, in a selected embodiment, peak current (“I_{P}”) through the LED segments 175 is maintained substantially constant, such that as the rectified AC voltage level increases and as current increases to a predetermined or selected peak current level through the one or more LED segments 175 which are currently connected in the series path, additional LED segments 175 are switched into the serial path; conversely, as the rectified AC voltage level decreases, LED segments 175 which are currently connected in the series path are successively switched out of the series path and bypassed. Such current levels through LEDs 140 due to switching in of LED segments 175 (into the series LED 140 current path), followed by switching out of LED segments 175 (from the series LED 140 current path) is illustrated in FIGS. 2 and 3. More particularly, FIG. 2 is a graphical diagram illustrating a first exemplary load current waveform (e.g., full brightness levels) and input voltage levels in accordance with the teachings of the present invention, and

FIG. 3 is a graphical diagram illustrating a second exemplary load current waveform (e.g., lower or dimmed brightness levels) and input voltage levels in accordance with the teachings of the present invention.

Referring to FIGS. 2 and 3, current levels through selected LED segments 175 are illustrated during a first half of a rectified 60 Hz AC cycle (with input voltage V_{IN} illustrated as dotted line 142), which is further divided into a first time period (referred to as time quadrant “Q1” 146), as a first part or portion of an AC (voltage) interval, during which the rectified AC line voltage increases from about zero volts to its peak level, and a second time period (referred to as time quadrant “Q2” 147), as a second part or portion of an AC (voltage) interval, during which the rectified AC line voltage decreases from its peak level to about zero volts. As the AC voltage is rectified, time quadrant “Q1” 146 and time quadrant “Q2” 147 and the corresponding voltage levels are repeated during a second half of a rectified 60 Hz AC cycle. (It should also be noted that the rectified AC voltage V_{IN} is illustrated as an idealized, textbook example, and is likely to vary from this depiction during actual use.) Referring to FIG. 2, for each time quadrant Q1 and Q2, as an example and without limitation, seven time intervals are illustrated, corresponding to switching seven LED segments 175 in or out of the series LED 140 current path. During time interval 145₁, at the beginning of the AC cycle, switch 110₁ is on and conducting and the remaining switches 110 are off, current (“I_{S}”) flows through LED segment 175₁ and rises to a predetermined or selected peak current level I_{P}. Using current sensor 115, when the current reaches I_{P}, the controller 120 switches in a next LED segment 175₂ by turning on switch 110₂, turning off switch 110₁, and keeping the remaining switches 110 off, thereby commencing time interval 145₂. The controller 120 also measures or otherwise determines either the duration of the time interval 145₁ or an equivalent parameter, such as the line voltage level at which I_{P} was reached for this particular series combination LED segments 175, (which, in this instance, is just a first LED segment 175₁) such as by using a voltage sensor 195 illustrated in various exemplary embodiments, and stores the corresponding information in memory 185 or another register or memory. This interval information for the selected combination of LED segments 175, whether a time parameter, a voltage parameter, or another measurable parameter, is utilized during the second time quadrant “Q2” 147 for switching corresponding LED segments 175 out of the series LED 140 current path (generally in the reverse order).

Continuing to refer to FIG. 2, during time interval 145₂, which is slightly later in the AC cycle, switch 110₂ is on and conducting and the remaining switches 110 are off, current (“I_{S}”) flows through LED segments 175₁ and 175₂, and again rises to a predetermined or selected peak current level I_{P}. Using current sensor 115, when the current reaches I_{P}, the controller 120 switches in a next LED segment 175₃ by turning on switch 110₃, turning off switch 110₂, and keeping the remaining switches 110 off, thereby commencing time interval 145₃. The controller 120 also measures or otherwise determines either the duration of the time interval 145₂ or an equivalent parameter, such as the line voltage level at which I_{P} was reached for this particular series combination LED segments 175 (which, in this instance, is LED segments 175₁ and 175₂), and stores the corresponding information in memory 185 or another register or memory. This interval information for the selected combination of LED segments 175, whether a time parameter, a voltage parameter, or another measurable parameter, is also utilized during the second time quadrant “Q2” 147 for switching corresponding LED segments 175 out of the series LED 140 current path. As the rectified AC voltage level increases, this process continues until all LED segments 175 have been switched into the series LED 140 current path (i.e., all switches 110 are off and no LED segments 175 are bypassed), time interval 145ₙ, with all corresponding interval information stored in memory 185.

Accordingly, as the rectified AC line voltage (V_{IN}, 142 in FIGS. 2 and 3) has increased, the number of LEDs 140 which are utilized has increased correspondingly, by the switching in of additional LED segments 175. In this way, LED 140 usage substantially tracks or corresponds to the AC line voltage, so that appropriate currents may be maintained through the LEDs 140 (e.g., within LED device specification), allowing full utilization of the rectified AC line voltage without complicated energy storage devices and without complicated power converter devices. This apparatus 100 configuration and switching methodology thereby provides a higher efficiency, increased LED 140 utilization, and allows use of many, generally smaller LEDs 140, which also provides higher efficiency for light output and better heat dissipation and management.

In addition, due to the switching frequency, changes in output brightness through the switching of LED segments 175 in or out of the series LED 140 current path is generally not perceptible to the average human observer.

When there are no balancing resistors, the jump in current from before to after switching, during time quadrant “Q1” 146 (with increasing rectified AC voltage), is (Equation 1):

$$Δ I = \frac{Δ N}{N + Δ N} ( \frac{{V}_{switch}}{NRd} ) ,$$

where “Vswitch” is the line voltage when switching occurs, “Rd” is the dynamic impedance of one LED 140, “N” is the number of LEDs 140 in the series LED 140 current path prior to the switching in of another LED segment 175, and ΔN is the number of additional LEDs 140 which are being switched in to the series

LED 140 current path. A similar equation may be derived when voltage is decreasing during time quadrant “Q2” 147. (Of course, the current jump will never cause the current to become negative, as the diode current will just drop to zero in this case.) Equation 1 indicates that the current jump is decreased by making ΔN small compared to the number of conducting LEDs 140 or by having LEDs with comparatively higher dynamic impedance, or both.

In an exemplary embodiment, during second time quadrant “Q2” 147, as the rectified AC line voltage decreases, the stored interval, voltage or other parameter information is utilized to sequentially switch corresponding LED segments 175 out of the series LED 140 current path in reverse order (e.g., “mirrored”), beginning with all LED segments 175 having been switched into the series LED 140 current path (at the end of Q1) and switching out a corresponding LED segment 175 until only one (LED segment 175₁) remains in the series LED 140 current path. Continuing to refer to FIG. 2, during time interval 148ₙ, which is the interval following the peak or crest of the AC cycle, all LED segments 175 have been switched into the series LED 140 current path (all switches 110 are off and no LED segments 175 are bypassed), current (“I_{S}”) flows through all LED segments 175, and decreases from its predetermined or selected peak current level I_{P}. Using the stored interval, voltage or other parameter information, such as a corresponding time duration or a voltage level, when the corresponding amount of time has elapsed or the rectified AC input voltage has decreased to the stored voltage level, or other stored parameter level has been reached, the controller 120 switches out a next LED segment 175ₙ by turning on switch 110ₙ₋₁, and keeping the remaining switches 110 off, thereby commencing time interval 148ₙ₋₁. During the next time interval 148ₙ₋₁, all LED segments 175 other than LED segment 175ₙ are still switched into the series LED 140 current path, current I_{S} flows through these LED segments 175, and again decreases from its predetermined or selected peak current level I_{P}. Using the stored interval information, also such as a corresponding time duration or a voltage level, when the corresponding amount of time has elapsed, voltage level has been reached, or other stored parameter level has been reached, the controller 120 switches out a next LED segment 175ₙ₋₁ by turning on switch 110ₙ₋₂, turning off switch 110ₙ₋₁, and keeping the remaining switches 110 off, thereby commencing time interval 148ₙ₋₂. As the rectified AC voltage level decreases, this process continues until only one LED segment 175₁ remains in the series LED 140 current path, time interval 148₁, and the switching process may commence again, successively switching additional LED segments 175 into the series LED 140 current path during a next first time quadrant “Q1” 146.

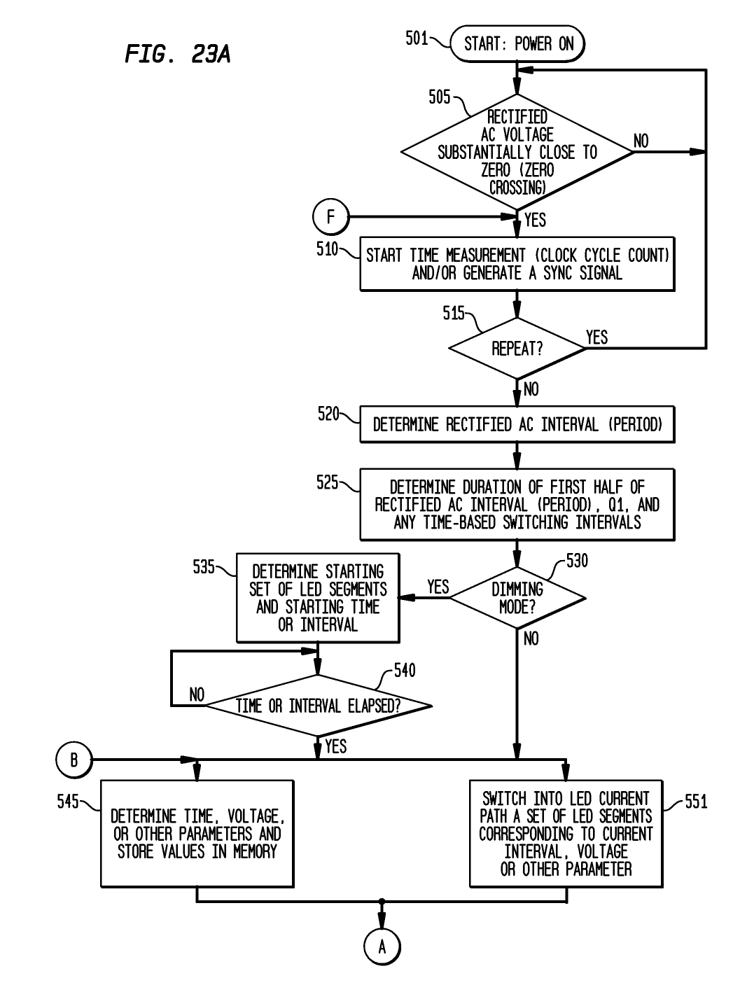

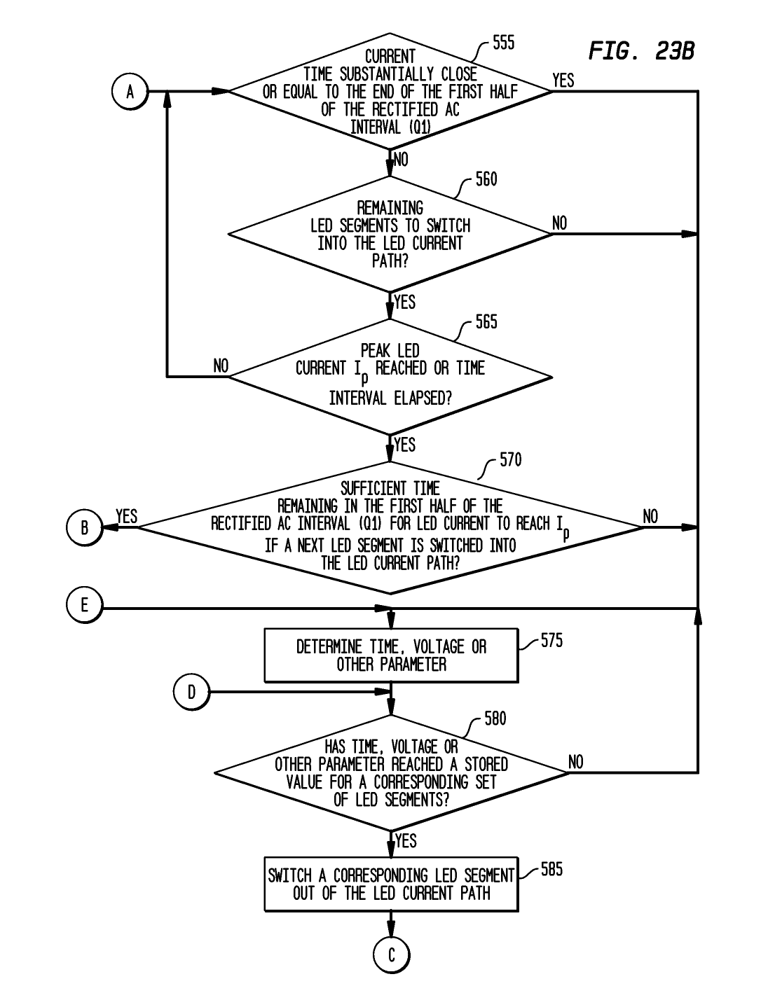

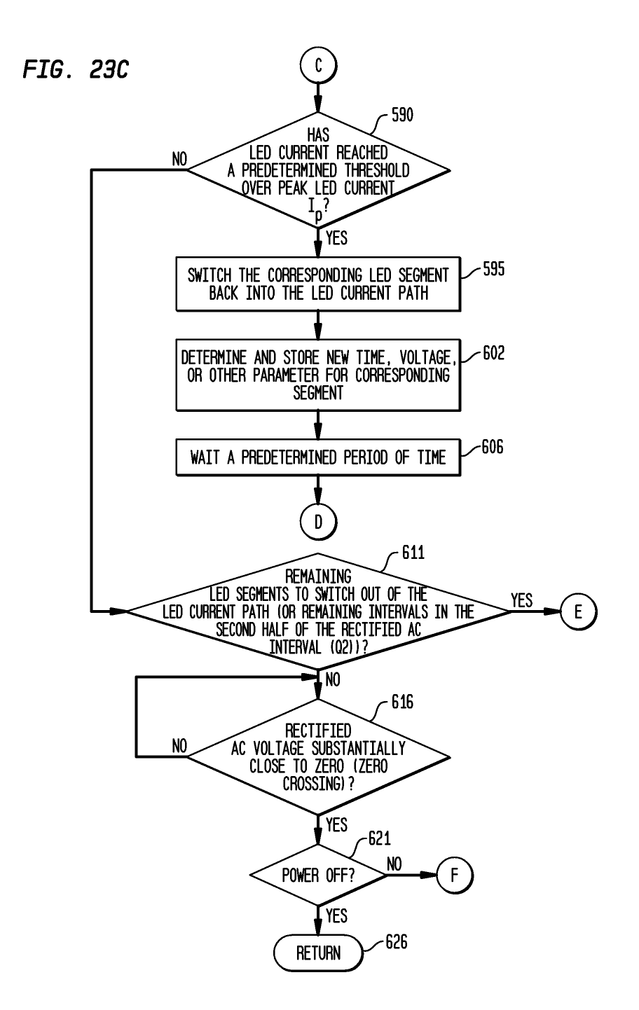

As mentioned above, a wide variety of parameters may be utilized to provide the interval information utilized for switching control in the second time quadrant “Q2” 147, such as time duration (which may be in units of time, or units of device clock cycle counts, etc.), voltage levels, current levels, and so on. In addition, the interval information used in time quadrant “Q2” 147 may be the information determined in the most recent preceding first time quadrant “Q1” 146 or, in accordance with other exemplary embodiments, may be adjusted or modified, as discussed in greater detail below with reference to FIG. 23, such as to provide increased power factor correction, changing thresholds as the temperature of the LEDs 140 may increase during use, digital filtering to reduce noise, asymmetry in the provided AC line voltage, unexpected voltage increases or decreases, other voltage variations in the usual course, and so on. In addition, various calculations may also be performed, such as time calculations and estimations, such as whether sufficient time remains in a given interval for the LED 140 current level to reach I_{P}, for power factor correction purposes, for example. Various other processes may also occur, such as current limiting in the event I_{P} may be or is becoming exceeded, or other current management, such as for drawing sufficient current for interfacing to various devices such as dimmer switches.

In addition, additional switching schemes may also be employed in exemplary embodiment, in addition to the sequential switching illustrated in FIG. 2. For example, based upon real time information, such as a measured increase in rectified AC voltage levels, additional LED segments 175 may be switched in, such as jumping from two LED segments 175 to five LED segments 175, for example and without limitation, with similar non-sequential switching available to voltage drops, etc., such that any type of switching, sequential, non-sequential, and so on, and for any type of lighting effect, such as full brightness, dimmed brightness, special effects, and color temperature, is within the scope of the claimed invention.

Another switching variation is illustrated in FIG. 3, such as for a dimming application. As illustrated, sequential switching of additional LED segments 175 into the series LED 140 current path during a next first time quadrant “Q1” 146 is not performed, with various LED segment 175 combinations skipped. For such an application, the rectified AC input voltage may be phase modulated, e.g., no voltage provided during a first portion or part (e.g., 30-70 degrees) of each half of the AC cycle, with a more substantial jump in voltage then occurring at that phase (143 in FIG. 3). Instead, during time interval 145ₙ₋₁, all LED segments 175 other than LED segment 175ₙ have been switched into the series LED 140 current path, with the current I_{S} increasing to I_{P} comparatively more slowly, thereby changing the average LED 140 current and reducing output brightness levels. While not separately illustrated, similar skipping of LED segments 175 may be performed in Q2, also resulting in decreased output brightness levels. Those having skill in the electronic arts will recognize innumerable different switching combinations which may be implemented to achieve such brightness dimming, in addition to that illustrated, and all such variations are within the scope of the invention as claimed, including modifying the average current value during each interval, or pulse width modulation during each interval, in addition to the illustrated switching methodology.

Those having skill in the electronic arts will recognize innumerable different switching interval schemes and corresponding switching methods which may be implemented within the scope of the claimed invention. For example, a given switching interval may be predetermined or otherwise determined in advance for each LED segment 175 individually, and may be equal or unequal to other switching intervals; switching intervals may be selected or programmed to be equal for each LED segment 175; switching intervals may be determined dynamically for each LED segment 175, such as for a desirable or selected lighting effect; switching intervals may be determined dynamically for each LED segment 175 based upon feedback of a measured parameter, such as a voltage or current level; switching intervals may be determined dynamically or predetermined to provide an equal current for each LED segment 175; switching intervals may be determined dynamically or predetermined to provide an unequal current for each LED segment 175, such as for a desirable or selected lighting effect; etc.

It should also be noted that the various exemplary apparatus embodiments are illustrated as including a rectifier 105, which is an option but is not required. Those having skill in the art will recognize that the exemplary embodiments may be implemented using a non-rectified AC voltage or current. In addition, exemplary embodiments may also be constructed using one or more LED segments 175 connected in an opposite polarity (or opposite direction), or with one set of LED segments 175 connected in a first polarity (direction) and another set of LED segments 175 connected in a second polarity (an opposing or antiparallel direction), such that each may receive current during different halves of a non-rectified AC cycle, for example and without limitation. Continuing with the example, a first set of LED segments 175 may be switched (e.g., sequentially or in another order) to form a first LED 140 current path during a first half of a non-rectified AC cycle, and a second set of LED segments 175 arranged in an opposing direction or polarity may be switched (e.g., sequentially or in another order) to form a second LED 140 current path during a second half of a non-rectified AC cycle.

Further continuing with the example, for a non-rectified AC input voltage, for a first half of the AC cycle, now divided into Q1 and Q2, during Q1 as a first part or portion of the AC voltage interval, various embodiments may provide for switching a first plurality of segments of light emitting diodes to form a first series light emitting diode current path, and during Q2, as a second part or portion of the AC voltage interval, switching the first plurality of segments of light emitting diodes out of the first series light emitting diode current path. Then, for the second half of the AC cycle, which may now be correspondingly divided into a Q3 part or portion and a Q4 part or portion (respectively identical to Q1 and Q2 but having the opposite polarity), during a third portion (Q3) of the AC voltage interval, various embodiments may provide for switching a second plurality of segments of light emitting diodes to form a second series light emitting diode current path having a polarity opposite the series light emitting diode current path formed in the first portion of the AC voltage interval, and during a fourth portion (Q4) of the AC voltage interval, switching the second plurality of segments of light emitting diodes out of the second series light emitting diode current path. All such variations are considered equivalent and within the scope of the claimed invention.

As mentioned above, exemplary embodiments may also provide substantial or significant power factor correction. Referring again to FIG. 2, exemplary embodiments may provide that the LED 140 current reaches a peak value (141) at substantially about the same time as the and input voltage level V_{IN} (149). In various embodiments, before switching in a next segment, such as LED segment 175ₙ, which may cause a decrease in current, a determination may be made whether sufficient time remains in quadrant Q1 to reach I_{P} if the next LED segment 175 were switched into the series LED 140 current path. If sufficient time remains in Q1, the next LED segment 175 is switched into the series LED 140 current path, and if not, no additional LED segment 175 is switched in. In the latter case, the LED 140 current may exceed the peak value I_{P} (not separately illustrated in FIG. 2), provided the actual peak LED 140 current is maintained below a corresponding threshold or other specification level, such as to avoid potential harm to the LEDs 140 or other circuit components. Various current limiting circuits, to avoid such excess current levels, are discussed in greater detail below.

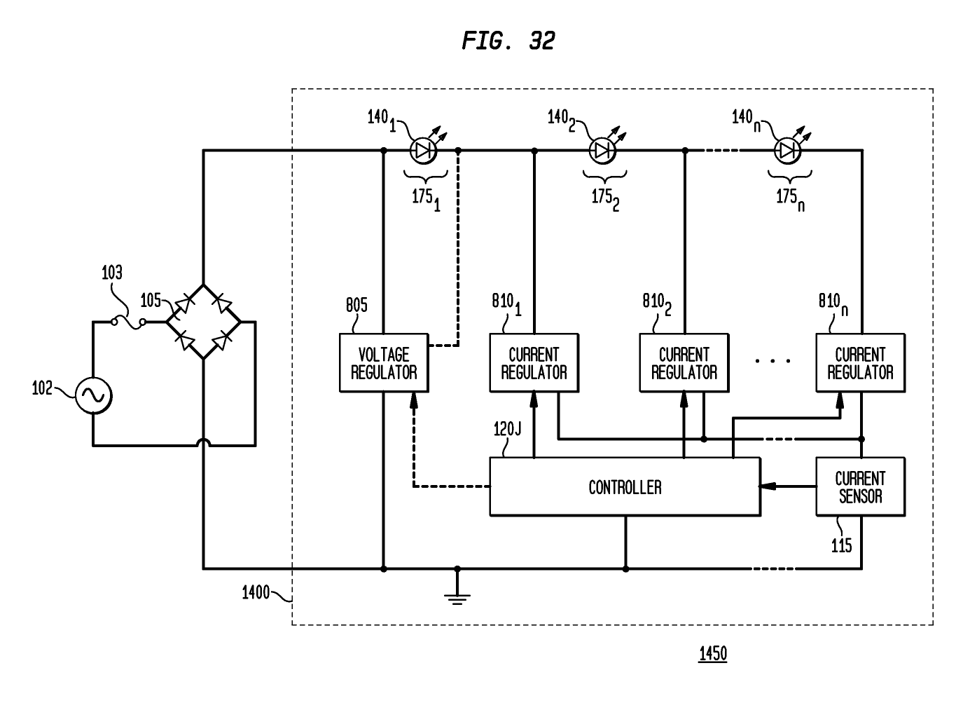

FIG. 4 is a block and circuit diagram illustrating a second exemplary system 250, a second exemplary apparatus 200, and a first exemplary voltage sensor 195A in accordance with the teachings of the present invention. Second exemplary system 250 comprises the second exemplary apparatus 200 (also referred to equivalently as an off line AC LED driver) coupled to an alternating current (“AC”) line 102. The second exemplary apparatus 200 also comprises a plurality of LEDs 140, a plurality of switches 110 (illustrated as MOSFETs, as an example), a controller 120A, a current sensor 115, a rectifier 105, first current regulators 180 (illustrated as being implemented by operational amplifiers, as an exemplary embodiment), complementary switches 111 and 112, and as an option, a first exemplary voltage sensor 195A (illustrated as a voltage divider, using resistors 130 and 135) for providing a sensed input voltage level to the controller 120A. Second current regulators 810, controlled current sources 815, and other exemplary implementations are also illustrated and discussed below with reference to FIGS. 32-42 and 44-46, which may be utilized equivalently. Also optional, a memory 185 and/or a user interface 190 also may be included as discussed above. For ease of illustration, a DC power source circuit 125 is not illustrated separately in FIG. 4, but may be included in any circuit location as discussed above and as discussed in greater detail below.

The second exemplary system 250 and second exemplary apparatus 200 operate similarly to the first system 50 and first apparatus 100 discussed above as far as the switching of LED segments 175 in or out of the series LED 140 current path, but utilizes a different feedback mechanism and a different switching implementation, allowing separate control over peak current for each set of LED segments 175 (e.g., a first peak current for LED segment 175₁; a second peak current for LED segments 175₁ and 175₂; a third peak current for LED segments 175₁, 175₂, and 175₃; through an n^{th} peak current level for all LED segments 175₁ through 175ₙ. More particularly, feedback of the measured or otherwise determined current level I_{S} from current sensor 115 is provided to a corresponding inverting terminal of current regulators 180, illustrated as current regulators 180₁, 180₂, 180₃, through 180ₙ, implemented as operational amplifiers which provide current regulation. A desired or selected peak current level for each corresponding set of LED segments 175, illustrated as I_{P1}, I_{P2}, I_{P3} though I_{Pn}, is provided by the controller 120A (via outputs 170₁, 170₂, 170₃, through 170ₙ) to the corresponding non-inverting terminal of current regulators 180. An output of each current regulator 180₁, 180₂, 180₃, through 180ₙ is coupled to a gate of a corresponding switch 110₁, 110₂, 110₃, through 110ₙ, and in addition, complementary switches 111 (111₁, 111₂, 111₃, through 111ₙ) and 112 (112₁, 112₂, 112₃, through 112ₙ) each have gates coupled to and controlled by the controller 120A (via outputs 172₁, 172₂, 172₃, through 172ₙ for switches 111 and via outputs 171₁, 171₂, 171₃, through 171ₙ for switches 112), thereby providing tri-state control and more fine-grained current regulation. A first, linear control mode is provided when none of the complementary switches 111 and 112 are on and a switch 110 is controlled by a corresponding current regulator 180, which compares the current I_{S} fed back from the current sensor 115 to the set peak current level provided by the controller 120, thereby gating the current through the switch 110 and corresponding set of LED segments 175. A second, saturated control mode is provided when a complementary switch 111 is on and the corresponding switch 112 is off. A third, disabled control mode is provided when a complementary switch 112 is on and the corresponding switch 111 is off, such that current does not flow through the corresponding switch 110. The control provided by second exemplary system 250 and second exemplary apparatus 200 allows flexibility in driving corresponding sets of LED segments 175, with individualized settings for currents and conduction time, including without limitation skipping a set of LED segments 175 entirely.

FIG. 5 is a block and circuit diagram illustrating a third exemplary system 350 and a third exemplary apparatus 300 in accordance with the teachings of the present invention. Third exemplary system 350 also comprises the third exemplary apparatus 300 (also referred to equivalently as an off line AC LED driver) coupled to an alternating current (“AC”) line 102. The third exemplary apparatus 300 comprises a plurality of LEDs 140, a plurality of switches 110 (illustrated as MOSFETs, as an example), a controller 120B, a current sensor 115, a rectifier 105, and as an option, a voltage sensor 195 (illustrated as voltage sensor 195A, a voltage divider, using resistors 130 and 135) for providing a sensed input voltage level to the controller 120B. Also optional, a memory 185 and/or a user interface 190 also may be included as discussed above. For ease of illustration, a DC power source circuit 125 is not illustrated separately in FIG. 5, but may be included in any circuit location as discussed above and as discussed in greater detail below.

Although illustrated with just three switches 110 and three LED segments 175, this system 350 and apparatus 300 configuration may be easily extended to additional LED segments 175 or reduced to a fewer number of LED segments 175. In addition, while illustrated with one, two and four LEDs 140 in LED segments 175₁, 175₂, and 175₃, respectively, the number of LEDs 140 in any given LED segment 175 may be higher, lower, equal or unequal, and all such variations are within the scope of the claimed invention. In this exemplary apparatus 300 and system 350, each switch 110 is coupled to each corresponding terminal of a corresponding LED segment 175, i.e., the drain of switch 110₁ is coupled to a first terminal of LED segment 175₁ (at the anode of LED 140₁) and the source of switch 110₁ is coupled to a second terminal of LED segment 175₁ (at the cathode of LED 140₁); the drain of switch 110₂ is coupled to a first terminal of LED segment 175₂ (at the anode of LED 140₂) and the source of switch 110₂ is coupled to a second terminal of LED segment 175₂ (at the cathode of LED 140₃); and the drain of switch 110₃ is coupled to a first terminal of LED segment 175₃ (at the anode of LED 140₄) and the source of switch 110₃ is coupled to a second terminal of LED segment 175₃ (at the cathode of LED 140₇). In this circuit configuration, the switches 110 allow for both bypassing a selected LED segment 175 and for blocking current flow, resulting in seven circuit states using just three switches 110 rather than seven switches. In addition, switching intervals may be selected in advance or determined dynamically to provide any selected usage or workload, such as a substantially balanced or equal workload for each LED segment 175, with each LED segment 175 coupled into the series LED 140 current path for the same duration during an AC half-cycle and with each LED segment 175 carrying substantially or approximately the same current.

Table 1 summarizes the different circuit states for an exemplary apparatus 300 and system 350. In Table 1, as a more general case in which “N” is equal to some integer number of LEDs 140, LED segment 175₁ has “1N” number of LEDs 140, LED segment 175₂ has “2N” number of LEDs 140, and LED segment 175₃ has “3N” number of LEDs 140, with the last column providing the more specific case illustrated in FIG. 5 (N=1) in which LED segment 175₁ has one LED 140, LED segment 175₂ has two LEDs 140, and LED segment 175₃ has four LEDs 140.

TABLE 1

| | | | | Total | |
|---|---|---|---|---|---|
| | | | | number of | |
| | | | | LEDs 140 | Total |
| | | | | on when | number of |
| | | | | N1 = N, | LEDs 140 |
| | Switches | Switches | LED segment | N2 = 2N, | on for |
| State | On | Off | 175 on | N3 = 4N | FIG. 5 |
| 1 | 110₂, 110₃ | 110₁ | 175₁ | N | 1 |
| 2 | 110₁, 110₃ | 110₂ | 175₂ | 2N | 2 |
| 3 | 110₃ | 110₁, 110₂ | 175₁ + 175₂ | 3N | 3 |
| 4 | 110₁, 110₂ | 110₃ | 175₃ | 4N | 4 |
| 5 | 110₂ | 110₁, 110₃ | 175₁ + 175₃ | 5N | 5 |
| 6 | 110₁ | 110₂, 110₃ | 175₂ + 175₃ | 6N | 6 |
| 7 | None | 110₁, 110₂, | 175₁ + 175₂ + | 7N | 7 |
| | | 110₃ | 175₃ | | |

In state one, current flows through LED segment 175₁ (as switch 110₁ is off and current is blocked in that bypass path) and through switches 110₂, 110₃. In state two, current flows through switch 110₁, LED segment 175₂ and switch 110₃. In state three, current flows through LED segment 175₁, LED segment 175₂ and switch 110₃, and so on, as provided in Table 1. It should be noted that as described above with respect to FIGS. 1 and 2, switching intervals and switching states may be provided for exemplary apparatus 300 and system 350 such that as the rectified AC voltage increases, more LEDs 140 are coupled into the series LED 140 current path, and as the rectified AC voltage decreases, corresponding numbers of LEDs 140 are bypassed (switched out of the series LED 140 current path), with changes in current also capable of being modeled using Equation 1. It should also be noted that by varying the number of LED segments 175 and the number of LEDs 140 within each such LED segment 175 for exemplary apparatus 300 and system 350, virtually any combination and number of LEDs 140 may be switched on and off as necessary or desirable for any corresponding lighting effect, circuit parameter (e.g., voltage or current level), and so on. It should also be noted that for this exemplary configuration, all of the switches 110 should not be on and conducting at the same time.

FIG. 6 is a block and circuit diagram illustrating a fourth exemplary system 450 and a fourth exemplary apparatus 400 in accordance with the teachings of the present invention. Fourth exemplary system 450 also comprises the fourth exemplary apparatus 400 (also referred to equivalently as an off line AC LED driver) coupled to an alternating current (“AC”) line 102. The fourth exemplary apparatus 400 also comprises a plurality of LEDs 140, a plurality of (first or “high side”) switches 110 (illustrated as MOSFETs, as an example), a controller 120C, a current sensor 115, a rectifier 105, a plurality of (second or “low side”) switches 210, a plurality of isolation (or blocking) diodes 205, and as an option, a voltage sensor 195 (illustrated as voltage sensor 195A, a voltage divider) for providing a sensed input voltage level to the controller 120B. Also optional, a memory 185 and/or a user interface 190 also may be included as discussed above.

Fourth exemplary system 450 and fourth exemplary apparatus 400 provide for both series and parallel configurations of LED segments 175, in innumerable combinations. While illustrated in FIG. 6 with four LED segments 175 and two LEDs 140 in each LED segment 175 for ease of illustration and explanation, those having skill in the electronic arts will recognize that the configuration may be easily extended to additional LED segments 175 or reduced to a fewer number of LED segments 175 and that the number of LEDs 140 in any given LED segment 175 may be higher, lower, equal or unequal, and all such variations are within the scope of the claimed invention. For some combinations, however, it may be desirable to have an even number of LED segments 175.

The (first) switches 110, illustrated as switches 110₁, 110₂, and 110₃, are correspondingly coupled to a first LED 140 of a corresponding LED segment 175 and to an isolation diode 205, as illustrated. The (second) switches 210, illustrated as switches 210₁, 210₂, and 210₃, are correspondingly coupled to a last LED 140 of a corresponding LED segment 175 and to the current sensor 115 (or, for example, to a ground potential 117, or to another sensor, or to another node). A gate of each switch 210 is coupled to a corresponding output 220 of (and is under the control of) a controller 120C, illustrated as outputs 220₁, 220₂, and 220₃. In this fourth exemplary system 450 and fourth exemplary apparatus 400, each switch 110 and 210 performs a current bypass function, such that when a switch 110 and/or 210 is on and conducting, current flows through the corresponding switch and bypasses remaining (or corresponding) one or more LED segments 175.

In the fourth exemplary system 450 and fourth exemplary apparatus 400, any of the LED segments 175 may be controlled individually or in conjunction with other LED segments 175. For example and without limitation, when switch 210₁ is on and the remaining switches 110 and 210 are off, current is provided to LED segment 175₁ only; when switches 110₁ and 210₂ are on and the remaining switches 110 and 210 are off, current is provided to LED segment 175₂ only; when switches 110₂ and 210₃ are on and the remaining switches 110 and 210 are off, current is provided to LED segment 175₃ only; and when switch 110₃ is on and the remaining switches 110 and 210 are off, current is provided to LED segment 175₄ only.

Also for example and without limitation, any of the LED segments 175 may be configured in any series combination to form a series LED 140 current path, such as: when switch 210₂ is on and the remaining switches 110 and 210 are off, current is provided to LED segment 175₁ and LED segment 175₂ in series only; when switch 110₂ is on and the remaining switches 110 and 210 are off, current is provided to LED segment 175₃ and LED segment 175₄ in series only; when switches 110₁ and 210₃ are on and the remaining switches 110 and 210 are off, current is provided to LED segment 175₂ and LED segment 175₃ in series only; and so on.

In addition, a wide variety of parallel and series combinations LED segments 175 are also available. For example and also without limitation, when all switches 110 and 210 are on, all LED segments 175 are configured in parallel, thereby providing a plurality of parallel LED 140 current paths; when switches 110₂ and 210₂ are on and the remaining switches 110 and 210 are off, LED segment 175₁ and LED segment 175₂ are in series with each other forming a first series LED 140 current path, LED segment 175₃ and LED segment 175₄ are in series with each other forming a second series LED 140 current path, and these two series combinations are further in parallel with each other (series combination of LED segment 175₁ and LED segment 175₂ is in parallel with series combination LED segment 175₃ and LED segment 175₄), forming a parallel LED 140 current path comprising a parallel combination of two series LED 140 current paths; and when all switches 110 and 210 are off, all LED segments 175 are configured to form one series LED 140 current path, as one string of LEDs 140 connected to the rectified AC voltage.

It should also be noted that by varying the number of LED segments 175 and the number of LEDs 140 within each such LED segment 175 for exemplary apparatus 400 and system 450, virtually any combination and number of LEDs 140 may be switched on and off as necessary or desirable for any corresponding lighting effect, circuit parameter (e.g., voltage or current level), and so on, as discussed above, such as for substantially tracking the rectified AC voltage level by increasing the number of LEDs 140 coupled in series, parallel, or both, in any combination.

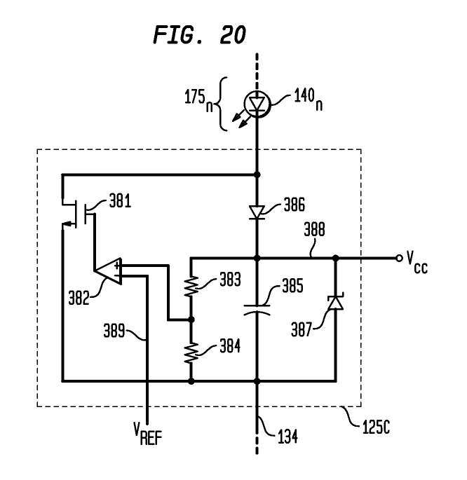

FIG. 7 is a block and circuit diagram illustrating a fifth exemplary system 550 and a fifth exemplary apparatus 500 in accordance with the teachings of the present invention. Fifth exemplary system 550 and a fifth exemplary apparatus 500 are structurally similar to and operate substantially similarly to the first exemplary system 50 and the first exemplary apparatus 100, and differ insofar as fifth exemplary system 550 and fifth exemplary apparatus 500 further comprise a (second) sensor 225 (in addition to current sensor 115), which provides selected feedback to controller 120D through a controller input 230, and also comprises a DC power source circuit 125C, to illustrate another exemplary circuit location for such as power source. FIG. 7 also illustrates, generally, an input voltage sensor 195. An input voltage sensor 195 may also be implemented as a voltage divider, using resistors 130 and 135. For this exemplary embodiment, a DC power source circuit 125C is implemented in series with the last LED segment 175ₙ, and an exemplary third exemplary DC power source circuit 125C is discussed below with reference to FIG. 20.

For example and without limitation, second sensor 225 may be an optical sensor or a thermal sensor. Continuing with the example, in an exemplary embodiment in which second sensor 225 is an optical sensor providing feedback to the controller 120D concerning light emitted from the LEDs 140, the plurality of LED segments 175 may be comprised of different types of LEDs 140 having different light emission spectra, such as light emission having wavelengths in the red, green, blue, amber, etc., visible ranges. For example, LED segment 175₁ may be comprised of red LEDs 140, LED segment 175₂ may be comprised of green LEDs 140, LED segment 175₃ may be comprised of blue LEDs 140, another LED segment 175ₙ₋₁ may be comprised of amber or white LEDs 140, and so on. Also for example, LED segment 175₂ may be comprised of amber or red LEDs 140 while the other LED segments 175 are comprised of white LEDs, and so on. As mentioned above, in such exemplary embodiments, using feedback from the optical second sensor 225, a plurality of time periods t₁ through tₙ may be determined by the controller 120D for switching current (through switches 110) which correspond to a desired or selected architectural lighting effect such as ambient or output color control (i.e., control over color temperature), such that current is provided through corresponding LED segments 175 to provide corresponding light emissions at corresponding wavelengths, such a red, green, blue, amber, white, and corresponding combinations of such wavelengths (e.g., yellow as a combination of red and green). Those having skill in the art will recognize innumerable switching patterns and types of LEDs 140 which may be utilized to achieve any selected lighting effect, any and all of which are within the scope of the invention as claimed.

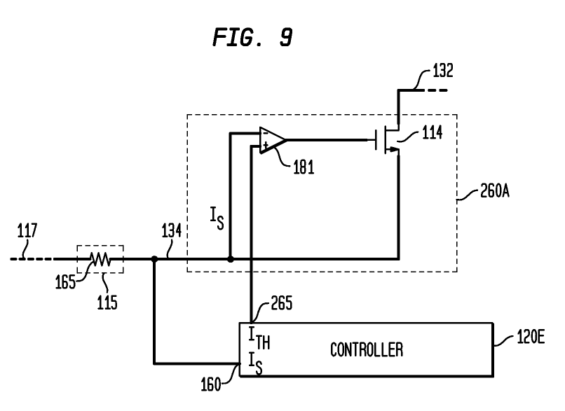

FIG. 8 is a block and circuit diagram illustrating a sixth exemplary system 650 and a sixth exemplary apparatus 600 in accordance with the teachings of the present invention. Sixth exemplary system 650 comprises the sixth exemplary apparatus 600 (also referred to equivalently as an off line AC LED driver) coupled to an AC line 102. The sixth exemplary apparatus 600 also comprises a plurality of LEDs 140, a plurality of switches 110 (also illustrated as MOSFETs, as an example), a controller 120E, a (first) current sensor 115, a rectifier 105, and as an option, a voltage sensor 195 for providing a sensed input voltage level to the controller 120. Also optional, a memory 185 and/or a user interface 190 also may be included as discussed above.

As optional components, the sixth exemplary apparatus 600 further comprises a current limiter circuit 260, 270 or 280, may also comprise an interface circuit 240, may also comprise a voltage sensor 195, and may also comprise a temperature protection circuit 290. A current limiter circuit 260, 270 or 280 is utilized to prevent a potentially large increase in LED 140 current, such as if the rectified AC voltage becomes unusually high while a plurality of LEDs 140 are switched into the series LED 140 current path. A current limiter circuit 260, 270 or 280 may be active, under the control of controller 120E and possibly having a bias or operational voltage, or may be passive and independent of the controller 120E and any bias or operational voltage. While three locations and several different embodiments of current limiting circuits 260, 270 or 280 are illustrated, it should be understood that only one of the current limiter circuits 260, 270 or 280 is selected for any given device implementation. The current limiter circuit 260 is located on the “low side” of the sixth exemplary apparatus 600, between the current sensor 115 (node 134) and the sources of switches 110 (and also a cathode of the last LED 140ₙ) (node 132); equivalently, such a current limiter circuit 260 may also be located between the current sensor 115 and ground potential 117 (or the return path of the rectifier 105). As an alternative, the current limiter circuit 280 is located on the “high side” of the sixth exemplary apparatus 600, between node 131 and the anode of the first LED 140₁ of the series LED 140 current path. As another alternative, a current limiter circuit 270 may be utilized between the “high side” and the “low side” of the sixth exemplary apparatus 600, coupled between the top rail (node 131) and the ground potential 117 (or the low or high (node 134) side of current sensor 115, or another circuit node, including node 131). The current limiter circuits 260, 270 and 280 may be implemented in a wide variety of configurations and may be provided in a wide variety of locations within the sixth exemplary apparatus 600 (or any of the other apparatuses 100, 200, 300, 400, 500, 700, 800, 900, 1000, 1100, 1200, 1300), with several exemplary current limiter circuits 260, 270 and 280 illustrated and discussed with reference to FIGS. 9-12.

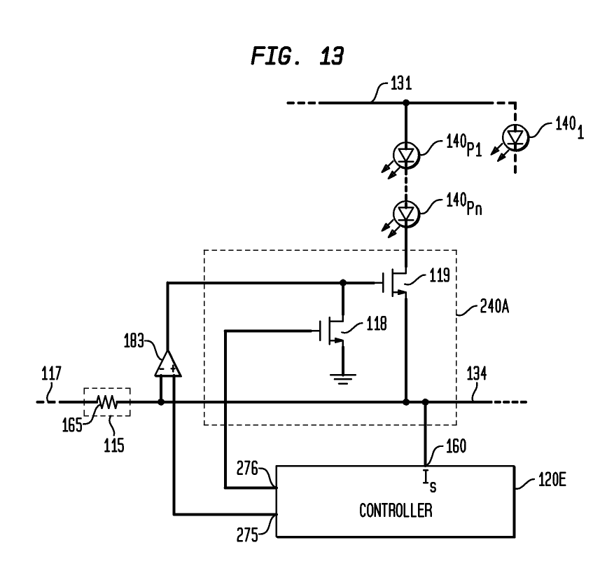

An interface circuit 240 is utilized to provide backwards (or retro-) compatibility with prior art switches, such as a dimmer switch 285 which may provide a phase modulated dimming control and may require a minimum holding or latching current for proper operation. Under various circumstances and at different times during the AC cycle, one or more of the LEDs 140 may or may not be drawing such a minimum holding or latching current, which may result in improper operation of such a dimmer switch 285. Because a device manufacturer generally will not know in advance whether a lighting device such as sixth exemplary apparatus 600 will be utilized with a dimmer switch 285, an interface circuit 240 may be included in the lighting device. Exemplary interface circuits 240 will generally monitor the LED 140 current and, if less than a predetermined threshold (e.g., 50 mA), will draw more current through the sixth exemplary apparatus 600 (or any of the other apparatuses 100, 200, 300, 400, 500, 700, 800, 900, 1000, 1100, 1200, 1300). Exemplary interface circuits 240 may be implemented in a wide variety of configurations and may be provided in a wide variety of locations within the sixth exemplary apparatus 600 (or any of the other apparatuses 100, 200, 300, 400, 500, 700, 800, 900, 1000, 1100, 1200, 1300), with several exemplary interface circuits 240 illustrated and discussed with reference to FIGS. 13-17.

A voltage sensor 195 is utilized to sense an input voltage level of the rectified AC voltage from the rectifier 105. An exemplary input voltage sensor 195 may also be implemented as a voltage divider, using resistors 130 and 135, as discussed above. The voltage sensor 195 may be implemented in a wide variety of configurations and may be provided in a wide variety of locations within the sixth exemplary apparatus 600 (or any of the other apparatuses 100, 200, 300, 400, 500, 700, 800, 900, 1000, 1100, 1200, 1300) as known or becomes known in the electronic arts, in addition to the previously illustrated voltage divider, with all such configurations and locations considered equivalent and within the scope of the invention as claimed.

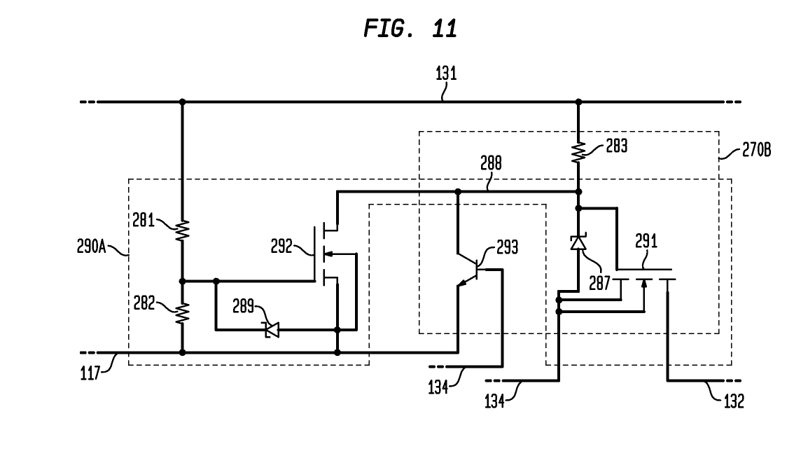

A temperature protection circuit 290 is utilized to detect an increase in temperature over a predetermined threshold, and if such a temperature increase has occurred, to decrease the LED 140 current and thereby serves to provide some degree of protection of the exemplary apparatus 600 from potential temperature-related damage. Exemplary temperature protection circuits 290 may be implemented in a wide variety of configurations and may be provided in a wide variety of locations within the sixth exemplary apparatus 600 (or any of the other apparatuses 100, 200, 300, 400, 500, 700, 800, 900, 1000, 1100, 1200, 1300), with an exemplary temperature protection circuit 290A illustrated and discussed with reference to FIG. 11.

FIG. 9 is a block and circuit diagram illustrating a first exemplary current limiter 260A in accordance with the teachings of the present invention. Exemplary current limiter 260A is implemented on the “low side” of sixth exemplary apparatus 600 (or any of the other apparatuses 100, 200, 300, 400, 500, 700, 800, 900, 1000, 1100, 1200, 1300), between nodes 134 and 132, and is an “active” current limiting circuit. A predetermined or dynamically determined first threshold current level (“I_{TH1}”) (e.g., a high or maximum current level for a selected specification) is provided by controller 120E (output 265) to a non-inverting terminal of error amplifier 181, which compares the threshold current I_{TH1} (as a corresponding voltage) to the current I_{S} (also as a corresponding voltage) through the LEDs 140 (from current sensor 115). When current I_{S} through the LEDs 140 is less than the threshold current I_{TH1}, the output of the error amplifier 181 increases and is high enough to maintain the switch 114 (also referred to as a pass element) in an on state and allowing current I_{S} to flow. When current I_{S} through the LEDs 140 is has increased to be greater than the threshold current I_{TH1}, the output of the error amplifier 181 decreases into in a linear mode, controlling (or gating) the switch 114 in a linear mode and providing for a reduced level of current I_{S} to flow.

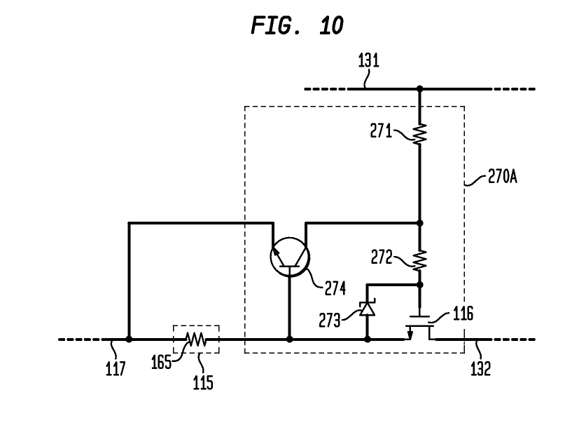

FIG. 10 is a block and circuit diagram illustrating a second exemplary current limiter 270A in accordance with the teachings of the present invention. Exemplary current limiter 270A is implemented between the “high side” (node 131) and the “low side” of sixth exemplary apparatus 600 (or any of the other apparatuses 100, 200, 300, 400, 500, 700, 800, 900, 1000, 1100, 1200, 1300), at node 117 (the low side of current sensor 115) and at node 132 (the cathode of the last series-connected LED 140ₙ), and is a “passive” current limiting circuit. First resistor 271 and second resistor 272 are coupled in series to form a bias network coupled between node 131 (e.g., the positive terminal of rectifier 105) and the gate of switch 116 (also referred to as a pass element), and during typical operation bias the switch 116 in a conduction mode. An NPN transistor 274 is coupled at its collector to second resistor 272 and coupled across its base-emitter junction to current sensor 115. In the event a voltage drop across the current sensor 115 (e.g., resistor 165) reaches a breakdown voltage of the base-emitter junction of transistor 274, the transistor 274 starts conducting, controlling (or gating) the switch 116 in a linear mode and providing for a reduced level of current I_{S} to flow. It should be noted that this second exemplary current limiter 270A does not require any operational (bias) voltage for operation. Zener diode 273 serves to limit the gate-to-source voltage of transistor (FET) 116.

FIG. 11 is a block and circuit diagram illustrating a third exemplary current limiter circuit 270B and a temperature protection circuit 290A in accordance with the teachings of the present invention. Exemplary current limiter 270B also is implemented between the “high side” (node 131) and the “low side” of sixth exemplary apparatus 600 (or any of the other apparatuses 100, 200, 300, 400, 500, 700, 800, 900, 1000, 1100, 1200, 1300), at node 117 (the low side of current sensor 115), at node 134 (the high side of current sensor 115), and at node 132 (the cathode of the last series-connected LED 140ₙ), and is a “passive” current limiting circuit. The third exemplary current limiter 270B comprises resistor 283; zener diode 287; and two switches or transistors, illustrated as transistor (FET) 291 and NPN bipolar junction transistor (BJT) 293. In operation, transistor (FET) 291 is usually on and conducting LED 140 current (between nodes 132 and 134), with a bias provided by resistor 283 and zener diode 287. A voltage across current sensor 115 (between nodes 134 and 117 biases the base emitter junction of transistor 293, and in the event that LED 140 current exceeds the predetermined limit, this voltage will be high enough to turn on transistor 293, which will pull node 288 (and the gate of transistor (FET) 291) toward a ground potential, and decrease the conduction through transistor (FET) 291, thereby limiting the LED 140 current. Zener diode 287 serves to limit the gate-to-source voltage of transistor (FET) 291.

The exemplary temperature protection circuit 290A comprises first resistor 281 and second, temperature-dependent resistor 282 configured as a voltage divider; zener diodes 289 and 287; and two switches or transistors, illustrated as FETs 292 and 291. As operating temperature increases, the resistance of resistor 282 increases, increasing the voltage applied to the gate of transistor (FET) 292, which also will pull node 288 (and the gate of transistor (FET) 291) toward a ground potential, and decrease the conduction through transistor (FET) 291, thereby limiting the LED 140 current. Zener diode 289 also serves to limit the gate-to-source voltage of transistor (FET) 292.

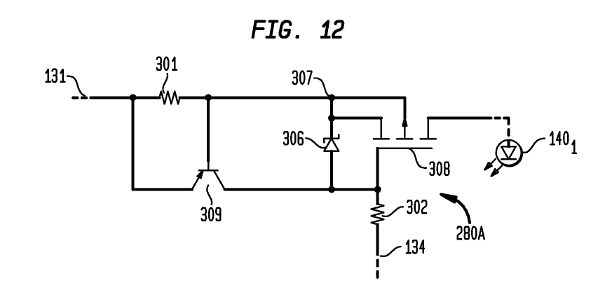

FIG. 12 is a block and circuit diagram illustrating a fourth exemplary current limiter 280A in accordance with the teachings of the present invention. The current limiter circuit 280A is located on the “high side” of the sixth exemplary apparatus 600 (or any of the other apparatuses 100, 200, 300, 400, 500, 700, 800, 900, 1000, 1100, 1200, 1300), between node 131 and the anode of the first LED 140₁ of the series LED 140 current path, and is further coupled to node 134 (the high side of current sensor 115). The fourth exemplary current limiter 280A comprises a second current sensor, implemented as a resistor 301; zener diode 306; and two switches or transistors, illustrated as transistor (P-type FET) 308 and transistor (PNP BJT) 309 (and optional second resistor 302, coupled to node 134 (the high side of current sensor 115)). A voltage across second current sensor 301 biases the emitter-base junction of transistor 309, and in the event that LED 140 current exceeds a predetermined limit, this voltage will be high enough to turn on transistor 309, which will pull node 307 (and the gate of transistor (FET) 308) toward a higher voltage, and decrease the conduction through transistor (FET) 308, thereby limiting the LED 140 current. Zener diode 306 serves to limit the gate-to-source voltage of transistor (FET) 308.

As mentioned above, an interface circuit 240 is utilized to provide backwards (or retro-) compatibility with prior art switches, such as a dimmer switch 285 which may provide a phase modulated dimming control and may require a minimum holding or latching current for proper operation. Exemplary interface circuits 240 may be implemented in a wide variety of configurations and may be provided in a wide variety of locations within the exemplary apparatus apparatuses 100, 200, 300, 400, 500, 600, 700, 800, 900, 1000, 1100, 1200, 1300, including those illustrated and discussed below.

FIG. 13 is a block and circuit diagram illustrating a first exemplary interface circuit 240A in accordance with the teachings of the present invention. Exemplary interface circuit 240A is implemented between the “high side” (node 131) and the “low side” of sixth exemplary apparatus 600 (or any of the other apparatuses 100, 200, 300, 400, 500, 700, 800, 900, 1000, 1100, 1200, 1300), at node 134 (the high side of current sensor 115) or at another low side node 132. The first exemplary interface circuit 240A comprises first and second switches 118 and 119, and error amplifier (or comparator) 183. A pass element illustrated as a switch (FET) 119 is coupled to an additional one or more LEDs 140 (which are in parallel to the series LED 140 current path), illustrated as LEDs 140_{P1} through 140_{Pn}, to provide useful light output and avoid ineffective power losses in the switch 119 when it is conducting. A predetermined or dynamically determined second threshold current level (“I_{TH2}”) (e.g., a minimum holding or latching current level for a dimmer 285) is provided by controller 120E (output 275) to a non-inverting terminal of error amplifier (or comparator) 183, which compares the threshold current I_{TH2} (as a corresponding voltage) to the current level I_{S} (also as a corresponding voltage) through the LEDs 140 (from current sensor 115). The controller 120E also receives information of the current level I_{S} (e.g., as a voltage level) from current sensor 115. When current I_{S} through the LEDs 140 is greater than the threshold current I_{TH2}, such as a minimum holding or latching current, the controller 120E turns on switch 118 (connected to the gate of switch 119), effectively turning the switch 119 off and disabling the current sinking capability of the first exemplary interface circuit 240A, so that the first exemplary interface circuit 240A does not draw any additional current. When current I_{S} through the LEDs 140 is less than the threshold current I_{TH2}, such as being less than a minimum holding or latching current, the controller 120E turns off switch 118, and switch 119 is operated in a linear mode by the output of the error amplifier (or comparator) 183, which allows additional current I_{S} to flow through LEDs 140_{P1} through 140_{Pn} and switch 119.

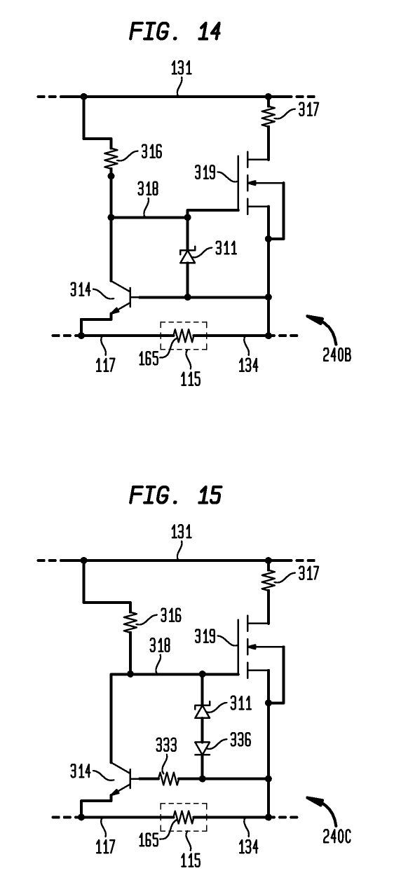

FIG. 14 is a circuit diagram illustrating a second exemplary interface circuit 240B in accordance with the teachings of the present invention. Exemplary interface circuit 240B is implemented between the “high side” (node 131) and the “low side” of sixth exemplary apparatus 600 (or any of the other apparatuses 100, 200, 300, 400, 500, 700, 800, 900, 1000, 1100, 1200, 1300), such as coupled across current sensor 115 (implemented as a resistor 165) at nodes 134 and 117. The second exemplary interface circuit 240B comprises first and second and third resistors 316, 317; zener diode 311 (to clamp the gate voltage of transistor 319); and two switches or transistors, illustrated as N-type FET 319 and transistor (NPN BJT) 314. When current I_{S} through the LEDs 140 is greater than the threshold current I_{TH2}, such as a minimum holding or latching current, a voltage is generated across current sensor 115 (implemented as a resistor 165), which biases the base-emitter junction of transistor 314, turning or maintaining the transistor 314 on and conducting, which pulls node 318 to the voltage of node 117, which in this case is a ground potential, effectively turning or maintaining transistor 319 off and not conducting, disabling the current sinking capability of the second exemplary interface circuit 240B, so that it does not draw any additional current. When current I_{S} through the LEDs 140 is less than the threshold current I_{TH2}, such as being less than a minimum holding or latching current, the voltage generated across current sensor 115 (implemented as a resistor 165) is insufficient to bias the base-emitter junction of transistor 314 and cannot turn or maintain the transistor 314 in an on and conducting state. A voltage generated across resistor 316 pulls node 318 up to a high voltage, turning on transistor 319, which allows additional current I_{S} to flow through resistor 317 and transistor 319.

FIG. 15 is a circuit diagram illustrating a third exemplary interface circuit 240C in accordance with the teachings of the present invention. Exemplary interface circuit 240C may be configured and located as described above for second exemplary interface circuit 240B, and comprises an additional resistor 333 and blocking diode 336, to prevent a potential discharge path through diode 311 and avoid allowing current paths which do not go through current sensor 115 (implemented as a resistor 165).

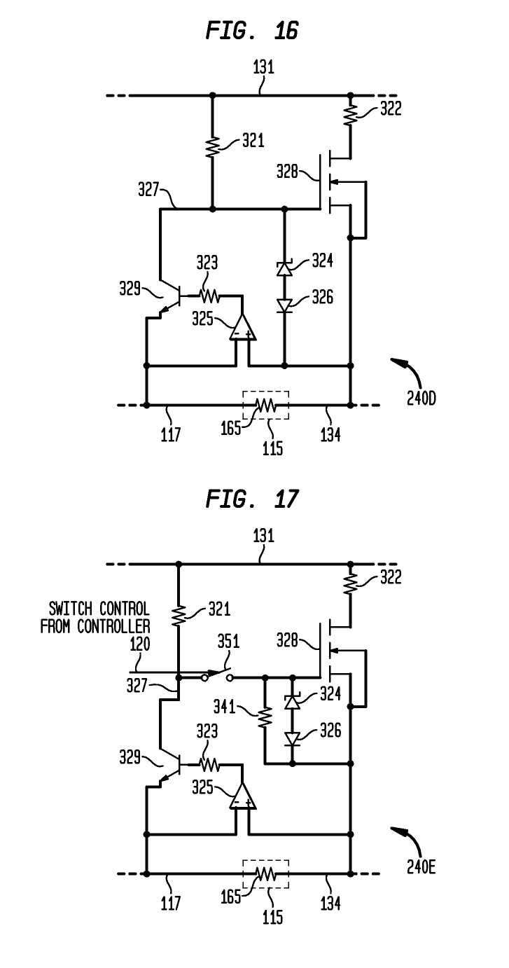

FIG. 16 is a block and circuit diagram illustrating a fourth exemplary interface circuit 240D in accordance with the teachings of the present invention. Exemplary interface circuit 240D is also implemented between the “high side” (node 131) and the “low side” of sixth exemplary apparatus 600 (or any of the other apparatuses 100, 200, 300, 400, 500, 700, 800, 900, 1000, 1100, 1200, 1300), such as coupled across current sensor 115 (implemented as a resistor 165) at nodes 134 and 117. The fourth exemplary interface circuit 240D comprises first, second and third resistors 321, 322 and 323; zener diode 324 (to clamp the gate voltage of transistor 328); blocking diode 326; operational amplifier (“op amp”) 325 and two switches or transistors, illustrated as N-type FET 328 and NPN BJT 329. Op amp 325 amplifies a voltage difference generated across current sensor 115 (implemented as a resistor 165), and allows use of a current sensor 115 which has a comparatively low impedance or resistance. When current I_{S} through the LEDs 140 is greater than the threshold current I_{TH2}, such as a minimum holding or latching current, this amplified voltage (which biases the base-emitter junction of transistor 329), turns or maintains the transistor 329 on and conducting, which pulls node 327 to the voltage of node 117, which in this case is a ground potential, effectively turning or maintaining transistor 328 off and not conducting, disabling the current sinking capability of the second exemplary interface circuit 240C, so that it does not draw any additional current. When current I_{S} through the LEDs 140 is less than the threshold current I_{TH2}, such as being less than a minimum holding or latching current, the amplified voltage is insufficient to bias the base-emitter junction of transistor 329 and cannot turn or maintain the transistor 329 in an on and conducting state. A voltage generated across resistor 321 pulls node 327 up to a high voltage, turning on transistor 328, which allows additional current I_{S} to flow through resistor 322 and transistor 328.

FIG. 17 is a block and circuit diagram illustrating a fifth exemplary interface circuit 240E in accordance with the teachings of the present invention. Exemplary interface circuit 240E may be configured and located as described above for fourth exemplary interface circuit 240D, and comprises an additional resistor 341 and a switch 351 (controlled by controller 120). For this fifth exemplary interface circuit 240E, the various LED segments 175 are also utilized to draw sufficient current, such that the current I_{S} through the LEDs 140 is greater than or equal to the threshold current I_{TH2}. In operation, the LED 140 peak current (I_{P}) is greater than the threshold current I_{TH2} by a significant or reasonable margin, such as 2-3 times the threshold current I_{TH2}. As LED segments 175 are switched into the series LED 140 current path, however, initially the LED 140 current may be less than the threshold current I_{TH2}. Accordingly, when LED segment 175₁ (without any of the remaining LED segments 175) is initially conducting and has a current less than the threshold current I_{TH2}, the controller 120 closes switch 351, and allows transistor 328 to source additional current through resistor 322, until the LED 140 current is greater than threshold current I_{TH2} and transistor 329 pulls node 327 back to a low potential. Thereafter, the controller maintains the switch 351 in an open position, and LED segment 175₁ provides for sufficient current to be maintained through the LED segments 175.

Accordingly, to avoid the level of the LED 140 current falling below the threshold current I_{TH2} as a next LED segment 175 is switched into the series LED 140 current path, when such a next LED segment 175 is being switched into the series LED 140 current path, such as LED segment 175₂, the controller 120 allows two switches 110 to be on and conducting, in this case both switch 110₁ and 110₂, allowing sufficient LED 140 current to continue to flow through LED segment 175₁ while current increases in LED segment 175₂. When sufficient current is also flowing through LED segment 175₂, switch 110₁ is turned off with only switch 110₂ remaining on, and the process continues for each remaining LED segment 175. For example, when such a next LED segment 175 is being switched into the series LED 140 current path, such as LED segment 175₃, the controller 120 also allows two switches 110 to be on and conducting, in this case both switch 110₂ and 110₃, allowing sufficient LED 140 current to continue to flow through LED segment 175₂ while current increases in LED segment 175₃.

Not separately illustrated, another type of interface circuit 240 which may be utilized may be implemented as a constant current source, which draws a current which is greater than or equal to the threshold current I_{TH2}, such as a minimum holding or latching current, regardless of the current I_{S} through the LEDs 140.

FIG. 18 is a circuit diagram illustrating a first exemplary DC power source circuit 125A in accordance with the teachings of the present invention. As mentioned above, exemplary DC power source circuits 125 may be utilized to provide DC power, such as Vcc, for use by other components within exemplary apparatuses 100, 200, 300, 400, 500, 600, 700, 800, 900, 1000, 1100, 1200, 1300. Exemplary DC power source circuits 125 may be implemented in a wide variety of configurations, and may be provided in a wide variety of locations within the sixth exemplary apparatus 600 (or any of the other apparatuses 100, 200, 300, 400, 500, 700, 800, 900, 1000, 1100, 1200, 1300), in addition to the various configurations illustrated and discussed herein, any and all of which are considered equivalent and within the scope of the invention as claimed.

Exemplary DC power source circuit 125A is implemented between the “high side” (node 131) and the “low side” of sixth exemplary apparatus 600 (or any of the other apparatuses 100, 200, 300, 400, 500, 700, 800, 900, 1000, 1100, 1200, 1300), such as at node 134 (the high side of current sensor 115) or at another low side node 132 or 117. Exemplary DC power source circuit 125A comprises a plurality of LEDs 140, illustrated as LEDs 140ᵥ₁, 140ᵥ₂, through 140_{vz}, a plurality of diodes 361, 362, and 363, one or more capacitors 364 and 365, and an optional switch 367 (controlled by controller 120). When the rectified AC voltage (from rectifier 105) is increasing, current is provided through diode 361, which charges capacitor 365, through LEDs 140ᵥₙ through 140_{vz} and through diode 362, which charges capacitor 364. The output voltage Vcc is provided at node 366 (i.e., at capacitor 364). LEDs 140ᵥₙ through 140_{vz} are selected to provide a substantially stable or predetermined voltage drop, such as 18V, and to provide another source of light emission. When the rectified AC voltage (from rectifier 105) is decreasing, capacitor 365 may have a comparatively higher voltage and may discharge through LEDs 140ᵥ₁ through 140ᵥₘ, also providing another source of light emission and utilizing energy for light emission which might otherwise be dissipated, serving to increase light output efficiency. In the event the output voltage Vcc becomes higher than a predetermined voltage level or threshold, overvoltage protection may be provided by the controller 120, which may close switch 367 to reduce the voltage level.

FIG. 19 is a circuit diagram illustrating a second exemplary DC power source circuit 125B in accordance with the teachings of the present invention. Exemplary DC power source circuit 125B is also implemented between the “high side” (node 131) and the “low side” of sixth exemplary apparatus 600 (or any of the other apparatuses 100, 200, 300, 400, 500, 700, 800, 900, 1000, 1100, 1200, 1300), such as at node 134 (the high side of current sensor 115) or at another low side node 132 or 117. Exemplary DC power source circuit 125B comprises a switch or transistor (illustrated as an N-type MOSFET) 374, resistor 371, diode 373, zener diode 372, capacitor 376, and an optional switch 377 (controlled by controller 120). Switch or transistor (MOSFET) 374 is biased to be conductive by a voltage generated across resistor 371 (and clamped by zener diode 372), such that current is provided through diode 373, which charges capacitor 376. The output voltage Vcc is provided at node 378 (i.e., at capacitor 376). In the event the output voltage Vcc becomes higher than a predetermined voltage level or threshold, overvoltage protection also may be provided by the controller 120, which may close switch 377 to reduce the voltage level.

FIG. 20 is a circuit diagram illustrating a third exemplary DC power source circuit 125C in accordance with the teachings of the present invention. Exemplary DC power source circuit 125C is implemented in series with the last LED segment 175ₙ, as discussed above with reference to FIG. 5. Exemplary DC power source circuit 125C comprises a switch or transistor (illustrated as an N-type MOSFET) 381, comparator (or error amplifier) 382, isolation diode 386, capacitor 385, resistors 383 and 384 (configured as a voltage divider), and zener diode 387, and uses a reference voltage V_{REF} provided by controller 120. During operation, current flows through isolation diode 386 and charges capacitor 385, with the output voltage Vcc provided at node 388 (capacitor 385), with zener diode 387 serving to damp transients and avoid overflow of capacitor 385 at start up, and which should generally have a current rating to match the maximum LED 140 current. The resistors 383 and 384 configured as a voltage divider are utilized to sense the output voltage Vcc for use by the comparator 382. When the output voltage Vcc is less than a predetermined level (corresponding to the reference voltage V_{REF} provided by controller 120), the comparator 382 turns transistor (or switch) 381 off, such that most of the LED 140 current charges capacitor 385. When the output voltage Vcc reaches the predetermined level (corresponding to the reference voltage V_{REF}), the comparator 382 will turn on transistor (or switch) 381, allowing the LED 140 current to bypass capacitor 385. As the capacitor 385 provides the energy for the bias source (output voltage Vcc), it is configured to discharge at a rate substantially less than the charging rate. In addition, as at various times the transistor (or switch) 381 is switched off to start a new cycle, comparator 382 is also configured with some hysteresis, to avoid high frequency switching, and the AC ripple across the capacitor 385 is diminished by the value of the capacitance and the hysteresis of the comparator 382, which may be readily determined by those having skill in the electronic arts.

FIG. 21 is a block diagram illustrating an exemplary controller 120F in accordance with the teachings of the present invention. Exemplary controller 120F comprises a digital logic circuit 460, a plurality of switch driver circuits 405, analog-to-digital (“A/D”) converters 410 and 415, and optionally may also include a memory circuit 465 (e.g., in addition to or in lieu of a memory 185), a dimmer control circuit 420, a comparator 425 and sync (synchronous) signal generator 430, a Vcc generator 435 (when another DC power circuit is not provided elsewhere), a power on reset circuit 445, an under-voltage detector 450, an over-voltage detector 455, and a clock 440 (which may also be provided off-chip or in other circuitry). Not separately illustrated, additional components (e.g., a charge pump) may be utilized to power the switch driver circuits 405, which may be implemented as buffer circuits, for example. The various optional components may be implemented as may be necessary or desirable, such as power on reset circuit 445, Vcc generator 435, under-voltage detector 450, and over-voltage detector 455, such as in addition to or in lieu of the other DC power generation, protection and limiting circuitry discussed above.

A/D converter 410 is coupled to a current sensor 115 to receive a parameter measurement (e.g., a voltage level) corresponding to the LED 140 current, and converts it into a digital value, for use by the digital logic circuit 460 in determining, among other things, whether the LED 140 current has reached a predetermined peak value I_{P}. A/D converter 415 is coupled to an input voltage sensor 195 to receive a parameter measurement (e.g., a voltage level) corresponding to the rectified AC input voltage V_{IN}, and converts it into a digital value, also for use by the digital logic circuit 460 in determining, among other things, when to switch LED segments 175 in or out of the series LED 140 current path, as discussed above. The memory 465 (or memory 185) is utilized to store interval, voltage or other parameter information used for determining the switching of the LED segments 175 during Q2. Using the digital input values for LED 140 current, the rectified AC input voltage V_{IN}, and/or time interval information (via clock 440), digital logic circuit 460 provides control for the plurality of switch driver circuits 405 (illustrated as switch driver circuits 405₁, 405₂, 405₃, through 405ₙ, corresponding to each switch 110, 210, or any of the various other switches under the control of a controller 120), to control the switching of the various LED segments 175 in or out of the series LED 140 current path (or in or out of the various parallel paths) as discussed above, such as to substantially track V_{IN} or to provide a desired lighting effect (e.g., dimming or color temperature control), and as discussed below with reference to FIG. 23.

For example, as mentioned above for a first methodology, the controller 120 (using comparator 425, sync signal generator 430, and digital logic circuit 460) may determine the commencement of quadrant Q1 and provide a corresponding sync signal (or sync pulse), when the rectified AC input voltage V_{IN} is about or substantially close to zero (what might otherwise be a zero crossing from negative to positive or vice-versa for a non-rectified AC input voltage) (illustrated as 144 in FIGS. 2 and 3, which may be referred to herein equivalently as a substantially zero voltage or a zero crossing), and may store a corresponding clock cycle count or time value in memory 465 (or memory 185). During quadrant Q1, the controller 120 (using digital logic circuit 460) may store in memory 465 (or memory 185) a digital value for the rectified AC input voltage V_{IN} occurring when the LED 140 current has reached a predetermined peak value I_{P} for one or more LED segments 175 in the series LED 140 current path, and provide corresponding signals to the plurality of switch driver circuits 405 to control the switching in of a next LED segment 175, and repeating these measurements and information storage for the successive switching in of each LED segment 175. Accordingly, a voltage level is stored that corresponds to the highest voltage level for the current (or first) set of LED segments 175 prior to switching in the next LED segment 175 which is also substantially equal to the lowest voltage level for the set of LED segments 175 that includes the switched in next LED segment 175 (to form a second set of LED segments 175). During quadrant Q2, as the rectified AC input voltage V_{IN} is decreasing, the LED 140 current is decreasing from the predetermined peak value I_{P} for a given set of LED segments 175, followed by the LED 140 current rising back up to the predetermined peak value I_{P} as each LED segment 175 is successively switched out of the series LED 140 current path. Accordingly, during quadrant Q2, the controller 120 (using digital logic circuit 460) may retrieve from memory 465 (or memory 185) a digital value for the rectified AC input voltage V_{IN} which occurred when the LED 140 current previously reached a predetermined peak value I_{P} for the first set of LED segments 175, which corresponds to the lowest voltage level for the second set of LED segments 175, and provide corresponding signals to the plurality of switch driver circuits 405 to control the switching out of an LED segment 175 from the second set of LED segments 175, such that the first set of LED segments 175 is now connected and the LED 140 current returns to the predetermined peak value I_{P} at that voltage level, and repeating these measurements and information retrieval for the successive switching out of each LED segment 175.

Also for example, as mentioned above for a second, time-based methodology, the controller 120 (using comparator 425, sync signal generator 430, and digital logic circuit 460) also may determine the commencement of quadrant Q1 and provide a corresponding sync signal, when the rectified AC input voltage V_{IN} is about or substantially close to zero, and may store a corresponding clock cycle count or time value in memory 465 (or memory 185). During quadrant Q1, the controller 120 (using digital logic circuit 460) may store in memory 465 (or memory 185) a digital value for the time (e.g., clock cycle count) at which or when the LED 140 current has reached a predetermined peak value I_{P} for one or more LED segments 175 in the series LED 140 current path, and provide corresponding signals to the plurality of switch driver circuits 405 to control the switching in of a next LED segment 175, and repeating these measurements, time counts, and information storage for the successive switching in of each LED segment 175. The controller 120 (using digital logic circuit 460) may further calculate and store corresponding interval information, such as the duration of time following switching (number of clock cycles or time interval) it has taken for a given set of LED segments 175 to reach I_{P}, such as by subtracting a clock count at the switching from the clock count when I_{P} has been reached. Accordingly, time and interval information is stored that corresponds to the switching time for a given (first) set of LED segments 175 and the time at which the given (first) set of LED segments 175 has reached I_{P}, the latter of which corresponds to the switching time for the next (second) set of LED segments. During quadrant Q2, as the rectified AC input voltage V_{IN} is decreasing, the LED 140 current is decreasing from the predetermined peak value I_{P} for a given set of LED segments 175, followed by the LED 140 current rising back up to the predetermined peak value I_{P} as each LED segment 175 is successively switched out of the series LED 140 current path. Accordingly, during quadrant Q2, the controller 120 (using digital logic circuit 460) may retrieve from memory 465 (or memory 185) corresponding interval information, calculate a time or clock cycle count at which a next LED segment 175 should be switched out of the series LED 140 current path, and provide corresponding signals to the plurality of switch driver circuits 405 to control the switching out of an LED segment 175 from the second set of LED segments 175, such that the first set of LED segments 175 is now connected and the LED 140 current returns to the predetermined peak value I_{P}, and repeating these measurements, calculations, and information retrieval for the successive switching out of each LED segment 175.

For both the exemplary voltage-based and time-based methodologies, the controller 120 (using digital logic circuit 460) may also implement power factor correction. As mentioned above, with reference to FIGS. 2 and 3, when the rectified AC input voltage V_{IN} reaches a peak value (149) at the end of Q1, it may be desirable for the LED 140 current to also reach a predetermined peak value I_{P} substantially concurrently, for power efficiency. Accordingly, the controller 120 (using digital logic circuit 460) may determine, before switching in a next segment, such as LED segment 175ₙ, which may cause a decrease in current, whether sufficient time remains in Q1 for a next set of LED segments 175 to reach I_{P} if that segment (e.g., LED segment 175ₙ) were switched in when the current set of LED segments 175 reach I_{P}. If sufficient time remains in Q1 as calculated by the controller 120 (using digital logic circuit 460), the controller 120 will generate the corresponding signals to the plurality of switch driver circuits 405 such that the next LED segment 175 is switched into the series LED 140 current path, and if not, no additional LED segment 175 is switched in. In the latter case, the LED 140 current may exceed the peak value I_{P} (not separately illustrated in FIG. 2), provided the actual peak LED 140 current is maintained below a corresponding threshold or other specification level, such as to avoid potential harm to the LEDs 140 or other circuit components, which also may be limited by the various current limiting circuits, to avoid such excess current levels, as discussed above.

The controller 120 may also be implemented to be adaptive, with the time, interval, voltage and other parameters utilized in Q2 generally based on the most recent set of measurements and determinations made in the previous Q1. Accordingly, as an LED segment 175 is switched out of the series LED 140 current path, in the event the LED 140 current increases too much, such as exceeding the predetermined peak value I_{P} or exceeding it by a predetermined margin, that LED segment 175 is switched back into the series LED 140 current path, to return the LED 140 current back to a level below I_{P} or below I_{P} plus the predetermined margin. Substantially concurrently, the controller 120 (using digital logic circuit 460) will adjust the time, interval, voltage or other parameter information, such as to increase (increment) the time interval or decrease (decrement) the voltage level at which that LED segment 175 will be switched out of the series LED 140 current path for use in the next Q2.

In an exemplary embodiment, then, the controller 120 may sense the rectified AC voltage V_{IN} and create synchronization pulses corresponding to the rectified AC voltage V_{IN} being substantially zero (or a zero crossing). The controller 120 (using digital logic circuit 460) may measure or calculate the time between two synchronization pulses (the rectified period, approximately or generally related to the inverse of twice the utility line frequency), and then divide the rectified period by two, to determine the duration of each quadrant Q1 and Q2, and the approximate point at which Q1 will end. For an embodiment which does not necessarily switch LED segments 175 when I_{P} is reached, in another embodiment the quadrants may be divided into approximately or substantially equal intervals corresponding to the number “n” of LED segments 175, such that each switching interval is substantially the same. During Q1, the controller 120 will then generate the corresponding signals to the plurality of switch driver circuits 405 such that successive LED segments 175 are switched into the series LED 140 current path for the corresponding interval, and for Q2, the controller 120 will then generate the corresponding signals to the plurality of switch driver circuits 405 such that successive LED segments 175 are switched out of the series LED 140 current path for the corresponding interval, in the reverse (or mirror) order, as discussed above, with a new Q1 commencing at the next synchronization pulse.

In addition to creating or assigning substantially equal intervals corresponding to the number “n” of LED segments 175, there are a wide variety of other ways to assign such intervals, any and all of which are within the scope of the invention as claimed, for example and without limitation, unequal interval periods for various LED segments 175 to achieve any desired lighting effect; dynamic assignment using current or voltage feedback, as described above; providing for substantially equal current for each LED segment 175, such that each segment is generally utilized about equally; providing for unequal current for each LED segment 175 to achieve any desired lighting effect or to optimize or improve AC line performance or efficiency.

Other dimming methodologies are also within the scope of the invention as claimed. As may be apparent from FIG. 3, using the rectified AC voltage V_{IN} being substantially zero (or a zero crossing) to determine the durations of the quadrants Q1 and Q2 will be different in a phase modulated dimming situation, which chops or eliminates a first portion of the rectified AC voltage V_{IN}. Accordingly, the time between successive synchronization pulses (zero crossings) may be compared with values stored in memory 465 (or memory 185), such as 10 ms for a 50 Hz AC line or 8.36 ms for a 60 Hz AC line. When the time between successive synchronization pulses (zero crossings) is about or substantially the same as the relevant or selected values stored in memory 465 (or memory 185) (within a predetermined variance), a typical, non-dimming application is indicated, and operations may proceed as previously discussed. When the time between successive synchronization pulses (zero crossings) is less than the relevant or selected values stored in memory 465 (or memory 185) (plus or minus a predetermined variance or threshold), a dimming application is indicated. Based on this comparison or difference between the time between successive synchronization pulses (zero crossings) and the relevant or selected values stored in memory 465 (or memory 185), a corresponding switching sequence of the LED segments 175 may be determined or retrieved from memory 465 (or memory 185). For example, the comparison may indicate a 45 phase modulation, which then may indicate how many intervals should be skipped, as illustrated in and as discussed above with reference to FIG. 3. As another alternative, a complete set of LED segments 175 may be switched into the series LED 140 current path, with any dimming provided directly by the selected phase modulation.

It should also be noted that various types of LEDs 140, such as high brightness LEDs, may be described rather insightfully for such dimming applications. More particularly, an LED may be selected to have a characteristic that its voltage changes more than 2:1 (if possible) as its LED current varies from zero to its allowable maximum current, allowing dimming of a lighting device by phase modulation of the AC line. Assuming that “N” LEDs are conducting, the rectified AC voltage V_{IN} is rising, and that the next LED segment 175 is switched into the series LED 140 current path when the current reaches I_{P}, then the voltage immediately before the switching is (Equation 2):

V_{LED}=V_{IN}=N(V_{FD}+I_{P}*Rd)

where we use the fact that the LED is modeled as a voltage (V_{FD}) plus resistor model. After the switching of ΔN more LEDs to turn on, the voltage becomes (Equation 3):

V_{IN}=(N+ΔN)(V_{FD}+I_{after}R_{d})

Setting the two line voltages V_{IN} (of Equations 2 and 3) equal leads to (Equation 4):

$${I}_{after} = \frac{( {NI}_{P} {R}_{d} - Δ {NV}_{FD} )}{N + Δ N} ( \frac{1}{{R}_{d}} )$$

Therefore, in order for the current after the LEDs 140 of the next LED segment 175 are turned on to be positive, then NIₚR_{d}>ΔNV_{FD} and further, if we desire for the current to remain above the latching current (I_{LATCH}) of a residential dimmer, then (Equation 5):

$$\frac{( {NI}_{p} {R}_{d} - Δ {NV}_{FD} )}{N + Δ N} ( \frac{1}{{R}_{d}} ) > {I}_{LATCH} \approx 50 mA .$$

From Equation 5 we can derive a value of Ip, referred to as “Imax” which provides a desired I_{LATCH} current when the next LED segment 175 is switched (Equation 6):

$${I}_{max} = \frac{{I}_{LATCH} {R}_{d} ( N + Δ N ) + Δ {NV}_{FD}}{{NR}_{d}}$$

From Equation (1) we will then find the value of the Ip=Imax current at the segments switching (Equation 7):

$${I}_{max} = \frac{\frac{{V}_{IN}}{N} - {V}_{FD}}{{R}_{d}}$$

From setting Equations 6 and 7 equal to each other, we can then determine the value of a threshold input voltage “V_{INT}” producing an I_{LATCH} current in the LED segments 175 (Equation 8):

V_{INT}=N(F_{FD}+IₘₐₓR_{d})

The Equations 2 through 8 present a theoretical background for a process of controlling a driver interface with wall dimmer without additional bleeding resistors, which may be implemented within the various exemplary apparatuses (100, 200, 300, 400, 500, 600) under the control of a controller 120 (and its variations 120A-120E). To implement this control methodology, various one or more parameters or characteristics of the apparatuses (100, 200, 300, 400, 500, 600) are stored in the memory 185, such as by the device manufacturer, distributor, or end-user, including without limitation, as examples, the number of LEDs 140 comprising the various LED segments 175 in the segment, the forward voltage drop (either for each LED 140 or the total drop per selected

LED segment 175), the dynamic resistance Rd, and one or more operational parameters or characteristics of the apparatuses (100, 200, 300, 400, 500, 600), including without limitation, also as examples, operational parameters such as a dimmer (285) latch current I_{LATCH}, a peak current of the segment Ip, and a maximum current of the LED segment 175 which provides (following switching of a next LED segment 175) a minimum current equal to I_{LATCH}. In addition, values of an input voltage V_{INT} for each LED segment 175 and combinations of LED segments 175 (as there are switched into the LED 140 current path) may be calculated using Equation 8 and stored in memory 185, or may be determined dynamically during operation by the controller 120 and also stored in memory (as part of the first exemplary method discussed below). These various parameters and/or characteristics such as the peak and maximum currents may be the same for every LED segment 175 or specific for each LED segment 175.

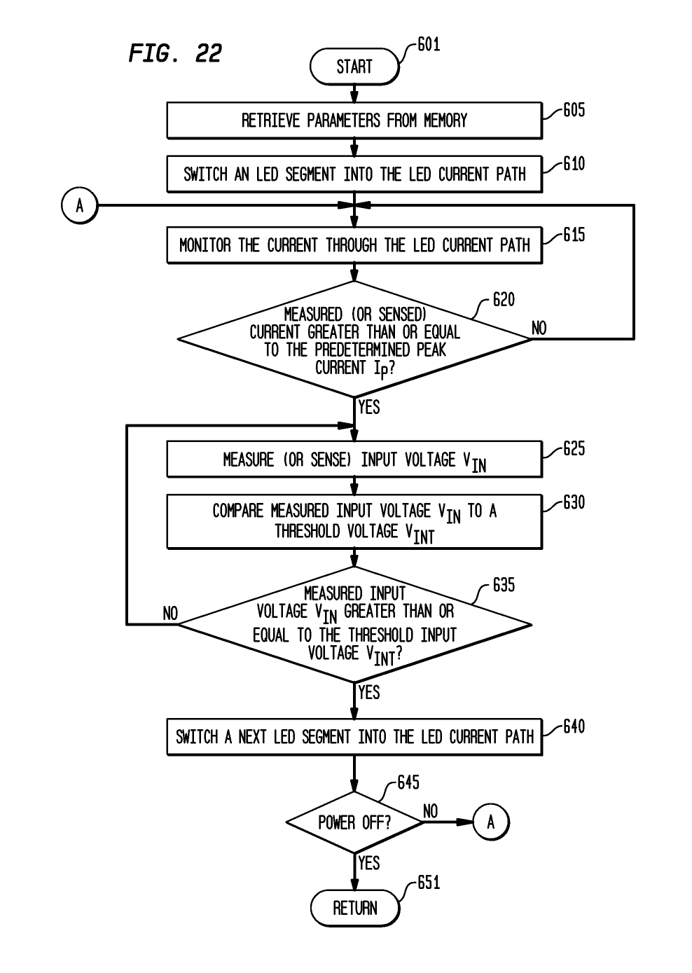

FIG. 22 is a flow diagram illustrating a first exemplary method in accordance with the teachings of the present invention, which implements this control methodology for maintaining a minimum current sufficient for proper operation of a dimmer switch 285 (to which one or more apparatuses (100, 200, 300, 400, 500, 600) may be coupled). The method begins, start step 601, with one or more of these various parameters being retrieved or otherwise obtained from memory 185, step 605, typically by a controller 120, such as a value for an input voltage V_{INT} for the current, active LED segment 175. The controller 120 then switches the LED segment 175 into the LED 140 current path (except in the case of a first LED segment 175₁, which depending on the circuit configuration, may always be in the LED 140 current path), step 610, and monitors the current through the LED 140 current path, step 615. When the current through the LED 140 current path reaches the peak current I_{P} (determined using a current sensor 115), step 620, the input voltage V_{IN} is measured or sensed (also determined using a voltage sensor 195), step 625, and the measured input voltage V_{IN} is compared to the threshold input voltage V_{INT} (one of the parameters previously stored in and retrieved from memory 185), step 630. Based on this comparison, when the measured input voltage V_{IN} is greater than or equal to the threshold input voltage V_{INT}, step 635, the controller 120 switches a next LED segment 175 into the LED 140 current path, step 640. When the measured input voltage V_{IN} is not greater than or equal to the threshold input voltage V_{INT} in step 635, the controller 120 does not switch a next LED segment 175 into the LED 140 current path (i.e., continues to operate the apparatus using the LED segments 175 which are currently in the LED 140 current path), and continues to monitor the input voltage V_{IN}, returning to step 625, to switch a next LED segment 175 (step 640) into the LED 140 current path when measured input voltage V_{IN} becomes equal to or greater than the threshold input voltage V_{INT} (step 635). Following step 640, and when the power has not been turned off, step 645, the method iterates for another LED segment 175, returning to step 615, and otherwise the method may end, return step 651.

FIG. 23 is a flow diagram illustrating a second exemplary method in accordance with the teachings of the present invention, and provides a useful summary for the methodology which tracks the rectified AC voltage V_{IN} or implements a desired lighting effect, such as dimming The determination, calculation and control steps of the methodology may be implemented, for example, as a state machine in the controller 120. Many of the steps also may occur concurrently and/or in any number of different orders, with a wide variety of different ways to commence the switching methodology, in addition to the sequence illustrated in FIG. 23, any and all of which are considered equivalent and within the scope of the claimed invention.

More particularly, for ease of explanation, the methodology illustrated in FIG. 23 begins with one or more zero crossings, i.e., one or more successive determinations that the rectified AC voltage V_{IN} is substantially equal to zero. During this determination period, all, none, or one or more of the LED segments 175 may be switched in. Those having skill in the electronic arts will recognize that there are innumerable other ways to commence, several of which are also discussed below.

The method begins with start step 501, such as by powering on, and determines whether the rectified AC voltage V_{IN} is substantially equal to zero (e.g., a zero crossing), step 505. If so, the method starts a time measurement (e.g., counting clock cycles) and/or provides a synchronization signal or pulse, step 510. When the rectified AC voltage V_{IN} was not substantially equal to zero in step 505, the method waits for the next zero crossing. In an exemplary embodiment, steps 505 and 510 are repeated for a second (or more) zero crossing, when the rectified AC voltage V_{IN} is substantially equal to zero, for ease of measurement determinations, step 515. The method then determines the rectified AC interval (period), step 520, and determines the duration of the first half of the rectified AC interval (period), i.e., the first quadrant Q1, and any switching intervals, such as when Q1 is divided into a number of equal time intervals corresponding to the number of LED segments 175, as discussed above, step 525. The method may also then determine whether brightness dimming is occurring, such as when indicated by the zero crossing information as discussed above, step 530. If dimming is to occur, the method may determines the starting set of LED segments 175, step 535, such as the number of sets of segments which may be skipped as discussed with reference to FIG. 3, and an interval (corresponding to the phase modulation) following the zero crossing for switching in the selected number of LED segments 175, step 540. Following step 540, or when dimming is not occurring, or if dimming is occurring but will track the rectified AC voltage V_{IN}, the method proceeds to steps 545 and 551, which are generally performed substantially concurrently.

In step 545, the method determines a time (e.g., a clock cycle count), or a voltage or other measured parameter, and stores the corresponding values, e.g., in memory 465 (or memory 185). As mentioned above, these values may be utilized in Q2. In step 551, the method switches into the series LED 140 current path the number of LED segments 175 corresponding to the desired sequence or time interval, voltage level, other measured parameter, or desired lighting effect. The method then determines whether the time or time interval indicates that Q1 is ending (i.e., the time is sufficiently close or equal to the halftime of the rectified AC interval (period), such as being within a predetermined amount of time from the end of Q1), step 555, and whether there are remaining LED segments 175 which may be switched into the series LED 140 current path, step 560. When Q1 is not yet ending and when there are remaining LED segments 175, the method determines whether the LED 140 current has reached a predetermined peak value I_{P} (or, using time-based control, whether the current interval has elapsed), step 565. When the LED 140 current has not reached the predetermined peak value I_{P} (or when the current interval has not elapsed) in step 565, the method returns to step 555. When the LED 140 current has reached the predetermined peak value I_{P} (or when the current interval has elapsed) in step 565, the method determines whether there is sufficient time remaining in Q1 to reach IP if a next LED segments 175 is switched into the series LED 140 current path, step 570. When there is sufficient time remaining in Q1 to reach I_{P}, step 570, the method returns to steps 545 and 551 and iterates, determining a time (e.g., a clock cycle count), or a voltage or other measured parameter, and storing the corresponding values (step 545), and switching in the next LED segment 175 (step 551).

When the time or time interval indicates that Q1 is ending (i.e., the time is sufficiently close or equal to the halftime of the rectified AC interval (period), step 555, or when there are no more remaining LED segments 175 to switch in, step 560, or when there is not sufficient time remaining in Q1 to switch in a next LED segment 175 and have the LED 140 current reach I_{P}, step 570, the method commences Q2, the second half of the rectified AC interval (period). Following steps 555, 560 or 570, the method determines the voltage level, time interval, other measured parameter, step 575. The method then determines whether the currently determined voltage level, time interval, other measured parameter has reached a corresponding stored value for a corresponding set of LED segments 175, step 580, such as whether the rectified AC voltage V_{IN} has decreased to the voltage level stored in memory which corresponded to switching in a last LED segment 175ₙ, for example, and if so, the method switches the corresponding LED segment 175 out of the series LED 140 current path, step 585.

The method then determines whether the LED 140 current has increased to a predetermined threshold greater than I_{P} (i.e., I_{P} plus a predetermined margin), step 590. If so, the method switches back into the series LED 140 current path the corresponding LED segment 175 which had been switched out most recently, step 595, and determines and stores new parameters for that LED segment 175 or time interval, step 602, such as a new value for the voltage level, time interval, other measured parameter, as discussed above (e.g., a decremented value for the voltage level, or an incremented time value). The method may then wait a predetermined period of time, step 606, before switching out the LED segment 175 again (returning to step 585), or instead of step 606, may return to step 580, to determine whether the currently determined voltage level, time interval, other measured parameter has reached a corresponding new stored value for the corresponding set of LED segments 175, and the method iterates. When the LED 140 current has not increased to a predetermined threshold greater than I_{P} in step 590, the method determines whether there are remaining LED segments 175 or remaining time intervals in Q2, step 611, and if so, the method returns to step 575 and iterates, continuing to switch out a next LED segment 175. When there are no remaining LED segments 175 to be switched out of the series LED 140 current path or there are no more remaining time intervals in Q2, the method determines whether there is a zero crossing, i.e., whether the rectified AC voltage V_{IN} is substantially equal to zero, step 616. When the zero crossing has occurred, and when the power has not been turned off, step 621, the method iterates, starting a next Q1, returning to step 510 (or, alternatively, step 520 or steps 545 and 551), and otherwise the method may end, return step 626.

As mentioned above, the methodology is not limited to commencing when a zero crossing has occurred. For example, the method may determine the level of the rectified AC voltage V_{IN} and/or the time duration from the substantially zero rectified AC voltage V_{IN}, time interval, other measured parameter, and switches in the number of LED segments 175 corresponding to that parameter. In addition, based upon successive voltage or time measurements, the method may determine whether it is in a Q1 (increasing voltage) or Q2 (decreasing voltage) portion of the rectified AC interval (period), and continue to respectively switch in or switch out corresponding LED segments 175. Alternatively, the method may start with substantially all LED segments 175 switched or coupled into the series LED 140 current path (e.g., via power on reset), and wait for a synchronization pulse indicating that the rectified AC voltage V_{IN} is substantially equal to zero and Q1 is commencing, and then perform the various calculations and commence switching of the number of LED segments 175 corresponding to that voltage level, time interval, other measured parameter, or desired lighting effect, proceeding with step 520 of the methodology of FIG. 23.

Not separately illustrated in FIG. 23, for dimming applications, steps 545 and 551 may involve additional features. There are dimming circumstances in which there is no Q1 time interval, such that the phase modulated dimming cuts or clips ninety degrees or more of the AC interval. Under such circumstances, the Q2 voltages or time intervals cannot be derived from corresponding information obtained in Q1. In various exemplary embodiments, the controller 120 obtains default values from memory (185, 465), such as time intervals corresponding to the number of LED segments 175, uses these default values initially in Q2, and modifies or “trains” these values during Q2 by monitoring the AC input voltage and the LED 140 current through the series LED 140 current path. For example, starting with default values stored in memory, the controller 120 increments these values until IP is reached during Q2, and then stores the corresponding new voltage value, for each switching out of an LED segment 175.

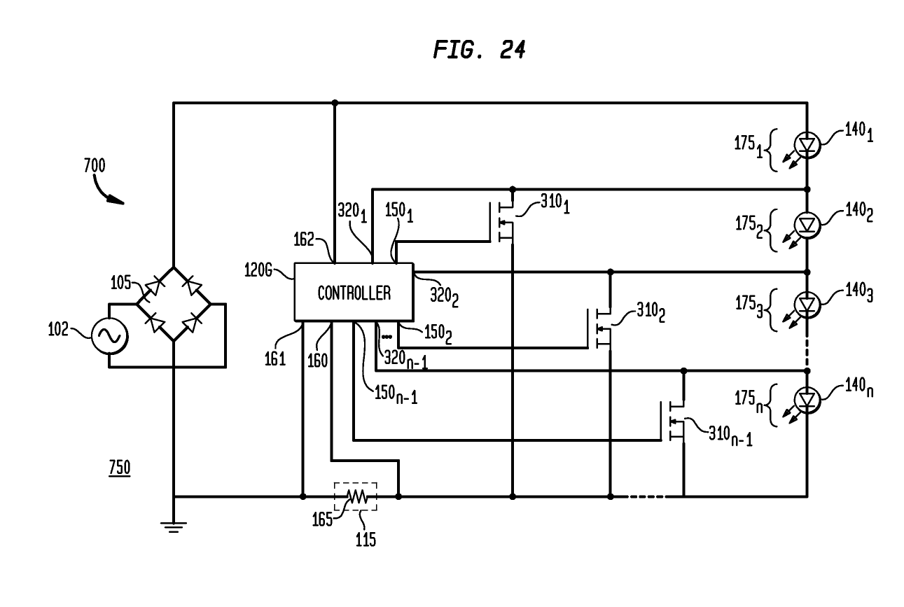

FIG. 24 is a block and circuit diagram illustrating a seventh exemplary system 750 and a seventh exemplary apparatus 700 in accordance with the teachings of the present invention. Seventh exemplary system 750 comprises the seventh exemplary apparatus 700 (also referred to equivalently as an off line AC LED driver) coupled to an AC line 102. The seventh exemplary apparatus 700 also comprises a plurality of LEDs 140, a plurality of switches 310 (illustrated as n-channel enhancement FETs, as an example), a controller 120G, a (first) current sensor 115, and a rectifier 105. Also optionally and not separately illustrated in FIG. 24, a memory 185 and/or a user interface 190 also may be included as discussed above. The seventh exemplary apparatus 700 does not require additional voltage sensors (such as a sensor 195) or power supplies (V_{CC} 125), although these components may be utilized as may be desired.

The seventh exemplary apparatus 700 (and the other apparatus 800, 900, 1000, 1100, 1200, 1300 discussed below) are utilized primarily to provide current regulation of the series LED 140 current path, and to utilize current parameters to switch each LED segment 175 in or out of the series LED 140 current path. The seventh exemplary apparatus 700 (and the other apparatus 800, 900, 1000, 1100, 1200, 1300 discussed below) differs from the first apparatus 100 primarily with respect to the location of the controller 120 and the type of feedback provided to the controller 120, and several of the apparatuses (1100, 1200, and 1300) utilize a different switching circuit arrangement. More particularly, the controller 120G has a different circuit location, receiving input of the input voltage V_{IN} (input 162), receiving input (feedback) of each of the node voltages between LED segments 175 (inputs 320), in addition to receiving input from current sensor 115 (inputs 160, 161). In this exemplary embodiment, the controller 120G may be powered by or through any of these node voltages, for example. Using such voltage and current information, the controller 120G produces the gate (or base) voltage for the FET switches 310, which can be controlled in either linear or switch mode (or both) to produce any current waveform to maximize the power factor, light production brightness, efficiency, and interfacing to triac-based dimmer switches. For example, controller 120G may produce a gate voltage for the FET switches 310 to maintain substantially constant current levels for the various combinations of LED segments 175 during both Q1 and Q2. Continuing with the example, the controller 120G may produce a gate voltage for FET switch 310₁ to provide a current of 50 mA in a series LED 140 current path consisting of LED segment 175₁, followed by producing a gate voltage for FET switch 310₂ to provide a current of 75 mA in a series LED 140 current path consisting of LED segment 175₁ and LED segment 175₂, followed by producing zero or no gate voltages for FET switches 310 to provide a current of 100 mA in a series LED 140 current path consisting of all of the LED segments 174. Parameters or comparison levels for such desired current levels may be stored in a memory 185 for example (not separately illustrated), or provided through analog circuitry, also for example. In this circuit topology, the controller 120G thereby controls the current level in the series LED 140 current path, and provides corresponding linear or switching control of the FET switches 310 to maintain any desired level of current during Q1 and Q2, such as directly tracking the input voltage/current levels, or step-wise tracking of the input voltage/current levels, or maintaining constant current levels, for example and without limitation. In addition, the various node voltages may also be utilized to provide such linear and/or switching control of the FET switches 310, in addition to feedback from current sensor 115. While illustrated using n-channel FETs, it should be noted that any other type or kind of switch, transistor (e.g., PFET, BJT (npn or pnp), or combinations of switches or transistors (e.g., Darlington devices) may be utilized equivalently (including with respect to the other apparatus 800, 900, 1000, 1100, 1200, 1300).

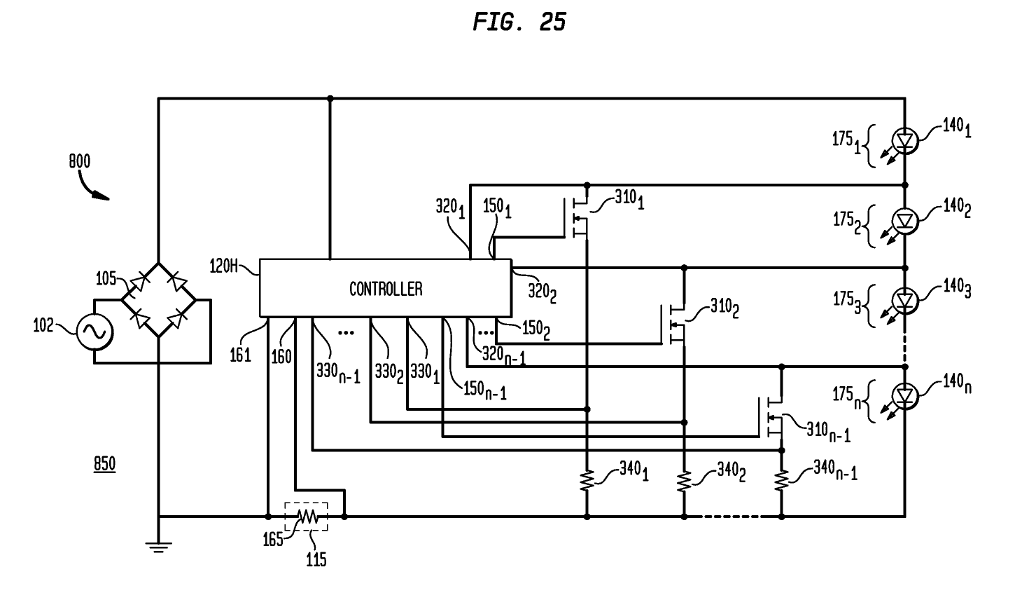

FIG. 25 is a block and circuit diagram illustrating an eighth exemplary system 850 and an eighth exemplary apparatus 800 in accordance with the teachings of the present invention. The eighth exemplary apparatus 800 differs from the seventh exemplary apparatus 700 insofar as resistors 340 are connected in series with the FET switches 310, and corresponding voltage or current levels are provided as feedback to the controller 120H (inputs 330), thereby providing additional information to the controller 120H, such as the current level through each LED segment 175 and switch 310 as an LED segment 175 may be switched in or out of the series LED 140 current path. By measuring the current levels in each branch (LED segment 175), comparatively smaller resistances 340 may be utilized advantageously (such as in comparison to resistor 165), which may serve to decrease power dissipation. Depending on the selected embodiment, such a resistor 165 (as a current sensor 115) may therefore be omitted (not separately illustrated).

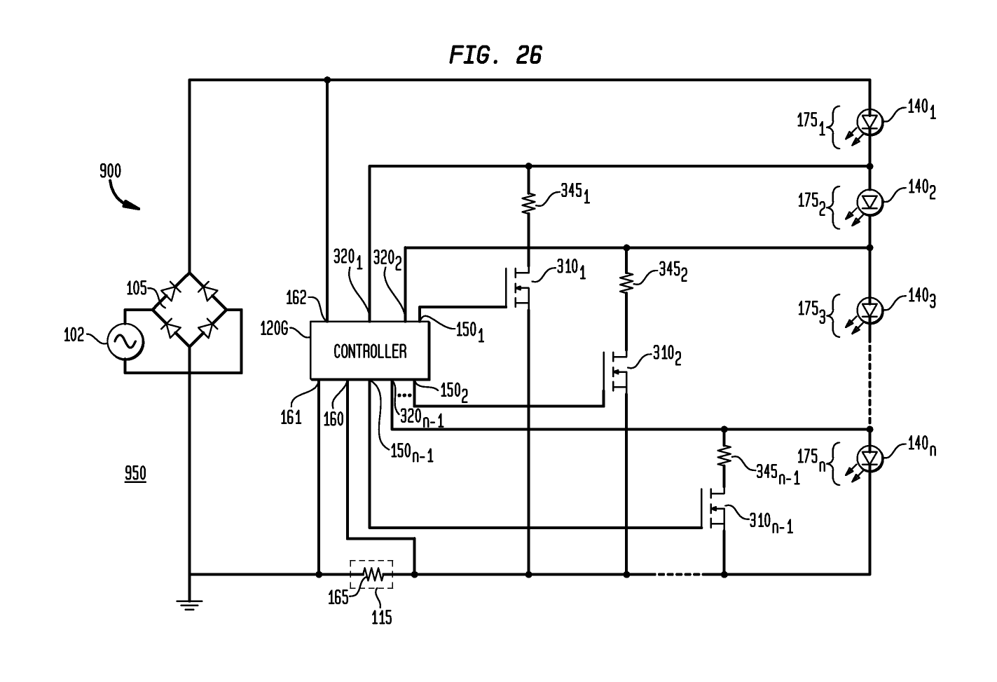

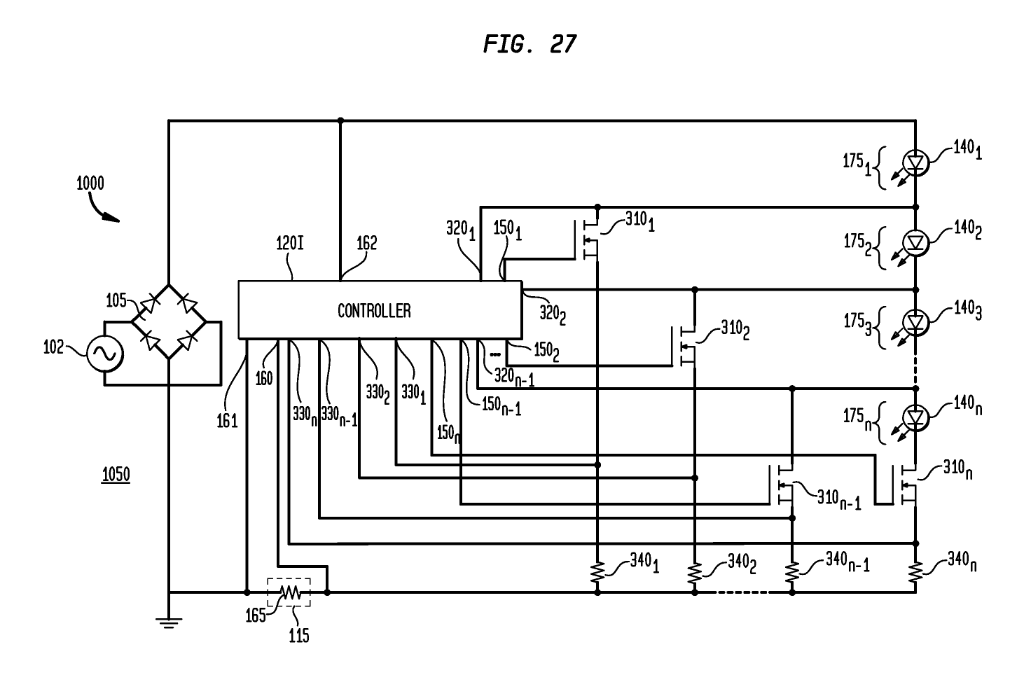

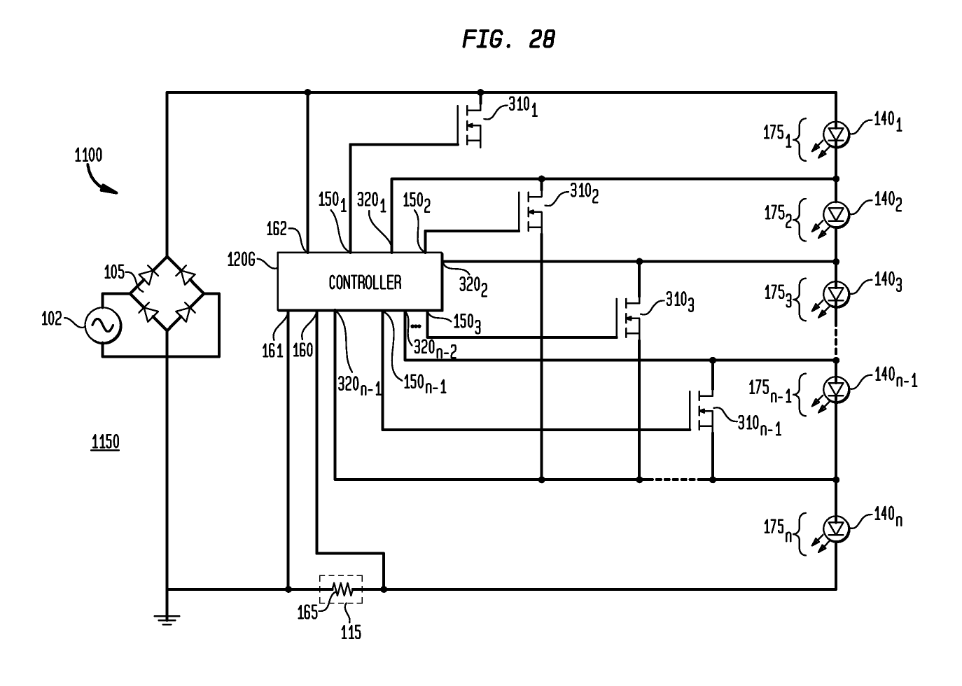

FIG. 26 is a block and circuit diagram illustrating a ninth exemplary system 950 and a ninth exemplary apparatus 900 in accordance with the teachings of the present invention. The ninth exemplary apparatus 900 differs from the eighth exemplary apparatus 800 insofar as resistors 345 are connected on the “high side” in series with the FET switches 310, rather than on the low voltage side. In this exemplary embodiment, series resistors 345 (which have a resistance comparatively larger than low side resistors 340) are utilized to increase the impedance in their branch when the corresponding FET switch 310 is turned on, which may be utilized to improve electromagnetic interference (“EMI”) performance and eliminate the potential need for an additional EMI filter (not separately illustrated).

FIG. 27 is a block and circuit diagram illustrating a tenth exemplary system 1050 and a tenth exemplary apparatus 1000 in accordance with the teachings of the present invention. The tenth exemplary apparatus 1000 differs from the eighth exemplary apparatus 800 insofar as additional current control is provided in the series LED 140 current path when all LED segments 175 are utilized (none are bypassed), utilizing switch 310ₙ (also illustrated as an n-channel FET) and series resistor 340ₙ, both coupled in series with the LED segments 175 in the series LED 140 current path. The switch 310ₙ and series resistor 340ₙ may be utilized to provide current limiting, with the controller 120I providing a corresponding gate voltage (generally in linear mode, although a switch mode may also be utilized) to the switch 310ₙ to maintain the desired current level in the series LED 140 current path, in addition to the current limiting provided by series resistor 340ₙ. This is particularly useful in the event the input voltage V_{IN} becomes too high; with the input of V_{IN} (input 162) and the feedback of the node voltage (from series resistor 340ₙ at input 330ₙ), by adjusting the gate voltage of the switch 310ₙ, the controller 120I is able to prevent excess current flowing through the LED segments 175 in the series LED 140 current path. In addition, with this circuit topology, other resistors (such as 165 or other resistors 340) may then be redundant or reduced in value, yet the controller 1201 still has sufficient information to provide desired performance, and depending on the selected embodiment, such a resistor 165 (as a current sensor 115) may therefore be omitted (not separately illustrated). It should also be noted that the switch 310ₙ and series resistor 340ₙ may also be located elsewhere in the tenth exemplary apparatus 1000, such as in between other LED segments 175, or at the top or beginning of the series LED 140 current path, or on the positive or negative voltage rails, and not just at the bottom or termination of the series LED 140 current path.

FIG. 28 is a block and circuit diagram illustrating an eleventh exemplary system 1150 and an eleventh exemplary apparatus 1100 in accordance with the teachings of the present invention. The eleventh exemplary apparatus 1100 differs from the seventh exemplary apparatus 700 insofar as FET switches 310 are connected (at the corresponding anodes of the first LED 140 of an LED segment 175) such that the series LED 140 current path always includes the last LED segment 175ₙ. Instead of being the last LED segment 175 to be turned on, the last LED segment 175ₙ is the first LED segment 175 to be turned on and conducting in the series LED 140 current path. The circuit topology of the eleventh exemplary apparatus 1100 has additional advantages, namely, power for the controller 120G may be provided from the node voltage obtained at the last LED segment 175ₙ, and various voltage and current levels may also be monitored at this node, potentially and optionally eliminating the feedback of voltage levels from other nodes in the series LED 140 current path, further simplifying the controller 120G design.

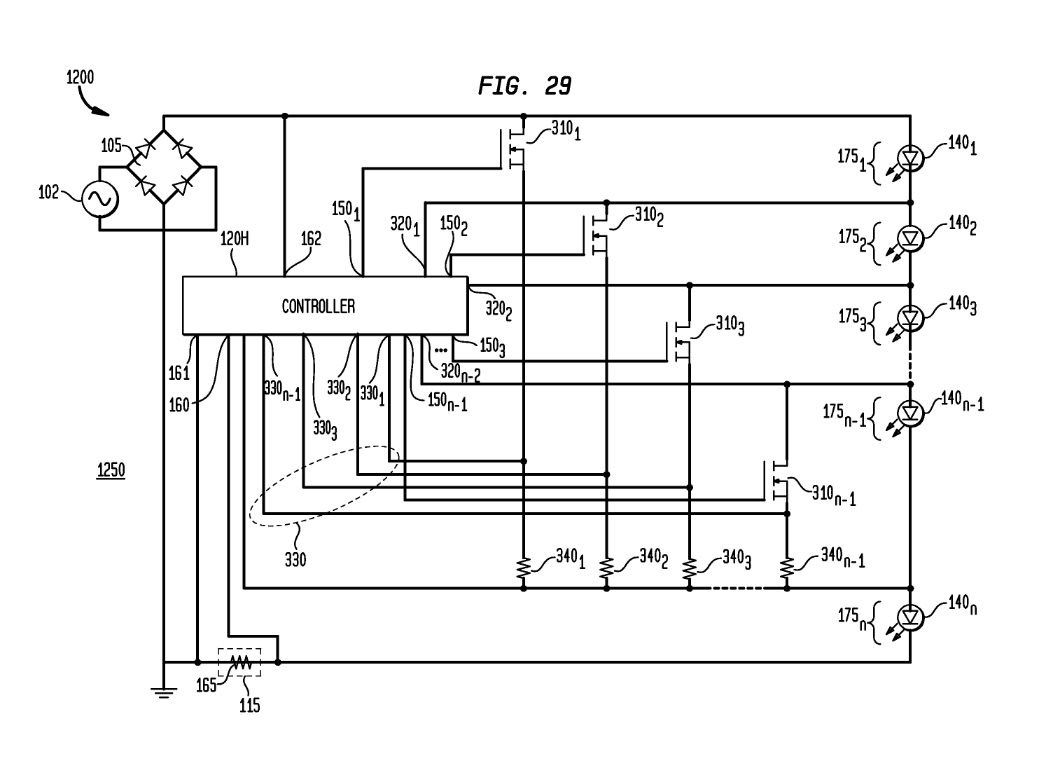

FIG. 29 is a block and circuit diagram illustrating a twelfth exemplary system 1250 and a twelfth exemplary apparatus 1200 in accordance with the teachings of the present invention. As discussed previously with respect to the eighth exemplary apparatus 800, the twelfth exemplary apparatus 1200 differs from the eleventh exemplary apparatus 1100 insofar as resistors 340 are connected in series with the FET switches 310, and corresponding voltage or current levels are provided as feedback to the controller 120H (inputs 330), thereby providing additional information to the controller 120H, such as the current level through each LED segment 175 and switch 310 as an

LED segment 175 may be switched in or out of the series LED 140 current path. By measuring the current levels in each branch (LED segment 175), comparatively smaller resistances 340 may be utilized advantageously (such as in comparison to resistor 165), which may serve to decrease power dissipation. In addition, with this circuit topology, other resistors (such as 165) may then be redundant or reduced in value, yet the controller 1201 still has sufficient information to provide desired performance, and depending on the selected embodiment, such a resistor 165 (as a current sensor 115) or other resistors 340 may therefore be omitted (not separately illustrated). Also not separately illustrated, but as discussed previously, resistors 345 may be utilized (instead of resistors 340) on the high side of the switches 310.

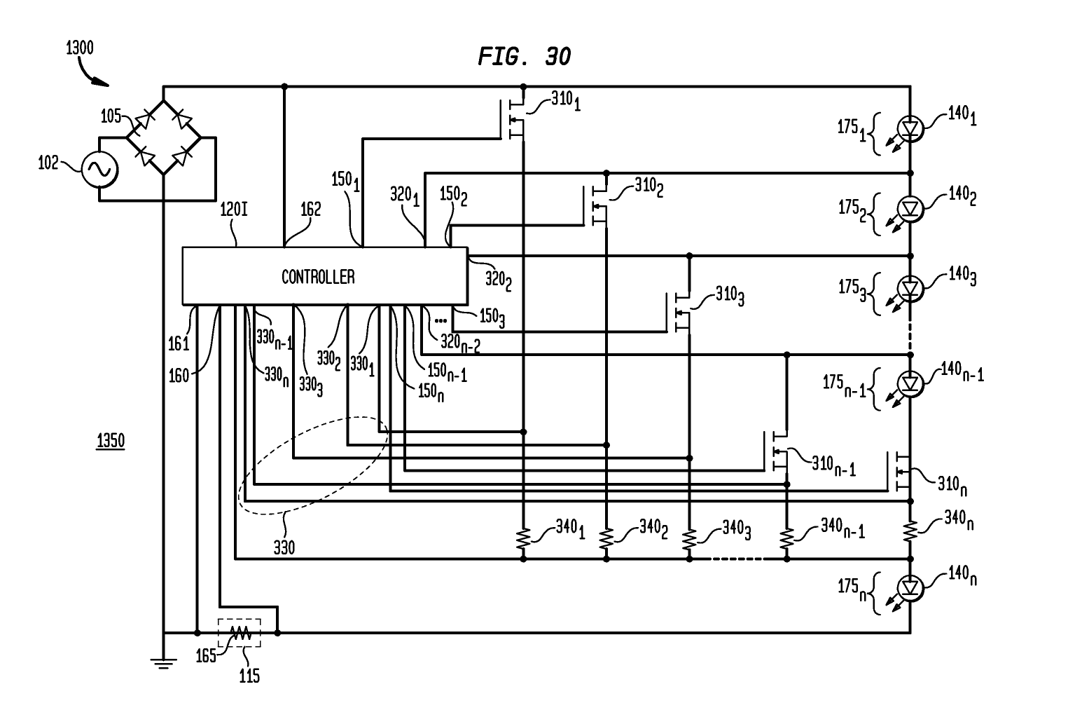

FIG. 30 is a block and circuit diagram illustrating a thirteenth exemplary system 1350 and a thirteenth exemplary apparatus 1300 in accordance with the teachings of the present invention. As discussed previously with respect to the tenth exemplary apparatus 1000, the thirteenth exemplary apparatus 1300 differs from the twelfth exemplary apparatus 1200 insofar as additional current control is provided in the series LED 140 current path when all LED segments 175 are utilized (none are bypassed), utilizing switch 310ₙ (also illustrated as an n-channel FET) and series resistor 340ₙ, both coupled in series with the LED segments 175 in the series LED 140 current path. The switch 310ₙ and series resistor 340ₙ may be utilized to provide current limiting, with the controller 120I providing a corresponding gate voltage (generally in linear mode, although a switch mode may also be utilized) to the switch 310ₙ to maintain the desired current level in the series LED 140 current path, in addition to the current limiting provided by series resistor 340ₙ. This is also particularly useful in the event the input voltage V_{IN} becomes too high; with the input of V_{IN} (input 162) and the feedback of the node voltage (from series resistor 340ₙ at input 330ₙ), by adjusting the gate voltage of the switch 310ₙ, the controller 120I is able to prevent excess current flowing through the LED segments 175 in the series LED 140 current path. In addition, with this circuit topology, other resistors (such as 165 or other resistors 340) may then be redundant or reduced in value, yet the controller 120I still has sufficient information to provide desired performance, and depending on the selected embodiment, such a resistor 165 (as a current sensor 115) may therefore be omitted (not separately illustrated). It should also be noted that the switch 310ₙ and series resistor 340ₙ may also be located elsewhere in the thirteenth exemplary apparatus 1300, such as in between other LED segments 175, or at the top or beginning of the series LED 140 current path, or on the positive or negative voltage rails, and not just at the bottom or termination of the series LED 140 current path.

It should also be noted that any of the various apparatus described herein may also provide for a parallel combination of two or more series LED 140 current paths, with a first series LED 140 current path comprising one or more of LED segment 175₁, LED segment 175₂, through LED segment 175ₘ, with a second series LED 140 current path comprising one or more of LED segment 175ₘ₊₁, LED segment 175ₘ₊₂, through LED segment 175ₙ, and so on. As previously discussed with reference to FIG. 6, many different parallel combinations of LED segments 175 are available. Those having skill in the electronic arts will recognize that any of the LED segment 175 configurations may be easily extended to additional parallel LED 140 strings and additional LED segments 175, or reduced to a fewer number of LED segments 175, and that the number of LEDs 140 in any given LED segment 175 may be higher, lower, equal or unequal, and all such variations are within the scope of the claimed invention.

Multiple strings of LEDs 140 arranged in parallel may also be used to provide higher power for a system, in addition to potentially increasing the power ratings of the LEDs 140 utilized in a single series LED 140 current path. Another advantage of such parallel combinations of switchable series LED 140 current paths circuit topologies is the capability of skewing the current wave shape of the parallel LED strings by configuring different numbers of LEDs 140 for each LED segment 175 and the various sense resistor values to achieve improved harmonic reduction in the AC line current waveform. In addition, any selected series LED 140 current path also may be turned off and shut down in the event of power de-rating, such as to reduce power when a maximum operating temperature is reached.

In any of these various apparatus and system embodiments, it should be noted that light color compensation can be achieved by using various color LEDs 140, in addition to or in lieu of white LEDs 140. For example, one or more LEDs 140 within an LED segment 175 may be green, red or amber, with color mixing and color control provided by the controller 120, which may be local or which may be remote or centrally located, through connecting the selected LED segment 175 into the series LED 140 current path or bypassing the selected LED segment 175.

It should also be noted that the various apparatuses and systems described above are operable under a wide variety of conditions. For example, the various apparatuses and systems described above are also able to operate using three phase conditions, i.e., using a 360 Hz or 300 Hz rectifier output and not merely a 120 Hz or 100 Hz rectifier output from 60 Hz or 50 Hz lines respectively. Similarly, the various apparatuses and systems described above also work in other systems, such as aircraft using 400 Hz input voltage sources. In addition, comparatively long decay type phosphors, on the order of substantially about a 2-3 msec decay time constant, may also be utilized in conjunction with the LEDs 140, such that the light emission from the energized phosphors average the LED 140 light output in multiple AC cycles, thereby serving to reduce the magnitude of any perceived ripple in the light output.

In addition to the current control described above, the various apparatuses 700, 800, 900, 1000, 1100, 1200, and 1300 may also operate as described above with respect to apparatuses 100, 200, 300, 400, 500, and 600. For example, switching of LED segments 175 into or out of the series LED 140 current path may be based upon voltage levels, such as the various node voltages at controller inputs 320. Also for example, such as for power factor correction, switching of LED segments 175 into or out of the series LED 140 current path also may be based upon whether sufficient time remains in a time interval to reach a peak current level, as described above. In short, any of the various control methodologies described above for apparatuses 100, 200, 300, 400, 500, and 600 may also be utilized with any of the various apparatuses 700, 800, 900, 1000, 1100, 1200, and 1300.

It should also be noted that any of the various controllers 120 described herein may be implemented using either or both digital logic and/or using automatic, analog control circuitry. In addition, various controllers 120 may not require any type of memory 185 to store parameter values. Rather, the parameters used for comparison, to determine the switching of LED segments 175 in or out of the series LED 140 current path, may be embodied or determined by the values selected for the various components, such as the resistance values of resistors, for example and without limitation. Components such as transistors may also perform a comparison function, turning on when a corresponding voltage has been created at coupled resistors which, in turn, may perform a current sensing function.

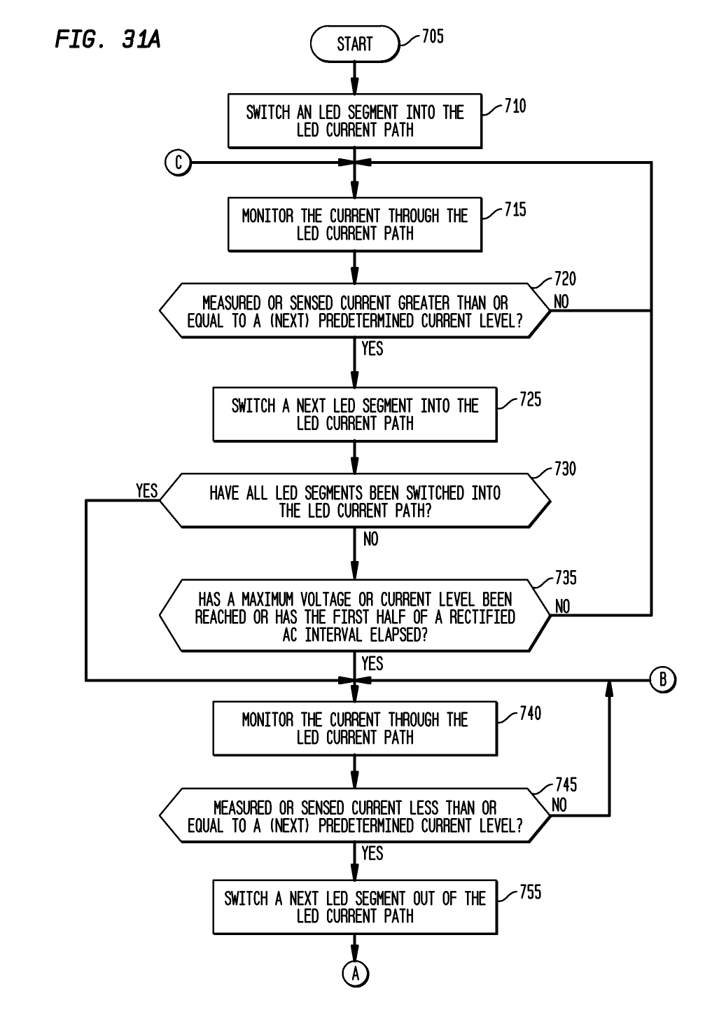

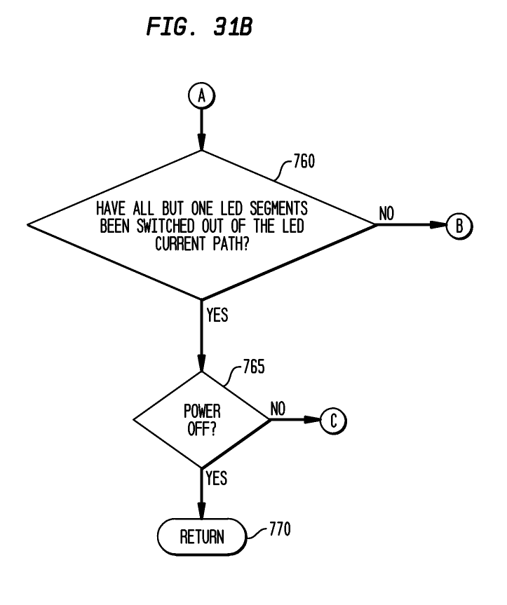

FIG. 31 is a flow diagram illustrating a third exemplary method in accordance with the teachings of the present invention, and provides a useful summary. The method begins, start step 705, with switching an LED segment 175 into the series LED 140 current path, step 710. Step 710 may also be omitted when at least one LED segment 175 is always in the series LED 140 current path. The current through the series LED 140 current path is monitored or sensed, step 715. When the measured or sensed current is not greater than or equal to a predetermined current level, step 720, the method iterates, returning to step 715. When the measured or sensed current is greater than or equal to a predetermined current level, step 720, a next LED segment 175 is switched into the series LED 140 current path, step 725. When all LED segments 175 have been switched into the series LED 140 current path, step 730, or when a maximum voltage or current level has been reached or the first half (Q1) of a rectified AC interval has elapsed (Q1 has ended), step 735, the method monitors the current level through the series LED 140 current path, step 740. When the measured or sensed current is not less than or equal to a predetermined current level, step 745, the method iterates, returning to step 740. When the measured or sensed current is less than or equal to a predetermined current level, step 745, a next LED segment 175 is switched out of the series LED 140 current path, step 755. When more than one LED segment 175 is remaining in the series LED 140 current path, the method iterates, returning to step 740. When all but one LED segments 175 have been switched out of the series LED 140 current path, step 760, and when the power is not off, step 765, the method iterates, returning to step 715, and otherwise the method may end, return step 770.

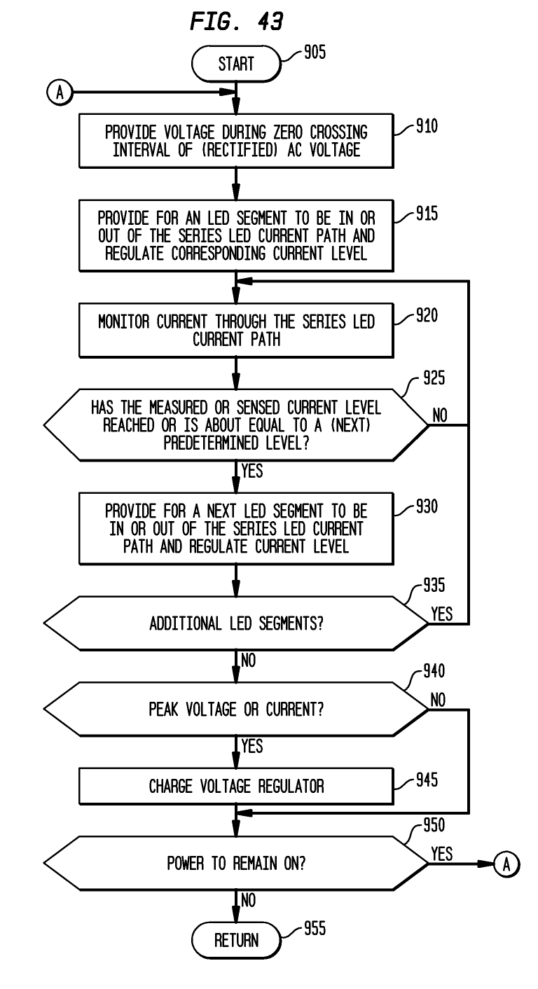

Additional levels of control may also be implemented utilizing the various embodiments illustrated in FIGS. 1-31. For example, the sequencing of the switching of the various LED segments 175 into and out of the series LED 140 current path may be varied, such as in response to the detected current level in the series LED 140 current path. Continuing with the example, the various controllers 120-120I may be configured or programmed to switch the various LED segments 175 into and out of the series LED 140 current path in different orders, such as in response to the detected current level provided via current sensor 115, may allow selected LED segments 175 to remain in the series LED 140 current path for selected or predetermined current levels, and may allow multiple series LED 140 current paths. Additional levels or kinds of voltage and current regulation may also be provided, as illustrated and discussed below with reference to FIGS. 32-46, which also may be implemented with the embodiments illustrated in FIGS. 1-31. For example, the various switches 110, 310 may be controlled and operated as current regulators 810 and/or controlled current sources 815, as discussed below and as illustrated in FIGS. 43-46, to provide regulation of the current levels through the series LED 140 current path, in addition to performing a switching function.

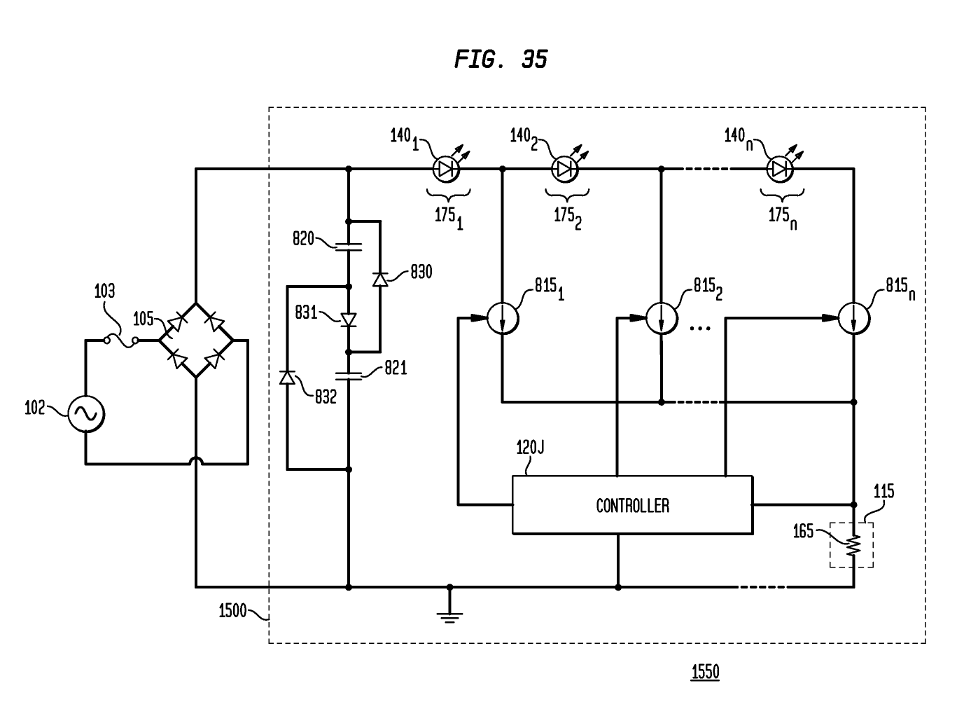

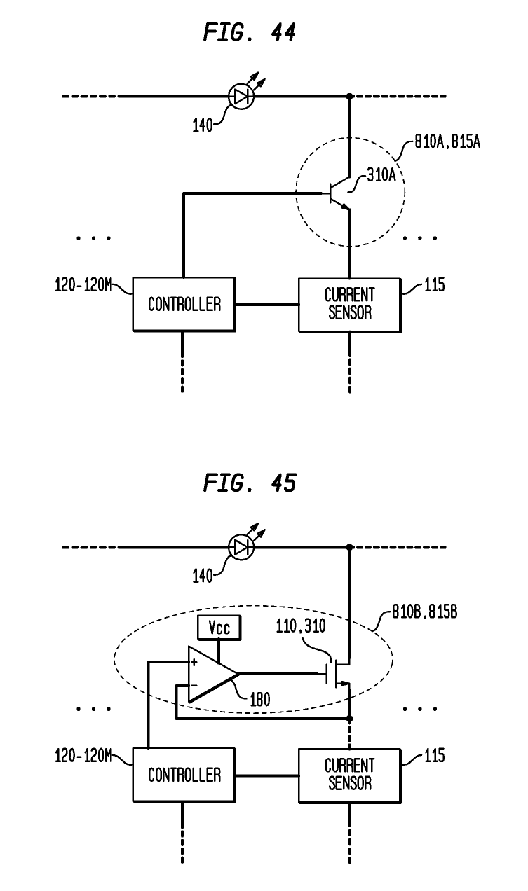

FIG. 32 is a block and circuit diagram illustrating a fourteenth exemplary system 1450 and a fourteenth exemplary apparatus 1400 in accordance with the teachings of the present invention. Instead of utilizing the various switches (e.g., 110, 310) in an on or off (e.g., non-linear) mode only, one or more current regulators 810 (illustrated as current regulators 810₁, 810₂, through 810ₙ) are utilized, to both (1) control or determine which LED segments 175 are in or out of the series LED 140 current path (or provide multiple series LED 140 current paths), and (2) control or determine the level of current through the series LED 140 current path and/or one or more LED segments 175 within the series LED 140 current path. In the exemplary embodiments illustrated in FIGS. 35 and 38-42, the one or more current regulators 810 are illustrated as controlled current sources 815, under the control of a controller 120J. In addition, such current regulators 810 and/or controlled current sources 815 also may be implemented as illustrated in FIGS. 44-46, such as using various transistors (e.g., MOSFETs, bipolar transistors, for example and without limitation) or such transistors and operational amplifiers, and also as previously discussed (such as with reference to FIG. 4). Controller 120J differs from the previously discussed controllers 120 insofar as it provides additional control or regulation of current regulators 810 (rather than control of the on and off states of switches 110, 310), which may be implemented as current sources 815 and the other embodiments discussed below, for example. FIGS. 32, 35, 38-42 also illustrate use of a fuse 103 in a system 1450 embodiment, which in addition to being placed or configured between the AC line or source 102 and the rectifier 105, may also be located between the rectifier 105 and any of the various apparatuses 1400, 1500, 1600, 1700, 1800, 1900, 2000.

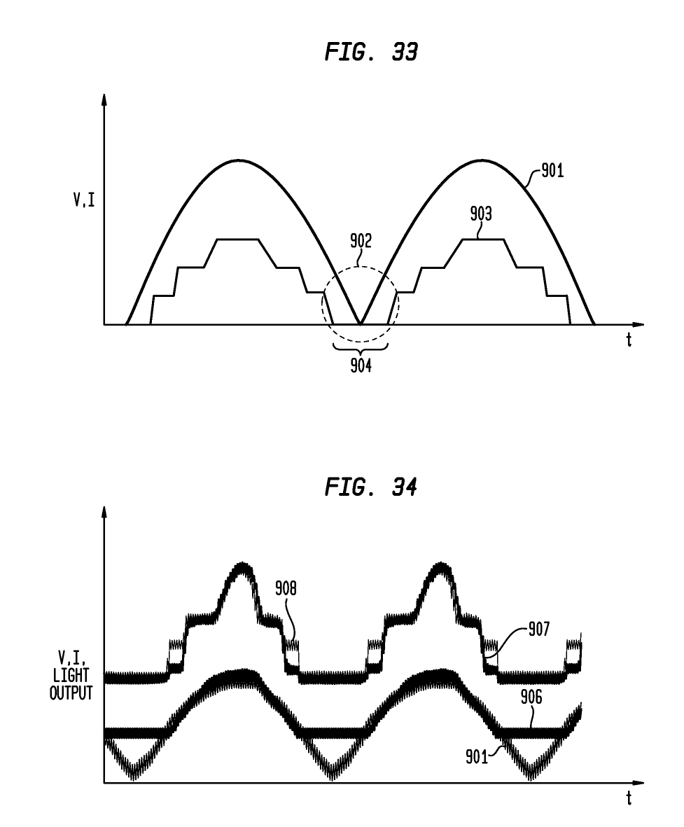

In addition, as discussed in greater detail below, one or more voltage regulators 805 may also be implemented, to maintain a minimum, predetermined or selected voltage level for the LED segments 175, for example, near the intervals of the zero crossing portions of a rectified voltage provided by rectifier 105, as illustrated by the exemplary voltage waveforms in FIGS. 33, 34, 36 and 37 discussed below. A wide variety of voltage regulators 805 are illustrated and discussed with reference to FIGS. 35 and 38-42. In exemplary embodiments, a voltage regulator 805 is utilized to provide a voltage level sufficient for at least one LED 140 to be on and conducting (and emitting light) substantially or mostly at all times (provided the at least one LED 140 is in at least one series LED 140 current path), so that there is always or mostly light output when the system 1450 is turned on, including during the intervals of the zero crossing portions of a rectified voltage.

By regulating which LED segments 175 are in or out of the series LED 140 current path (or multiple series LED 140 current paths), regulating the level of current through the series LED 140 current path and/or one or more LED segments 175 within the series LED 140 current path(s), and by regulating the voltage level provided to the LED segments 175, a significant degree of control over corresponding light output is provided, including control over brightness (lumen output), duration of continuous light output (or flicker), and the power factor of the apparatuses and systems. For example, the various exemplary embodiments illustrated in FIGS. 32, 35, and 38-42 have a significantly reduced flicker index (defined as the amount of light above the average level divided by the total light output), in addition to providing a comparatively high power factor, at a selected or predetermined lumen output.

Also for example, the various exemplary embodiments illustrated in FIGS. 32, 35, and 38-42 are also able to accommodate a wide range of input AC voltage levels (e.g., 220 V for Asia and Europe and 120V for North America) and a wide range of tolerances for the LEDs 140 (e.g., variability of manufacture), which may have a wide range of forward voltage level drops, such as plus or minus 20%. Because of such variance in forward voltage drop, without the additional control provided by the exemplary embodiments illustrated in FIGS. 32, 35, and 38-42, various LED segments 175 may receive insufficient levels of current (and therefore would be dim or dark), while other LED segments 175 could receive excessive voltage or current levels and reduce system efficiency and lifespan.

FIG. 33 is a graphical diagram illustrating exemplary voltage and current waveforms without this additional voltage regulation. As illustrated, a rectified voltage is provided, illustrated as waveform 901, with line current levels illustrated as waveform 903. In the vicinity of the “zero crossing” (illustrated as region 902, with the zero crossing referring to the interval surrounding the corresponding zero crossing of the non-rectified AC voltage (from AC source 102)), without a voltage regulator 805, the rectified voltage generally is not high enough to allow the LEDs 140 (or one or more LED segments 175) to be on and conducting within a series LED 140 current path, i.e., is not high enough to overcome the forward voltage required by one or more LEDs 140 and generate sufficient LED 140 current (region 904 of line current waveform 903). As a result, the LEDs 140 would not be providing light output during this zero crossing interval (region 902), with the potential for both perceived flicker and perceived variance in light output levels.

FIG. 34 is a graphical diagram illustrating exemplary voltage, current and light output waveforms using an exemplary voltage regulator 805. As illustrated, the voltage regulator 805 provides a higher voltage level (illustrated as waveform 906) during the zero crossing interval (“filling the valley”) of the rectified voltage (waveform 901), which is sufficient to allow at least one LED 140 (or more) to be on and conducting. For example, when implemented as voltage regulator 805A discussed below with reference to FIG. 35, the capacitors 820, 821 are charged during the higher voltage (peak) portion or interval of the rectified voltage, and provide voltage and/or current to the one or more LED segments 175 at other times, such as during the zero crossing interval, and/or at other voltage levels (e.g., whenever the rectified voltage level drops below the voltage level provided by the voltage regulator 805). FIG. 34 also illustrates line current (waveform 908) and light output (waveform 907), which also indicates varying light output levels. It should be noted that the LED 140 current in the series LED 140 current path (not separately illustrated in FIG. 34) generally will differ from the exemplary LED 140 current illustrated in FIG. 2, as the non-peak current levels in the series LED 140 current path will generally be higher than the levels shown in FIG. 2 during the zero crossing intervals, as determined by the voltage and/or current levels provided by the voltage regulator 805, for example and without limitation. In addition, it should be noted that the peak current levels in the series LED 140 current path may also be different than the levels illustrated in FIG. 2 (e.g., there may be multiple different peak current levels depending upon which LED segments 175 are in the series LED 140 current path(s), each of which also may be comparatively stable, flat or clamped at a particular current level, also for example and without limitation), as discussed in greater detail below.

A wide variety of (switching) sequences of the current regulators 810, and corresponding current levels provided by the current regulators 810 (e.g., fixed, variable, programmable), are available and within the scope of the disclosure, for any and all of the various embodiments. For example, and as illustrated with the waveforms shown in FIG. 34, in a first exemplary current level and LED segment 175 switching sequence, the current levels are incremented sequentially from lower to higher as more LED segments 175 are included in the series LED 140 current path (first, lower current level for LED segment 175₁ in the series LED 140 current path; followed by a second, mid-range current level for LED segment 175₁ and LED segment 175₂ in the series LED 140 current path, followed by a third, higher current level for LED segment 175₁ through LED segment 175ₙ in the series LED 140 current path), and sequentially decremented from higher back to lower as LED segments 175 are removed (or bypassed) from the series LED 140 current path (third, higher current level for LED segment 175₁ through LED segment 175ₙ in the series LED 140 current path, followed by a second, mid-range current level for LED segment 175₁ and LED segment 175₂ in the series LED 140 current path, followed by a first, lower current level for LED segment 175₁ in the series LED 140 current path). For example: (1) in Q1, current regulator 810₁ is on first and is set to 50 mA as a first, lower current level for LED segment 175₁ in the series LED 140 current path, while the other current regulators 810 are off; current regulator 810₁ is turned off, current regulator 810₂ is on next and is set to 75 mA as a second, mid-range current level for LED segment 175₁ and LED segment 175₂ in the series LED 140 current path (also while the other current regulators 810 are off); current regulator 810₂ is turned off, current regulator 810ₙ is on last and is set to 100 mA as a third, higher current level for LED segment 175₁ through LED segment 175ₙ in the series LED 140 current path (also while the other current regulators 810 are off); and (2) in Q2, the sequence is reversed, such that current regulator 810ₙ remains on and is set to 100 mA for LED segment 175₁ through LED segment 175ₙ in the series LED 140 current path (while the other current regulators 810 are off); current regulator 810ₙ is turned off, current regulator 810₂ is on next and is set to 75 mA for LED segment 175₁ and LED segment 175₂ in the series LED 140 current path (also while the other current regulators 810 are off); and lastly current regulator 810₂ is turned off, current regulator 810₁ is on next and is set to 50 mA for LED segment 175₁ in the series LED 140 current path (also while the other current regulators 810 are off).

In exemplary embodiments, and as discussed in greater detail below, a wide variety of non-sequential current regulation schemes also may be implemented and utilized to provide a significantly reduced flicker index, a more constant or stable level of light output, and a comparatively high power factor. For example, in various embodiments, the current levels are not incremented sequentially from lower to higher as additional LED segments 175 are included in the series LED 140 current path, and are not decremented sequentially from higher back to lower as LED segments 175 are removed (or bypassed) from the series LED 140 current path. Rather, for a system with three current regulators 810, for example, during a rectified voltage interval, as additional LED segments 175 are included in the series LED 140 current path in Q1, the current levels are sequenced from the second, mid-range current level, followed by the first, lower current level, then followed by the third, higher current level, and as LED segments 175 are removed (or bypassed) from the series LED 140 current path in Q2, the third, higher current level is then followed by the first, lower current level, and followed by the second, mid-range current level. Additional types or implementations of such non-sequential current regulation are discussed in greater detail below.

FIG. 35 is a block and circuit diagram illustrating a fifteenth exemplary system 1550 and a fifteenth exemplary apparatus 1500 in accordance with the teachings of the present invention. As illustrated in FIG. 35, exemplary voltage regulator 805A comprises a first capacitor 820 coupled in series (through diode 831) to a second capacitor 821. The first and second capacitors 820, 821 may be implemented using any suitable type of capacitors, and are typically “bulk” capacitors, such as aluminum electrolytic capacitors, for example and without limitation. The first and second capacitors 820, 821 are charged in series (via diode 831) to a selected or predetermined (voltage regulator 805) voltage level during the higher voltage (e.g., peak) portion or interval of the rectified voltage (namely, whenever the rectified voltage level is higher than the voltage level provided by the voltage regulator 805A). Also during this higher voltage (peak) portion or interval of the rectified voltage, voltage and/or current generally are also being provided to the selected LED segments 175 of the series LED 140 current path(s), at predetermined or selected current levels. When the rectified voltage level is lower than the voltage level provided by the first and second capacitors 820, 821 (as part of the voltage regulator 805A), however, the first and second capacitors 820, 821 discharge in parallel (with the discharge path for the second capacitor 821 provided by diode 830, and diode 832 completing the circuit (return path) for capacitor 820), providing voltage and/or current to the LED segments 175 of the series LED 140 current path(s) during this lower, non-peak portion or interval of the rectified voltage. As a consequence, voltage and/or current sufficient for one or more LEDs 140 to be on and conducting (and emitting light) may be provided to the LED segments 175 of the series LED 140 current path(s) at all times or during any selected time interval.

Continuing to refer to FIG. 35, additional control is provided by current sources 815 (illustrated as current sources 815₁, 815₂, through 815ₙ), which are utilized to implement one or more current regulator(s) 810, and may be implemented as linear regulators, for example and without limitation, with several examples illustrated in FIGS. 44-46. The current sources 815 implement two functions in the exemplary system 1550 and exemplary apparatus 1500, and are under the control of a controller 120J. First, the current sources 815 effectively determine which LED segments 175 are in the series LED 140 current path(s) or are bypassed, functioning similarly to the various switches (110, 310) discussed previously. For example, when only current source 815₂ is on, LED segments 175₁ and 175₂ are in the series LED 140 current path, and LED segment 175ₙ is not in the series LED 140 current path; when only current source 815₁ is on, LED segment 175₁ is in the series LED 140 current path, and LED segments 175₂ through 175ₙ are not in the series LED 140 current path; and when only current source 815ₙ is on, all LED segment 175₁, 175₂ through 175ₙ are in the series LED 140 current path. Second, the current sources 815 determine the amount or maximum (peak) amount of current allowed through the LED segments 175 in the series LED 140 current path(s). The on or off status of the current sources 815 and/or the current levels of the current sources 815 may be determined dynamically by the controller 120J or other control logic, for example, using current level feedback provided by current sensor 115, implemented as illustrated using a current sense resistor 165; alternatively, the current levels and on/off status (switching on or off) of the current sources 815 may be predetermined or selected and provided as programmed input into the controller 120J; alternatively, the current levels and on/off status (switching on or off) of the current sources 815 may be predetermined or selected and provided as programmed input into the current sources 815 or other control logic.

It should also be noted that the current levels for any of the current sources 815 may be fixed or variable, and may be predetermined, programmable, and/or under the control of the controller 120J (e.g., in response to the detected level of current in current sensor 115, such as to accommodate variations in line voltages). For examples, a current source 815 may have a fixed current level, may have a variable level, may have a variable level up to a maximum level, and/or may have a current level determined by the controller 120J. For example, in the exemplary systems 1650, 1750 and exemplary apparatuses 1600, 1700 discussed below, the current levels of the current sources 815₃ and current sources 815ₙ are provided at levels to provide a comparatively or mostly constant light output overall (during successive rectified voltage intervals), rather than an increased light output due to more LED segments 175 being in the series LED 140 current path(s) or a reduced light output due to fewer LED segments 175 being in the series LED 140 current path(s).

As mentioned above, a wide variety of (switching) sequences of the current sources 815, and corresponding current levels provided by the current sources 815 (e.g., fixed, variable, programmable), are available and within the scope of the disclosure, for any and all of the various embodiments. For example, in a first exemplary current sequence, the current levels are incremented sequentially from lower to higher as LED segments 175 are included in the series LED 140 current path (first, lower current level, followed by a second, mid-range current level, followed by a third, higher current level), and sequentially decremented from higher back to lower as LED segments 175 are removed (or bypassed) from the series LED 140 current path (third, higher current level, followed by a second, mid-range current level, followed by a first, lower current level): (1) in Q1, current source 815₁ is on first and is set to 50 mA, while the other current sources 815 are off; current source 815₁ is turned off, current source 815₂ is on next and is set to 75 mA (also while the other current sources 815 are off); current source 815₂ is turned off, current source 815ₙ is on last and is set to 100 mA (also while the other current sources 815 are off); and (2) in Q2, current source 815ₙ remains on and is set to 100 mA (while the other current sources 815 are off); current source 815ₙ is turned off, current source 815₂ is on next and is set to 75 mA (also while the other current sources 815 are off); and lastly current source 815₂ is turned off, current source 815₁ is on next and is set to 50 mA (also while the other current sources 815 are off).

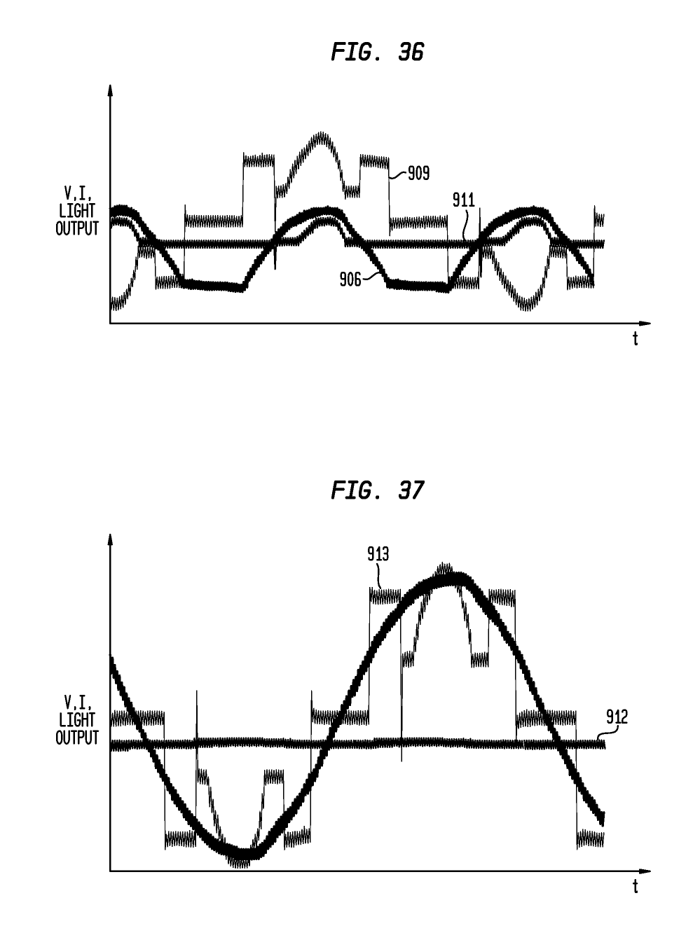

In another, second exemplary current sequence illustrated in FIG. 36, the current levels are not incremented sequentially from lower to higher as LED segments 175 are included in the series LED 140 current path and are not decremented sequentially from higher back to lower as LED segments 175 are removed (or bypassed) from the series LED 140 current path. Rather, for a system with three current sources 815, the current levels are sequenced from the second, mid-range current level, followed by the first, lower current level, followed by the third, higher current level), followed by the first, lower current level, and followed by the second, mid-range current level, as follows: (1) in Q1, current source 815₁ is on first and is set to 75 mA for LED segment 175₁ in the series LED 140 current path, while the other current sources 815 are off; current source 815₁ is turned off, current source 815₂ is on next and is set to 50 mA for LED segment 175₁ and LED segment 175₂ in the series LED 140 current path (also while the other current sources 815 are off); current source 815₂ is turned off, current source 815ₙ is on last and is set to 100 mA for LED segment 175₁ through LED segment 175ₙ in the series LED 140 current path (also while the other current sources 815 are off); and (2) in Q2, current source 815ₙ remains on and is set to 100 mA for LED segment 175₁ through LED segment 175ₙ in the series LED 140 current path (while the other current sources 815 are off); current source 815ₙ is turned off, current source 815₂ is on next and is set to 50 mA for LED segment 175₁ and LED segment 175₂ in the series LED 140 current path (also while the other current sources 815 are off); and lastly current source 815₂ is turned off, current source 815₁ is on next and is set to 75 mA for LED segment 175₁ in the series LED 140 current path (also while the other current sources 815 are off).

Using this non-sequential current regulation of the second example, when current source 815₁ is on, the LED segment 175₁ is driven at a second, mid-range current level (75 mA), which is higher than the current level used to drive both LED segment 175₁ and LED segment 175₂ when current source 815₂ is on (50 mA). As a result, when current source 815₁ is on, LED segment 175₁ is operated at a brighter level during this interval, producing a greater light output than if driven at the first, lower current level. Similarly, when current source 815₂ is on, LED segment 175₁ and LED segment 175₂ are operated at the first, lower current level; because multiple LED segments 175 are receiving this lower amount of current, however, the overall brightness and light output generated is substantially about the same (as LED segment 175₁ being driven at the second, mid-range current level), resulting in a more stable, even or constant light output, without flicker, as illustrated in FIG. 36 (substantially stable light output with some increase in the vicinity of the peak of the rectified voltage level) and FIG. 37 (substantially constant light output throughout the rectified voltage interval).

FIG. 36 is a graphical diagram illustrating exemplary voltage, line current and light output waveforms for the fifteenth exemplary system 1550 and a fifteenth exemplary apparatus 1500, with the non-sequential current regulation (of the second exemplary current sequence discussed above) and also using an exemplary voltage regulator 805A. As illustrated, light output (waveform 911) is considerably more stable, without flicker, using this non-sequential current regulation: (1) in Q1, current source 815₁ is on first and is set to 75 mA for LED segment 175₁ in the series LED 140 current path, while the other current sources 815 are off; current source 815₂ is on next and is set to 50 mA for LED segment 175₁ and LED segment 175₂ in the series LED 140 current path (also while the other current sources 815 are off); and current source 815ₙ is on last and is set to 100 mA for LED segment 175₁ through LED segment 175ₙ in the series LED 140 current path (also while the other current sources 815 are off); and in Q2, current source 815ₙ remains on and is set to 100 mA for LED segment 175₁ through LED segment 175ₙ in the series LED 140 current path (while the other current sources 815 are off); current source 815₂ is on next and is set to 50 mA for LED segment 175₁ and LED segment 175₂ in the series LED 140 current path (also while the other current sources 815 are off); and lastly current source 815₁ is on next and is set to 75 mA for LED segment 175₁ in the series LED 140 current path (also while the other current sources 815 are off). The line current waveform 909 also reflects the switching of the current sources 815 and the voltage/current provided by voltage regulator 805A, with no current provided by the AC 102 line when the voltage regulator 805A is providing current to the LEDs 140 (the “valley fill portion” near the zero crossing interval), followed by higher line current levels as the various current sources 815 are switched on and off (and capacitors 820, 821 are charged) with their corresponding current levels for the for LED segment(s) 175 in the series LED 140 current path (LED 140 current not separately illustrated).

In a third exemplary current sequence, only two current sources 815₁ and 815₂ are utilized with two LED segments 175₁ and 175₂ of the system and apparatus illustrated in FIG. 35. In this sequence, the current levels are not incremented sequentially from lower to higher and are not decremented sequentially from higher back to lower. Rather, for a system with two current sources 815, the current levels are sequenced from the higher to the lower level, followed by the lower current level to the higher current level, as follows: (1) in Q1, current source 815₁ is on first and is set to 75 mA for LED segment 175₁ in the series LED 140 current path, while the other current sources 815 are off; current source 815₁ is turned off, current source 815₂ is on next and is set to 50 mA for LED segment 175₁ and LED segment 175₂ in the series LED 140 current path (also while the other current sources 815 are off); and (2) in Q2, current source 815₂ remains on and is set to 50mA for LED segment 175₁ and LED segment 175₂ in the series LED 140 current path (while the other current sources 815 are off); and lastly current source 815₂ is turned off, current source 815₁ is on next and is set to 75mA for LED segment 175₁ in the series LED 140 current path (also while the other current sources 815 are off). It should be noted that this third sequence is similar to the second sequence, except that the third or n^{th} LED segment 175ₙ and the third or n^{th} current source 815ₙ are not utilized.

FIG. 37 is a graphical diagram illustrating exemplary voltage, line current and light output waveforms for the fifteenth exemplary system 1550 and a fifteenth exemplary apparatus 1500, with the non-sequential current regulation (of the third exemplary current sequence discussed above) and also using an exemplary voltage regulator 805A. As illustrated, light output (waveform 912) is considerably more stable, effectively flat and without flicker, using this third exemplary non-sequential current regulation described in the immediately preceding paragraph. The line current waveform 913 also reflects the switching of the current sources 815 and the voltage/current provided by voltage regulator 805A, with no current provided by the AC line when the voltage regulator 805A is providing current (the “valley fill portion”), followed by higher line current levels as the various current sources 815 are switched on and off with their corresponding current levels (LED 140 current also not separately illustrated).

While three sequences have been discussed and illustrated using two and three LED segments 175, it should be noted that innumerable additional current regulation sequences and permutations are available, are within the scope of the disclosure, and are largely dependent upon the number of LED segments 175 and current sources 815 (current regulators 810 and/or switches 110, 310) with corresponding current levels which may be utilized in any selected embodiment. For example, the current sources 815 may be decremented sequentially from higher to lower in Q1 as LED segments 175 are included in the series LED 140 current path and incremented sequentially from lower to higher in Q2 as LED segments 175 are removed (or bypassed) from the series LED 140 current path. Also for example, a wide variety of non-sequential current regulation patterns are also available, e.g., a higher to a first mid-level to a second (higher) mid-level to a lowest current level in Q1 as LED segments 175 are included in the series LED 140 current path, etc. In addition, the sequencing for Q2 may also have a different order, not merely the reverse order of Q1. Also in addition, different sequences (sequential and non-sequential) may also be utilized for determining which LED segments 175 are included in or removed from the series LED 140 current path, and their corresponding current levels. All such current regulation sequencing combinations and permutations for LED 140 switching and current level regulation are within the scope of the disclosure, and are applicable to any and all of the various exemplary embodiments.

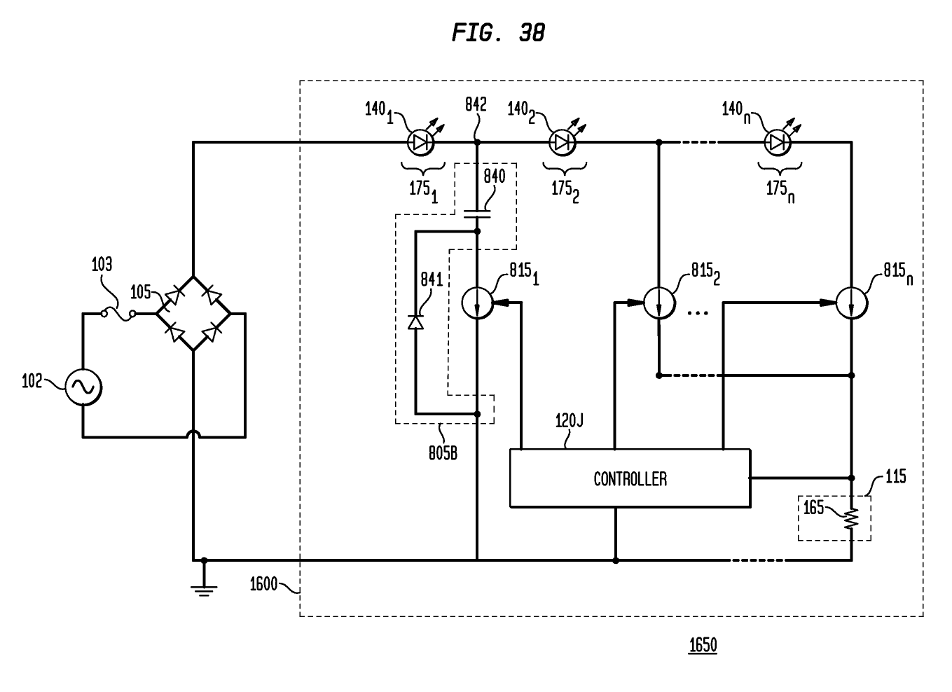

FIG. 38 is a block and circuit diagram illustrating a sixteenth exemplary system 1650 and a sixteenth exemplary apparatus 1600 in accordance with the teachings of the present invention. As illustrated in FIG. 38, in contrast to the exemplary voltage regulator 805A, the exemplary voltage regulator 805B is not coupled directly to the rectifier 105, but is coupled through an LED segment 175₁ to the rectifier 105, further illustrating the wide variety of circuit configurations within the scope of the disclosure. The exemplary voltage regulator 805B comprises a capacitor 840 and diode 841, with the capacitor 840 coupled in series to a current source 815₁ (as an embodiment of a current regulator 810), and with the diode 841 coupled anti-parallel to the current source 815₁ to provide a return current path when capacitor 840 discharges. The capacitor 840 also may be implemented using any suitable type of capacitor, and also is typically a “bulk” capacitor, for example and without limitation. The capacitor 840 is charged through LED segment 175₁ to a selected or predetermined (voltage regulator 805) voltage level during the comparatively higher voltage (peak) portion or interval of the rectified voltage when current source 815₁ is on and the voltage level at node 842 (the cathode of the last LED 140 of LED segment 175₁) is higher than the voltage level provided by the voltage regulator 805B (capacitor 840). Also during this higher voltage (peak) portion or interval of the rectified voltage, voltage and/or current are also being provided to LED segment 175₁ and, depending upon whether current source 815₂ and/or current source 815ₙ are on and conducting and depending upon their corresponding current level settings, to other selected LED segments 175 of the series LED 140 current path(s), at predetermined or selected current levels, providing multiple possible or available series LED 140 current paths (e.g., through LED segment 175₁ only, through LED segment 175₁ and LED segment 175₂ only, and/or through LED segment 175₁, LED segment 175₂ through LED segment 175ₙ.

For example, during this peak interval, to maintain a more constant light output, current source 815ₙ (or current source 815₂) may be adjusted accordingly (e.g., throttled back), such as set to a lower current level than current source 815₁, so the majority of current charges capacitor 840 and a lower level of current flows through LED segment 175₂ through LED segment 175ₙ, with all current also flowing through LED segment 175₁ in the series LED 140 current path. When the voltage level at node 842 is comparatively lower during other portions of the rectified AC voltage cycle, no current is provided to LED segment 175₁, the capacitor 840 discharges (with the completion of the discharge path or circuit provided by diode 841), providing voltage and/or current to the other LED segments 175₂ and/or 175₂ through 175ₙ of the series LED 140 current path(s) during this lower, non-peak portion or interval of the rectified voltage. As a consequence, voltage and/or current sufficient for one or more LEDs 140 to be on and conducting (and emitting light) may be provided to the LED segments 175 of the series LED 140 current path(s) at all times or during any selected time interval, with the sixteenth exemplary system 1650 and sixteenth exemplary apparatus 1600 providing a flicker index that can be driven down to about or close to zero, depending upon the implementation and selected sequencing of current regulation.

In addition, any of the various sequential and non-sequential types of current regulation discussed above may also be utilized with the sixteenth exemplary system 1650 and a sixteenth exemplary apparatus 1600, such as a fourth exemplary current sequence, for example. In this fourth sequence, assuming the capacitor 840 has been charged, during the zero crossing interval of Q1, current is typically sourced by the capacitor 840. During this zero crossing interval of Q1, either current source 815₂ and/or current source 815ₙ may be on and conducting, with LED segment 175₂ in the series LED 140 current path and/or with LED segment 175₂ through LED segment 175ₙ in the series LED 140 current path, respectively, e.g., for lower or higher voltage levels, as discussed above. Subsequently in Q1, in the vicinity of the peak rectified AC current/voltage, current source 815₁ then conducts, with LED segment 175₁ in the series LED 140 current path, in any of several ways. If only current source 815₁ is on and conducting, then only LED segment 175₁ is in the series LED 140 current path (with capacitor 840). If either or both current source 815₂ and/or current source 815ₙ are also on and conducting with current source 815₁, then LED segment 175₁ with LED segment 175₂ are in the series LED 140 current path, and/or LED segment 175₁ with LED segment 175₂ through LED segment 175ₙ are in the series LED 140 current path, or both. This sequence may be reversed for Q2, or another sequence may be utilized. As previously discussed, the different current levels provided by the current sources 815 may also be sequential or non-sequential with the addition and/or removal of LED segments 175 respectively to or from the series LED 140 current path.

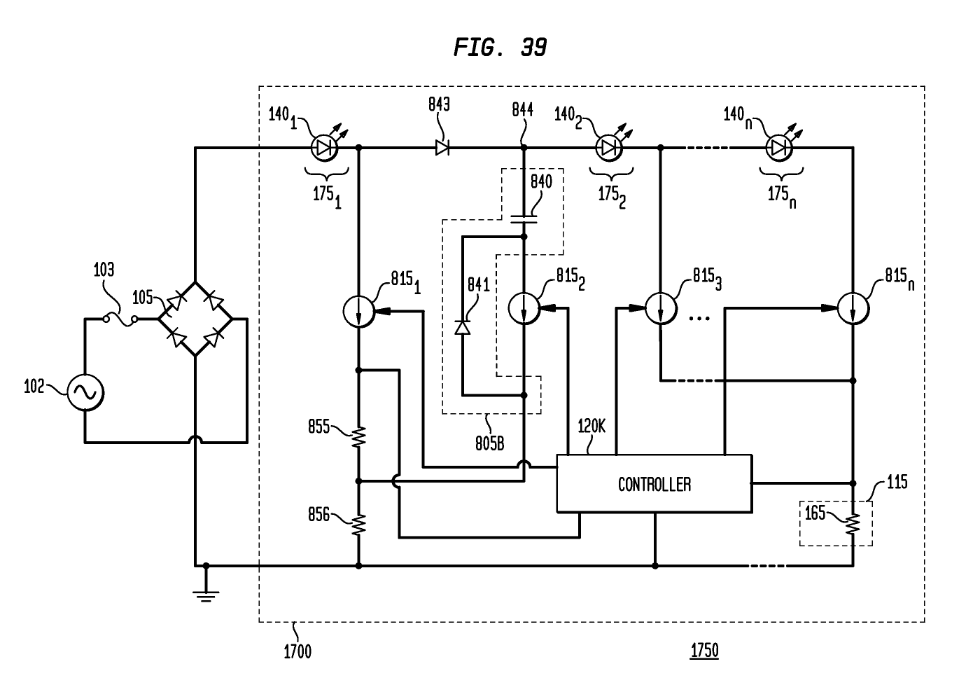

FIG. 39 is a block and circuit diagram illustrating a seventeenth exemplary system 1750 and a seventeenth exemplary apparatus 1700 in accordance with the teachings of the present invention. As illustrated in FIG. 39, the exemplary voltage regulator 805B also is not coupled directly to the rectifier 105, but is coupled through an LED segment 175₁ and diode 843 to the rectifier 105, also illustrating the wide variety of circuit configurations within the scope of the disclosure. The various current sources 815 are controlled by controller 120K, which differs from the previously discussed controllers 120 insofar as it provides control or regulation of current sources 815 (rather than switches 110, 310), and as illustrated, is also configured to receive additional feedback signals from the voltage and current levels developed across resistors 855, 856, which function as additional voltage and/or current sensors. The exemplary voltage regulator 805B also comprises a capacitor 840 and diode 841, but with the capacitor 840 coupled in series to a current source 815₂ (as an embodiment of a current regulator 810), and with the diode 841 coupled anti-parallel to the current source 815₂. The capacitor 840 also may be implemented using any suitable type of capacitor, and also is typically a “bulk” capacitor, for example and without limitation. The capacitor 840 is charged through LED segment 175₁ and diode 843 to a selected or predetermined (voltage regulator 805) voltage level during the higher voltage (peak) portion or interval of the rectified voltage when current source 815₂ is on and the voltage level at node 844 (the cathode of diode 843) is higher than the voltage level provided by the voltage regulator 805B. Also during this higher voltage (peak) portion or interval of the rectified voltage, voltage and/or current typically are also being provided to LED segment 175₁ and, depending upon whether current source 815₃ and current source 815ₙ are on and conducting and depending upon their corresponding current level settings, to other selected LED segments 175 of the series LED 140 current path(s), at predetermined or selected current levels, providing multiple series LED 140 current paths (e.g., through LED segment 175₁ only, through LED segment 175₁ and LED segment 175₂ only, and/or also through LED segment 175₁, LED segment 175₂ through LED segment 175ₙ). For example, during this peak interval, current source 815ₙ may be set to a lower current level than current source 815₂, so the majority of current charges capacitor 840 and a lower level of current flows through LED segment 175₂ through LED segment 175ₙ, with all current also flowing through LED segment 175₁.

When the voltage level at node 844 is or becomes lower, the capacitor 840 also discharges (with the completion of the discharge path or circuit provided by diode 841), providing voltage and/or current to the other LED segments 175₂ and/or 175₂ through 175ₙ of the series LED 140 current path(s) during this lower, non-peak portion or interval of the rectified voltage. In addition, also during this portion of the rectified AC cycle, current source 815₁ may also be on and conducting, with an additional series LED 140 current path provided for LED segment 175₁, resulting in multiple and separate series LED 140 current paths. As a consequence, voltage and/or current sufficient for one or more LEDs 140 to be on and conducting (and emitting light) may be provided to the LED segments 175 of the series LED 140 current path(s) at all times or during any selected time interval. In addition, this seventeenth exemplary system 1750 and a seventeenth exemplary apparatus 1700 provides an even greater power factor (e.g., greater than 0.9) and an equal or even more reduced flicker index.

In addition, any of the various sequential and non-sequential types of current regulation discussed above may also be utilized with the seventeenth exemplary system 1750 and a seventeenth exemplary apparatus 1700, such as a fifth exemplary current sequence, for example. In this fifth sequence, assuming the capacitor 840 has been charged, during the zero crossing interval of Q1, current is typically sourced by the capacitor 840. During this zero crossing interval of Q1, either current source 815₃ and/or current source 815ₙ may be on and conducting, with LED segment 175₂ in the series LED 140 current path and/or with LED segment 175₂ through LED segment 175ₙ in the series LED 140 current path, respectively, e.g., for lower or higher voltage levels, as discussed above. In addition, at these lower rectified AC voltage levels in Q1, current source 815₁ may also be on and conducting, with an additional series LED 140 current path provided for LED segment 175₁. Subsequently in Q1, in the vicinity of the peak rectified AC current/voltage, current source 815₂ then conducts, with LED segment 175₁ in the series LED 140 current path, in either of several ways. If only current source 815₂ is on and conducting, then only LED segment 175₁ is in the series LED 140 current path (with diode 843 and capacitor 840). If either or both current source 815₃ and/or current source 815ₙ are also on and conducting with current source 815₂, then LED segment 175₁ with LED segment 175₂ are in the series LED 140 current path, and/or LED segment 175₁ with LED segment 175₂ through LED segment 175ₙ are in the series LED 140 current path, or both, at lower current levels and reduced brightness. Additionally, capacitor 840 is also being charged during this interval of the peak rectified AC current/voltage. This sequence may be reversed for Q2, or another sequence may be utilized. As previously discussed, the different current levels provided by the current sources 815 may also be sequential or non-sequential with the addition and/or removal of LED segments 175 respectively to or from the series LED 140 current path.

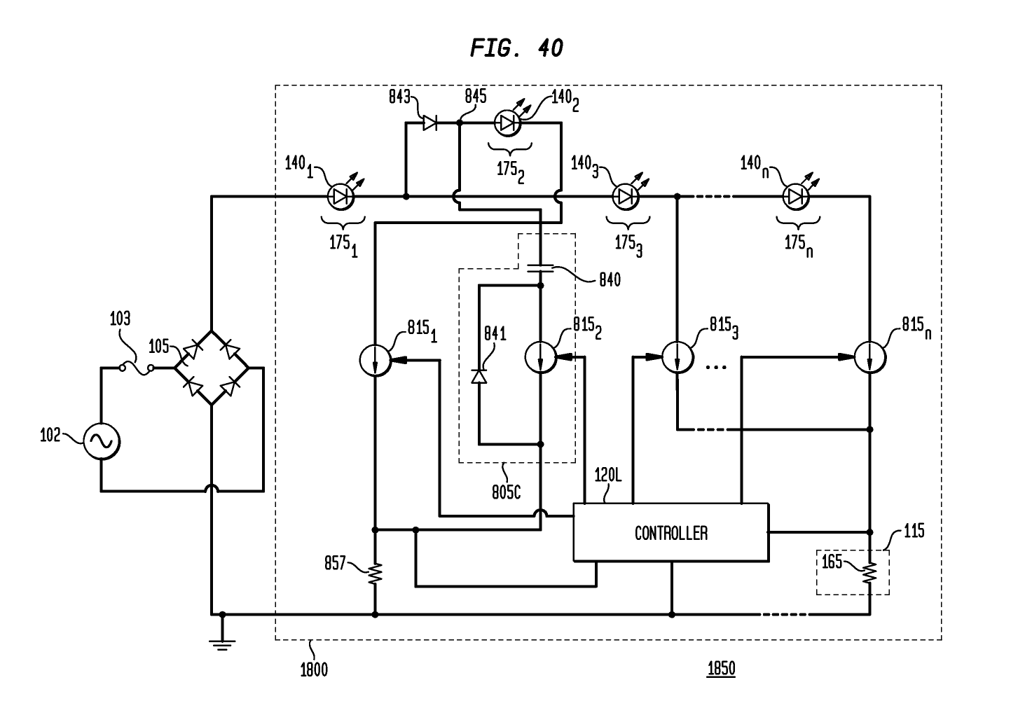

FIG. 40 is a block and circuit diagram illustrating an eighteenth exemplary system 1850 and an eighteenth exemplary apparatus 1800 in accordance with the teachings of the present invention. As illustrated in FIG. 40, the exemplary voltage regulator 805C also is not coupled directly to the rectifier 105, but is coupled through an LED segment 175₁ and diode 843 to the rectifier 105, also illustrating the wide variety of circuit configurations within the scope of the disclosure. The various current sources 815 are controlled by controller 120L, which differs from the previously discussed controllers 120 insofar as it provides control or regulation of current sources 815 (rather than switches 110, 310), and as illustrated, is configured to receive additional feedback signals from the voltage and current levels developed across resistor 857, which functions as an additional voltage and/or current sensor (in addition to resistor 165). The exemplary voltage regulator 805C comprises a controlled current source 815₂, a capacitor 840 and diode 841, with the capacitor 840 coupled in series to current source 815₂, and with the diode 841 coupled anti-parallel to the current source 815₂. The capacitor 840 also may be implemented using any suitable type of capacitor, and also is typically a “bulk” capacitor, for example and without limitation. The capacitor 840 is charged through LED segment 175₁ and diode 843 to a selected or predetermined (voltage regulator 805) voltage level during the higher voltage (peak) portion or interval of the rectified voltage when current source 815₂ is on and the voltage level at node 845 (the cathode of diode 843) is higher than the voltage level provided by the voltage regulator 805C.

In contrast to the embodiment illustrated in FIG. 39, this exemplary system 1850 and apparatus 1800 utilizes a discharge path for the capacitor 840 through LED segment 175₂ and current source 815₁. In addition, when current source 815₁ is on and conducting, depending upon the voltage at node 845, LED segment 175₂ or LED segment 175₁ and LED segment 175₂ may be in the series LED 140 current path(s). In an exemplary embodiment for sequencing of current regulation, generally current source 815₁ remains on during all of Q1 and Q2, although other current regulation sequences may also be utilized, as there is virtually always some energy on capacitor 840 once it has been charged.

Any of the various sequential and non-sequential types of current regulation discussed above may also be utilized with the exemplary system 1850 and apparatus 1800, such as a sixth exemplary current sequence, for example. In this sixth sequence, assuming the capacitor 840 has been charged, during the zero crossing interval of Q1, current is typically sourced by the capacitor 840. During this zero crossing interval of Q1, capacitor 840 is discharging, current source 815₁ is on and conducting, and LED segment 175₂ is in a first series LED 140 current path, with current source 815₁ regulating the amount of current through this first series LED 140 current path. Also during this lower voltage portion of the rectified AC voltage, as the rectified AC voltage level becomes sufficient, either current source 815₃ and/or current source 815ₙ also may be on and conducting, with LED segment 175₁ and LED segment 175₃ in a second series LED 140 current path and/or with LED segment 175₁, LED segment 175₃ through LED segment 175ₙ in the second series LED 140 current path, respectively, e.g., for lower or higher voltage levels, as discussed above. Subsequently in Q1, in the vicinity of the peak rectified AC current/voltage, current source 815₂ then conducts, with LED segment 175₁ in the series LED 140 current path(s), in either of several ways. If only current source 815₂ is on and conducting, then only LED segment 175₁ is in the series LED 140 current path (with diode 843 and capacitor 840). If current source 815₁ is also on and conducting with current source 815₂, then LED segment 175₁ with LED segment 175₂ are also in a series LED 140 current path. Additionally, capacitor 840 is also being charged during this interval of the peak rectified AC current/voltage. Generally, current source 815₃ through current source 815ₙ are off or are conducting at reduced levels during this peak portion of the rectified AC voltage, in order to keep the light output substantially constant and for higher efficiency. This sequence may be reversed for Q2, or another sequence may be utilized. As previously discussed, the different current levels provided by the current sources 815 may also be sequential or non-sequential with the addition and/or removal of LED segments 175 respectively to or from the series LED 140 current path.

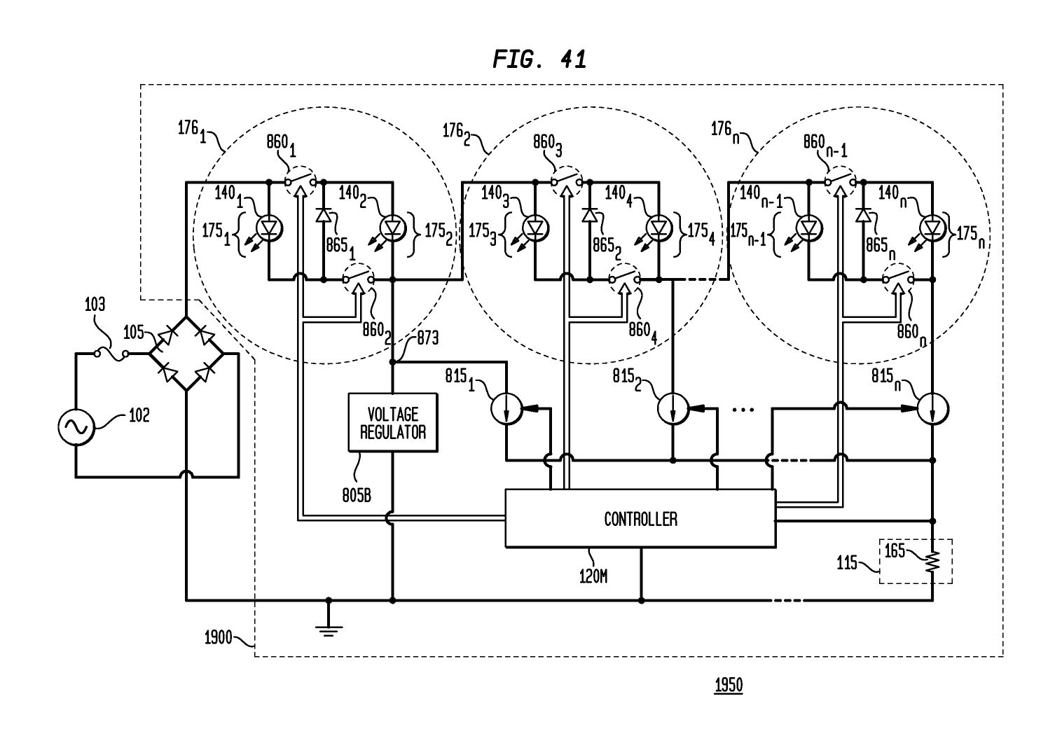

FIG. 41 is a block and circuit diagram illustrating a nineteenth exemplary system 1950 and a nineteenth exemplary apparatus 1900 in accordance with the teachings of the present invention, and illustrates additional switching of LED segments 175 to be in or out of the series LED 140 current path. Such additional switching capability is particularly useful for accommodating variances in the magnitude of the voltage levels provided on the AC line and improves efficiency, as more or fewer LED segments 175 may be switched in or out of the series LED 140 current path depending upon the currently available voltage levels, which may be highly variable. While not separately illustrated, such additional switching of the LED segments 175 also may be combined with any of the various embodiments and current regulation sequences disclosed herein. For example, the apparatus 1900 and system 1950 embodiments are illustrated with a voltage regulator 805B coupled (at node 873) to a cathode of the last LED 140 in LED segment 175₂; alternatively, a voltage regulator 805 for these embodiments may be any of the voltage regulators 805, 805A, 805B, 805C in any of the various circuit locations described herein and/or their equivalents. Also alternatively, no voltage regulator 805 is required to be used with and may be omitted from the apparatus 1900 and system 1950 embodiments.

Referring to FIG. 41, the switches 860 (illustrated as switches 860₁, 860₂, through 860ₙ) are under the control of controller 120M, and may be implemented or embodied as any of type of switch or transistor, such as the various types of switches (110, 310) described above. Controller 120M differs from the previously discussed controllers 120 insofar as it provides both control over switching of switches 860 and control or regulation of current sources 815, in addition to receiving feedback from a current sensor implemented using resistor 165. When all of the switches 860 are closed (e.g., on and conducting), various LED segments 175 are in parallel in pairs (or “tuples”) 176 with each other (pairwise, as illustrated, as pairs or tuples 176₁, 176₂ through 176ₙ), and are further in series with the other LED segments 175 (which are also pairwise in parallel, as illustrated), forming the series LED 140 current path. While illustrated with two LED segments 175 being in parallel in pairs (176) (as a two-member tuple), with each parallel strand 176 in series with each other, such a switching arrangement may be extended to additional parallel and series LED segments 175, such as forming a “tuple” of parallel LED segments 175 (e.g., triple, quadruple, pentuple, etc.). When all of the switches 860 are open (e.g., off and nonconducting), all of the LED segments 175 are in series with each other and in the series LED 140 current path, which also includes diodes 865 (illustrated as diodes 865₁, 865₂ through 865ₙ).

When one of the switches 860 is open and the other switch 860 is closed within the same pair or tuple 176 of LED segments 175, one of the LED segments 175 of that pair or tuple 176 is removed or out of the series LED 140 current path. With the opening of one of the switches 860₁, 860₃ and/or 860ₙ₋₁ while the other switches 860₂, 860₄ and/or 860ₙ of the corresponding tuple 176 remain closed, a corresponding LED segment 175₂, 175₄, and/or 175ₙ will no longer be conducting in the pair or tuple 176 and no longer in the series LED 140 current path. With the opening of one of the switches 860₂, 860₄ and/or 860ₙ while the other switches 860₁, 860₃ and/or 860ₙ₋₁ of the corresponding tuple 176 remain closed, a corresponding LED segment 175₁, 175₃, and/or 175ₙ₋₁ will no longer be conducting in the pair or tuple 176 and no longer in the series LED 140 current path.

Any of the types of sequential and non-sequential sequencing of current regulation (using current sources 815) may be utilized with the additional LED segment 175 switching provided in the exemplary system 1950 and apparatus 1900 embodiments. As previously discussed, the different current levels provided by the current sources 815 may also be sequential or non-sequential with the addition and/or removal of LED segments 175 (or LED segment 175 tuples 176) respectively to or from the series LED 140 current path. For example, when current source 815₂ is on and conducting at its selected or programmed current level (e.g., a lower current level) while current source 815₁ and current source 815₃ are off and nonconducting, for example, LED tuple 176ₙ is not in the series LED 140 current path, and depending upon the voltage at node 873 and whether voltage regulator 805B is being charged or is sourcing current, LED tuple 176₂ or LED tuples 176₁ and 176₂ are in the series LED 140 current path.

In the following example, the apparatus 1900 and system 1950 embodiments are presumed to not utilize or incorporate the optional voltage regulator 805, and sequential current regulation is implemented. Initially in Q1, when the voltage is comparatively low during the vicinity of the zero crossing interval of the rectified AC voltage from rectifier 105, the controller 120M enables current source 815₁ (while current source 815₂ and current source 815ₙ are off and nonconducting) and turns on (closes) both switches 860₁ and 860₂. This puts LED segments 175₁ and 175₂ in parallel (tuple 176₁), allowing for conduction and light emission when the rectified AC voltage is comparatively lower, as the rectified AC voltage only needs to overcome one LED 140 forward voltage (depending upon the number of LEDs 140 in the LED segment 175). As the voltage continues to rise in Q1, the controller 120M turns on (closes) switches 860₃ and 860₄, putting LED segments 175₃ and 175₃ in parallel (tuple 176₂) and in a series LED 140 current path with the parallel pair or tuple 176₁ of LED segments 175₁ and 175₂, and enables current source 815₂ while disabling current source 815₁. As the voltage continues to rise in Q1, the controller 120M turns on (closes) switches 860ₙ₋₁ and 860ₙ, putting LED segments 175ₙ₋₁ and 175ₙ in parallel (tuple 176ₙ) and in a series LED 140 current path with the parallel pair or tuple 176₁ of LED segments 175₁ and 175₂ and with the parallel pair or tuple 176₂ of LED segments 175₃ and 175₄, and enables current source 815ₙ while disabling current source 815₂. At this point, all switches 860 are on (closed) and conducting, and the current through each LED segment 175 within a pair or tuple 176 is about one-half of the current provided or allowed by the corresponding current source 815 (which, at this point, is current source 815ₙ).

As the rectified AC voltage continues to rise in Q1 (e.g., by at least one forward voltage level of an LED 140), the controller 120M begins to sequentially turn off (open) switches 860, beginning with turning off switches 860ₙ₋₁ and 860ₙ, putting LED segments 175ₙ₋₁ and 175ₙ in series through diode 865ₙ (and in the series LED 140 current path with the parallel pair or tuple 176₁ of LED segments 175₁ and 175₂ and with the parallel pair or tuple 176₂ of LED segments 175₃ and 175₄), with voltage drops continuing to match the higher rectified AC voltage levels. As the rectified AC voltage continues to rise further in Q1 (e.g., by at least one forward voltage level of an LED 140), the controller 120M turns off switches 860₃ and 860₄, putting LED segments 175₃ and 175₄ in series through diode 865₂ and in the series LED 140 current path with the LED segments 175ₙ₋₁ and 175ₙ and the parallel pair or tuple 176₁ of LED segments 175₁ and 175₂, followed by turning off switches 860₁ and 860₂, putting LED segments 175₁ and 175₂ in series through diode 865₁ and in series with all of the other LED segments 175, with voltage drops across the LEDs 140 continuing to match the higher rectified AC voltage levels. It should be noted that the turning off of the various switches in this portion of Q1 may occur in any other order as well, with the same result, that all LED segments 175 are in series in the series LED 140 current path. This sequence may be reversed for Q2, or another sequence may be utilized.

In the switching scheme discussed for the exemplary system 1950 and apparatus 1900, it is evident that at least one LED segment 175 is generally on, except potentially when the rectified AC voltage is close to zero, providing very little flicker and enabling higher system efficiency. If desired, a voltage regulator 805 may be utilized, to provide power during the zero crossing intervals, as discussed above, such as the illustrated voltage regulator 805B.

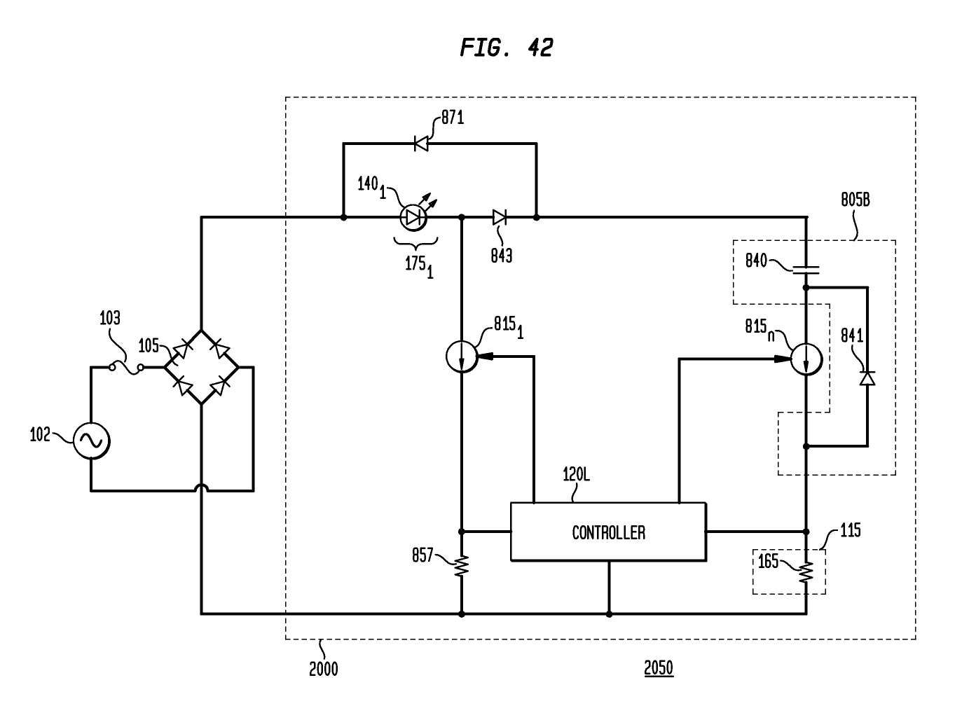

The number of LEDs 140 which may be needed in series (N_{SERIES}), to match the maximum rectified AC voltage level (V_{PEAK}), for a given forward voltage drop (V_{FORWARD}) may be calculated as: N_{SERIES}=V_{PEAK}/V_{FORWARD}. Assuming that an LED 140 forward voltage drop is about 3.2 V, about fifty LEDs 140 are needed for 120V AC line application, while about ninety LEDs 140 are needed for 220V AC line application. The number of required LEDs 140 may be reduced significantly, e.g., by about one-half, utilizing the exemplary system 2050 and apparatus 2000 illustrated and discussed below with reference to FIG. 42.

FIG. 42 is a block and circuit diagram illustrating a twentieth exemplary system 2050 and a twentieth exemplary apparatus 2000 in accordance with the teachings of the present invention. As illustrated in FIG. 42, an additional diode 871 is utilized to route current through the LED segment 175₁ during a zero crossing interval of the rectified AC voltage cycle. In this seventh sequence, assuming the capacitor 840 has been charged, during the zero crossing interval of Q1, current is typically sourced by the capacitor 840. During this zero crossing interval of Q1, capacitor 840 is discharging through diode 871, current source 815₁ is on and conducting, and LED segment 175₁ is in a series LED 140 current path, with current source 815₁ regulating the amount of current through this series LED 140 current path. Also during Q1, as the rectified AC voltage level becomes sufficient, current source 815₁ remains on and conducting, with LED segment 175₁ in the series LED 140 current path and receiving power from the rectified AC voltage. Subsequently in Q1, in the vicinity of about one-half of the peak rectified AC current/voltage, current source 815ₙ then conducts (with current source 815₁ being off), with LED segment 175₁ in the series LED 140 current path with capacitor 840, and the capacitor 840 is also being charged during this interval. This sequence may be reversed for Q2, or another sequence may be utilized. While illustrated using one LED segment 175₁, the concept of using one or more diodes 871 to route current through the same LED segments 175 during other parts of the AC cycle may be extended to additional LED segments 175 with corresponding current sources 815.

FIG. 43 is a flow diagram illustrating a fourth exemplary method in accordance with the teachings of the present invention, and provides a useful summary. The method begins, start step 905, with providing a (sufficient) voltage during the zero crossing interval of the (rectified) AC voltage, step 910, and providing for an LED segment 175 to be in an LED 140 current path and regulating the current through the LED 140 current path, step 915. Generally, the LED 140 current path is a series LED 140 current path, although as described above with reference to FIG. 41, the LED 140 current path may be parallel initially and terminally (in the vicinity of the zero crossing interval of the rectified AC voltage), and in series at other times. While the first part of step 915 may also be omitted when at least one LED segment 175 is always in the LED 140 current path (e.g., in FIG. 38), the current through the LED 140 current path should still be regulated. The current through the series LED 140 current path is monitored or sensed, step 920. When the measured or sensed current has not reached or is not about equal to a predetermined current level, step 925, the method iterates, returning to step 920. As mentioned above, the regulated, predetermined current levels may be sequential or non-sequential. When the measured or sensed current has reached or is about equal to a predetermined current level, step 925, the method provides for a next LED segment 175 (if available) to be in or out of the LED 140 current path and the current through the LED 140 current path is regulated, step 930. When there is additional LED segment(s) to be in or out of the LED 140 current path, step 935, the method iterates, returning to step 920. When there is a peak voltage or current level, step 940, a voltage regulator is charged, step 945. When the device is still on, i.e., the power has not been turned off, step 950, the method iterates, returning to step 910, and otherwise the method may end, return step 955. It should be noted that using the current regulation of the disclosure, the control methodology does not need to monitor whether the rectified AC voltage is in Q1 or Q2, and instead, the controller 120 (and 120A-120M) may make switching and regulation decisions based upon the sensed or measured current levels (and voltage levels, if desired), in any of the various LED 140 current paths. It should also be noted that the steps of the method of FIG. 43 may occur in a wide variety of orders, and depending on the implementation, various steps may be omitted or are optional.

FIG. 44 is a block and circuit diagram illustrating a first exemplary second current regulator 810A and/or current source 815A in accordance with the teachings of the present invention. As illustrated, a second current regulator 810A or a current source 815A may be implemented using a switch or transistor, illustrated as a bipolar junction transistor 310A, having its base coupled to a controller 120-120M, and further being coupled in any of the various configurations illustrated for a second current regulator 810 and/or current source 815, such as having its collector coupled to a cathode of an LED of an LED segment 175 and its emitter coupled to a current sensor 115, such as a resistor 165. Such a second current regulator 810A and/or current source 815A is controlled by the controller 120-120M using any of the various types and sequences of current regulation discussed herein.

FIG. 45 is a block and circuit diagram illustrating a second exemplary second current regulator 810B and/or current source 815B in accordance with the teachings of the present invention. As illustrated, a second current regulator 810B or a current source 815B may be implemented using a switch or transistor, illustrated as a field effect transistor 310B, coupled at its gate to an operational amplifier 180 which, in turn, is coupled through its non-inverting terminal to a controller 120-120M, and further being coupled in any of the various configurations illustrated for a second current regulator 810 and/or current source 815, such as having the drain of the field effect transistor 310B coupled to a cathode of an LED of an LED segment 175 and its source coupled to a current sensor 115, such as a resistor 165. Such a second current regulator 810B and/or current source 815B, coupled through the non-inverting terminal of the operational amplifier 180 to a controller 120-120M, is controlled by the controller 120-120M using any of the various types and sequences of current regulation discussed herein.

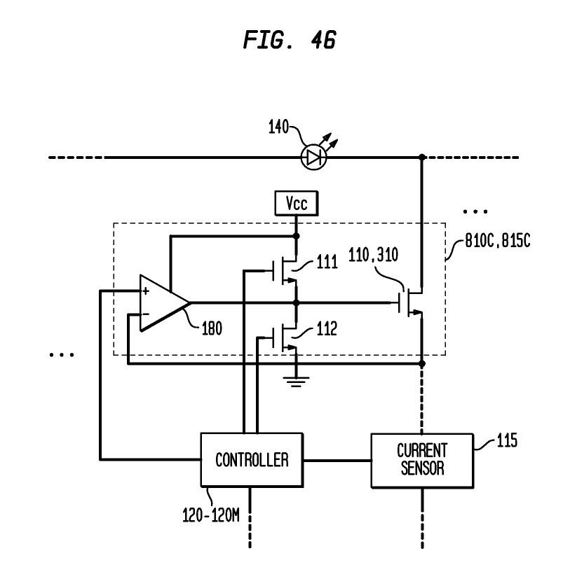

FIG. 46 is a block and circuit diagram illustrating a third exemplary second current regulator 810C and/or current source 815C in accordance with the teachings of the present invention. As illustrated, a second current regulator 810C or a current source 815C may be implemented as previously discussed and illustrated in FIG. 4, using a plurality of switches or transistors, illustrated as field effect transistor 110, coupled at its gate to an operational amplifier 180 which, in turn, is coupled through its non-inverting terminal to a controller 120-120M, and further being coupled in any of the various configurations illustrated for a second current regulator 810 and/or current source 815, such as having the drain of the field effect transistor 110 coupled to a cathode of an LED of an LED segment 175 and its source coupled to a current sensor 115, such as a resistor 165. The additional field effect transistors 111 and 112 may be utilized to provide additional or other control as previously discussed. Such a second current regulator 810C and/or current source 815C, coupled through the non-inverting terminal of the operational amplifier 180 to a controller 120-120M, is controlled by the controller 120-120M using any of the various types and sequences of current regulation discussed herein.

As indicated above, the controller 120 (and 120A-120M) may be any type of controller or processor, and may be embodied as any type of digital logic adapted to perform the functionality discussed herein. As the term controller or processor is used herein, a controller or processor may include use of a single integrated circuit (“IC”), or may include use of a plurality of integrated circuits or other components connected, arranged or grouped together, such as controllers, microprocessors, digital signal processors (“DSPs”), parallel processors, multiple core processors, custom ICs, application specific integrated circuits (“ASICs”), field programmable gate arrays (“FPGAs”), adaptive computing ICs, associated memory (such as RAM, DRAM and ROM), and other ICs and components. As a consequence, as used herein, the term controller or processor should be understood to equivalently mean and include a single IC, or arrangement of custom ICs, ASICs, processors, microprocessors, controllers, FPGAs, adaptive computing ICs, or some other grouping of integrated circuits which perform the functions discussed herein, with any associated memory, such as microprocessor memory or additional RAM, DRAM, SDRAM, SRAM, MRAM, ROM, FLASH, EPROM or EPROM. A controller or processor (such as controller 120 (and 120A-120I)), with its associated memory, may be adapted or configured (via programming, FPGA interconnection, or hard-wiring) to perform the methodology of the invention, as discussed above and below. For example, the methodology may be programmed and stored, in a controller 120 with its associated memory 465 (and/or memory 185) and other equivalent components, as a set of program instructions or other code (or equivalent configuration or other program) for subsequent execution when the controller or processor is operative (i.e., powered on and functioning). Equivalently, when the controller or processor may implemented in whole or part as FPGAs, custom ICs and/or ASICs, the FPGAs, custom ICs or ASICs also may be designed, configured and/or hard-wired to implement the methodology of the invention. For example, the controller or processor may be implemented as an arrangement of controllers, microprocessors, DSPs and/or ASICs, which are respectively programmed, designed, adapted or configured to implement the methodology of the invention, in conjunction with a memory 185.

The memory 185, 465, which may include a data repository (or database), may be embodied in any number of forms, including within any computer or other machine-readable data storage medium, memory device or other storage or communication device for storage or communication of information, currently known or which becomes available in the future, including, but not limited to, a memory integrated circuit (“IC”), or memory portion of an integrated circuit (such as the resident memory within a controller or processor IC), whether volatile or non-volatile, whether removable or non-removable, including without limitation RAM, FLASH, DRAM, SDRAM, SRAM, MRAM, FeRAM, ROM, EPROM or EPROM, or E²PROM any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment. In addition, such computer readable media includes any form of communication media which embodies computer readable instructions, data structures, program modules or other data in a data signal or modulated signal. The memory 185, 465 may be adapted to store various look up tables, parameters, coefficients, other information and data, programs or instructions (of the software of the present invention), and other types of tables such as database tables.

As indicated above, the controller or processor may be programmed, using software and data structures of the invention, for example, to perform the methodology of the present invention. As a consequence, the system and method of the present invention may be embodied as software which provides such programming or other instructions, such as a set of instructions and/or metadata embodied within a computer readable medium, discussed above. In addition, metadata may also be utilized to define the various data structures of a look up table or a database. Such software may be in the form of source or object code, by way of example and without limitation. Source code further may be compiled into some form of instructions or object code (including assembly language instructions or configuration information). The software, source code or metadata of the present invention may be embodied as any type of code, such as C, C++, SystemC, LISA, XML, Java, Brew, SQL and its variations (e.g., SQL 99 or proprietary versions of SQL), DB2, Oracle, or any other type of programming language which performs the functionality discussed herein, including various hardware definition or hardware modeling languages (e.g., Verilog, VHDL, RTL) and resulting database files (e.g., GDSII). As a consequence, a “construct”, “program construct”, “software construct” or “software”, as used equivalently herein, means and refers to any programming language, of any kind, with any syntax or signatures, which provides or can be interpreted to provide the associated functionality or methodology specified (when instantiated or loaded into a processor or computer and executed, including the controller 120, for example).

The software, metadata, or other source code of the present invention and any resulting bit file (object code, database, or look up table) may be embodied within any tangible storage medium, such as any of the computer or other machine-readable data storage media, as computer-readable instructions, data structures, program modules or other data, such as discussed above with respect to the memory 185, 465, e.g., a floppy disk, a CDROM, a CD-RW, a DVD, a magnetic hard drive, an optical drive, or any other type of data storage apparatus or medium, as mentioned above.

Numerous advantages of the exemplary embodiments of the present invention, for providing power to non-linear loads such as LEDs, are readily apparent. The various exemplary embodiments supply AC line power to one or more LEDs, including LEDs for high brightness applications, while simultaneously providing an overall reduction in the size and cost of the LED driver and increasing the efficiency and utilization of LEDs. Exemplary apparatus, method and system embodiments adapt and function properly over a relatively wide AC input voltage range, while providing the desired output voltage or current, and without generating excessive internal voltages or placing components under high or excessive voltage stress. In addition, various exemplary apparatus, method and system embodiments provide significant power factor correction when connected to an AC line for input power. Lastly, various exemplary apparatus, method and system embodiments provide the capability for controlling brightness, color temperature and color of the lighting device.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

As used herein for purposes of the present invention, the term “LED” and its plural form “LEDs” should be understood to include any electroluminescent diode or other type of carrier injection- or junction-based system which is capable of generating radiation in response to an electrical signal, including without limitation, various semiconductor- or carbon-based structures which emit light in response to a current or voltage, light emitting polymers, organic LEDs, and so on, including within the visible spectrum, or other spectra such as ultraviolet or infrared, of any bandwidth, or of any color or color temperature.

As used herein, the term “AC” denotes any form of time-varying current or voltage, including without limitation alternating current or corresponding alternating voltage level with any waveform (sinusoidal, sine squared, rectified, rectified sinusoidal, square, rectangular, triangular, sawtooth, irregular, etc.) and with any DC offset and may include any variation such as chopped or forward- or reverse-phase modulated alternating current or voltage, such as from a dimmer switch. As used herein, the term “DC” denotes both fluctuating DC (such as is obtained from rectified AC) and a substantially constant or constant voltage DC (such as is obtained from a battery, voltage regulator, or power filtered with a capacitor).

In the foregoing description of illustrative embodiments and in attached figures where diodes are shown, it is to be understood that synchronous diodes or synchronous rectifiers (for example relays or MOSFETs or other transistors switched off and on by a control signal) or other types of diodes may be used in place of standard diodes within the scope of the present invention. Exemplary embodiments presented here generally generate a positive output voltage with respect to ground; however, the teachings of the present invention apply also to power converters that generate a negative output voltage, where complementary topologies may be constructed by reversing the polarity of semiconductors and other polarized components.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims

1. A method of providing power to a plurality of light emitting diodes couplable to receive an AC voltage, the plurality of light emitting diodes coupled in series to form a plurality of segments of light emitting diodes each comprising at least one light emitting diode, the plurality of segments of light emitting diodes coupled to a plurality of current regulators, the method comprising:
monitoring and regulating a current level through a series light emitting diode current path;
providing for a first segment of light emitting diodes to be in or out of the series light emitting diode current path at about a first predetermined current level or until the current level has reached about the first predetermined current level; and
providing for a second segment of light emitting diodes to be in or out of the series light emitting diode current path at about a second predetermined current level or until the current level has reached about the second predetermined current level.

2. The method of claim 1, further comprising:
during a zero crossing interval of the AC voltage, using a voltage regulator, providing a voltage or a current sufficient for at least one light emitting diode to be on and conducting.

3. The method of claim 2, further comprising:
during a peak interval of the AC voltage, charging the voltage regulator.

4. The method of claim 2, wherein the voltage regulator comprises at least one capacitor coupled to a diode.

5. The method of claim 1, further comprising:
regulating the current level of the series light emitting diode current path to be less than or equal to a maximum current level.

6. The method of claim 1, wherein the steps of providing for the first and second segments of light emitting diodes to be in or out of the series light emitting diode current path further comprise:
turning off a first current regulator coupled to the first segment of light emitting diodes; and
turning on a second current regulator coupled to the second segment of light emitting diodes or coupled to the first segment of light emitting diodes.

7. The method of claim 6, wherein the first current regulator comprises a first current source and the second current regulator comprises a second current source.

8. The method of claim 6, further comprising:
controlling or setting the first current regulator at about the first predetermined current level; and
controlling or setting the second current regulator at about the second predetermined current level.

9. The method of claim 1, further comprising:
providing for the first, the second or a third segment of light emitting diodes to be in or out of the series light emitting diode current path at about a third predetermined current level or until the current level has reached about the third predetermined current level.

10. The method of claim 9, wherein the first, second and third predetermined current levels are non-sequential current levels.

11. The method of claim 9, wherein the steps of providing for the first, second and third segments of light emitting diodes to be in or out of the series light emitting diode current path further comprise:
regulating the current level of the series light emitting diode current path at about the first predetermined current level or until the current level has reached about the first predetermined current level, the series light emitting diode current path comprising the first segment of light emitting diodes and not the second segment of light emitting diodes;
regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level; and
regulating the current level of the series light emitting diode current path at about the third predetermined current level or until the current level has reached about the third predetermined current level, the series light emitting diode current path comprising the third segment of light emitting diodes coupled in series to the second segment of light emitting diodes coupled in series to the first segment of light emitting diodes, wherein the third predetermined current level is greater than the first predetermined current level.

12. The method of claim 9, wherein the steps of providing for the first, second and third segments of light emitting diodes to be in or out of the series light emitting diode current path further comprise:
regulating the current level of the series light emitting diode current path at about the first predetermined current level or until the current level has reached about the first predetermined current level, the series light emitting diode current path comprising the first segment of light emitting diodes and not the second segment of light emitting diodes;
regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is greater than the first predetermined current level; and
regulating the current level of the series light emitting diode current path at about the third predetermined current level or until the current level has reached about the third predetermined current level, the series light emitting diode current path comprising the third segment of light emitting diodes coupled in series to the second segment of light emitting diodes, wherein the third predetermined current level is greater than the second predetermined current level.

13. The method of claim 1, wherein the steps of providing for the first and second segments of light emitting diodes to be in or out of the series light emitting diode current path further comprise:
regulating the current level of the series light emitting diode current path at about the first predetermined current level or until the current level has reached about the first predetermined current level, the series light emitting diode current path comprising the first segment of light emitting diodes without the second segment of light emitting diodes; and
regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level.

14. The method of claim 1, wherein the steps of providing for the first and second segments of light emitting diodes to be in or out of the series light emitting diode current path further comprise:
regulating the current level of the series light emitting diode current path at about the first predetermined current level or until the current level has reached about the first predetermined current level, the series light emitting diode current path comprising the first segment of light emitting diodes without the second segment of light emitting diodes; and
regulating the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is higher than the first predetermined current level.

15. The method of claim 1, wherein the steps of providing for the first and second segments of light emitting diodes to be in or out of the series light emitting diode current path further comprise:
turning off a first current regulator coupled to the first segment of light emitting diodes, the first current regulator providing for a maximum current at about the first predetermined current level; and
turning on a second current regulator coupled to the second segment of light emitting diodes, the second segment of light emitting diodes coupled in series to the first segment of light emitting diodes in the series light emitting diode current path, the second current regulator providing for a maximum current at the second predetermined current level, wherein the second predetermined current level is lower than the first predetermined current level.

16. The method of claim 1, wherein the steps of providing for the first and second segments of light emitting diodes to be in or out of the series light emitting diode current path further comprise:
turning off a first current regulator coupled to the first segment of light emitting diodes, the first current regulator providing for a maximum current at about the first predetermined current level; and
turning on a second current regulator coupled to the second segment of light emitting diodes, the second segment of light emitting diodes coupled in series to the first segment of light emitting diodes in the series light emitting diode current path, the second current regulator providing for a maximum current at the second predetermined current level, wherein the second predetermined current level is higher than the first predetermined current level.

17. The method of claim 1, further comprising:
providing for a next segment of light emitting diodes to be in or out of the series light emitting diode current path at about a next predetermined current level or until the current level has reached about the next predetermined current level.

18. The method of claim 1, wherein providing for the first segment of light emitting diodes to be in or out of the series light emitting diode current path and providing for the second segment of light emitting diodes to be in or out of the series light emitting diode current path occurs in a first order during a first part of an AC voltage interval and in a second order during a second part of the AC voltage interval, wherein the second order is the reverse of the first order.

19. The method of claim 1, further comprising:
determining whether the AC voltage is phase modulated; and
when the AC voltage is phase modulated, providing for the first segment of light emitting diodes to be in or out of the series light emitting diode current path corresponding to a phase modulated AC current level.

20. The method of claim 19, further comprising:
when the AC voltage is phase modulated, maintaining a parallel light emitting diode current path concurrently with providing for the second segment of light emitting diodes to be in or out of the series light emitting diode current path.

21. The method of claim 1, further comprising:
providing for the first segment of light emitting diodes to be in a first series light emitting diode current path; and
providing for the second segment of light emitting diodes to be in a second series light emitting diode current path in parallel with the first series light emitting diode current path.

22. The method of claim 1, further comprising:
during a first part of an AC voltage interval, providing for the first segment of light emitting diodes to be in a first series light emitting diode current path and providing for the second segment of light emitting diodes to be in a second series light emitting diode current path in parallel with the first segment of light emitting diodes;
with an increasing voltage level during the first part of the AC voltage interval, providing for a third segment of light emitting diodes to be in the first series light emitting diode current path and providing for a fourth segment of light emitting diodes to be in a third series light emitting diode current path in parallel with the third segment of light emitting diodes;
with an increasing voltage level during the first part of the AC voltage interval, providing for the second segment of light emitting diodes to be in the first series light emitting diode current path; and
with an increasing voltage level during the first part of the AC voltage interval, providing for the fourth segment of light emitting diodes to be in the first series light emitting diode current path.

23. The method of claim 22, further comprising:
with a decreasing voltage level during a second part of the AC voltage interval, providing for the fourth segment of light emitting diodes to be in parallel with the third segment of light emitting diodes;
with a decreasing voltage level during the second part of the AC voltage interval, providing for the second segment of light emitting diodes to be in parallel with the first segment of light emitting diodes; and
with a decreasing voltage level during the second part of the AC voltage interval, providing for the third and fourth segments of light emitting diodes to be out of the first series light emitting diode current path.

24. The method of claim 1, wherein selected segments of light emitting diodes of the plurality of segments of light emitting diodes each comprise light emitting diodes having light emission spectra of different colors or wavelengths.

25. An apparatus for providing power to a plurality of light emitting diodes couplable to receive an AC voltage, the plurality of light emitting diodes coupled in series to form a plurality of segments of light emitting diodes each comprising at least one light emitting diode, the apparatus further couplable to a current sensor, the apparatus comprising:
a first current regulator coupled to a first segment of light emitting diodes of the plurality of segments of light emitting diodes;
a second current regulator coupled to a second segment of light emitting diodes of the plurality of segments of light emitting diodes; and
a controller coupled to the first and second current regulators and couplable to the current sensor, the controller to monitor a current level through a series light emitting diode current path, to provide for the first segment of light emitting diodes to be in or out of the series light emitting diode current path at about a first predetermined current level or until the current level has reached about the first predetermined current level; and to provide for the second segment of light emitting diodes to be in or out of the series light emitting diode current path at about a second predetermined current level or until the current level has reached about the second predetermined current level.

26. The apparatus of claim 25, further comprising:
a voltage regulator to provide a voltage or a current sufficient for at least one light emitting diode to be on and conducting during a zero crossing interval of the AC voltage.

27. The apparatus of claim 26, wherein the voltage regulator is charged during a peak interval of the AC voltage.

28. The apparatus of claim 26, wherein the voltage regulator comprises at least one capacitor coupled to a diode.

29. The apparatus of claim 26, wherein the voltage regulator comprises:
a first capacitor coupled to the first or second segment of light emitting diodes;
a first diode coupled to the first capacitor;
a second capacitor coupled in series to the first diode and the first capacitor; and
a second diode coupled to the second capacitor and to the first or second segment of light emitting diodes.

30. The apparatus of claim 26, wherein the voltage regulator is coupled to the first or second current regulator.

31. The apparatus of claim 25, wherein the controller further is to regulate the current level of the series light emitting diode current path to be less than or equal to a maximum current level.

32. The apparatus of claim 25, wherein the controller further is to provide for the first and second segments of light emitting diodes to be in or out of the series light emitting diode current path by respectively turning off or on the first current regulator and turning on or off the second current regulator.

33. The apparatus of claim 25, wherein the first current regulator comprises a first current source and the second current regulator comprises a second current source.

34. The apparatus of claim 33, wherein the first current source and the second current source each comprise a transistor.

35. The apparatus of claim 33, wherein the first current source and the second current source each comprise an operational amplifier coupled to a transistor.

36. The apparatus of claim 33, wherein the first current source and the second current source each comprise an operational amplifier coupled to a plurality of transistors.

37. The apparatus of claim 25, wherein the controller further is to control or set the first current regulator at about the first predetermined current level and control or set the second current regulator at about the second predetermined current level.

38. The apparatus of claim 25, further comprising:
a third current regulator coupled to a third segment of light emitting diodes of the plurality of segments of light emitting diodes;
wherein the controller further is to provide for the first, second or third segment of light emitting diodes to be in or out of the series light emitting diode current path at about a third predetermined current level or until the current level has reached about the third predetermined current level.

39. The apparatus of claim 38, wherein the first, second and third predetermined current levels are non-sequential current levels.

40. The apparatus of claim 38, wherein the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level; and to turn on the third current regulator and turn off the second current regulator to control the current level of the series light emitting diode current path at about the third predetermined current level or until the current level has reached about the third predetermined current level, the series light emitting diode current path comprising the third segment of light emitting diodes coupled in series to the second segment of light emitting diodes coupled in series to the first segment of light emitting diodes, wherein the third predetermined current level is greater than the first predetermined current level.

41. The apparatus of claim 38, wherein the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is greater than the first predetermined current level; and to turn on the third current regulator and turn off the second current regulator to control the current level of the series light emitting diode current path at about the third predetermined current level or until the current level has reached about the third predetermined current level, the series light emitting diode current path comprising the third segment of light emitting diodes coupled in series to the second segment of light emitting diodes coupled in series to the first segment of light emitting diodes, wherein the third predetermined current level is greater than the second predetermined current level.

42. The apparatus of claim 25, wherein the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; and to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is lower than the first predetermined current level.

43. The apparatus of claim 25, wherein the controller further is to turn on the first current regulator to control the current level of the series light emitting diode current path at about the first predetermined current level or until the current level has reached about the first predetermined current level, the series light emitting diode current path comprising the first segment of light emitting diodes and not the second segment of light emitting diodes; and to turn off the first current regulator and turn on the second current regulator to control the current level of the series light emitting diode current path at about the second predetermined current level or until the current level has reached about the second predetermined current level, the series light emitting diode current path comprising the second segment of light emitting diodes coupled in series to the first segment of light emitting diodes, wherein the second predetermined current level is greater than the first predetermined current level.

44. The apparatus of claim 25, wherein the controller further is to provide for a next segment of light emitting diodes to be in or out of the series light emitting diode current path at about a next predetermined current level or until the current level has reached about the next predetermined current level.

45. The apparatus of claim 25, wherein the controller further is to provide for the first segment of light emitting diodes to be in or out of the series light emitting diode current path and provide for the second segment of light emitting diodes to be in or out of the series light emitting diode current path in a first order during a first part of an AC voltage interval and in a second order during a second part of the AC voltage interval, wherein the second order is the reverse of the first order.

46. The apparatus of claim 25, wherein the controller further is to determine whether the AC voltage is phase modulated; and when the AC voltage is phase modulated, to provide for the first segment of light emitting diodes to be in or out of the series light emitting diode current path corresponding to a phase modulated AC current level.

47. The apparatus of claim 41, wherein the controller further is to provide for a parallel light emitting diode current path concurrently with providing for the first or second segment of light emitting diodes to be in or out of the series light emitting diode current path.

48. The apparatus of claim 25, wherein the controller further is to provide for the first segment of light emitting diodes to be in a first series light emitting diode current path; and to provide for the second segment of light emitting diodes to be in a second series light emitting diode current path in parallel with the first series light emitting diode current path.

49. The apparatus of claim 25, further comprising:
a rectifier couplable to receive the AC voltage.

50. The apparatus of claim 25, wherein selected segments of light emitting diodes of the plurality of segments of light emitting diodes each comprise light emitting diodes having light emission spectra of different colors or wavelengths.

51. The apparatus of claim 50, wherein the controller further is to selectively provide for the selected segments of light emitting diodes to be in or out of the series light emitting diode current path to provide a corresponding lighting effect.

52. The apparatus of claim 50, wherein the controller further is to selectively provide for the selected segments of light emitting diodes to be in or out of the series light emitting diode current path to provide a corresponding color temperature.

53. The apparatus of claim 25, wherein the apparatus operates at about a rectified AC voltage frequency selected from the group consisting of: 100 Hz, 120 Hz, 300 Hz, 360 Hz, 400 Hz, and combinations thereof.

54. The apparatus of claim 25, further comprising:
a plurality of phosphor coatings or layers, each phosphor coating or layer coupled to a corresponding light emitting diode of the plurality of light emitting diodes, each phosphor coating or layer having a luminous decay time constant between about 2 to 3 msec.

55. The apparatus of claim 25, wherein the apparatus is further couplable to a third segment of light emitting diodes of the plurality of segments of light emitting diodes and to a fourth segment of light emitting diodes of the plurality of segments of light emitting diodes, the apparatus further comprising:
a plurality of switches, each switch of the plurality of switches coupled to at least one of the first, second, third or fourth first segments of light emitting diodes and coupled to the controller;
wherein during a first part of an AC voltage interval, the controller is to provide for the first segment of light emitting diodes to be in a first series light emitting diode current path and provide for the second segment of light emitting diodes to be in a second series light emitting diode current path in parallel with the first segment of light emitting diodes; with an increasing voltage level during the first part of the AC voltage interval, the controller is to provide for the third segment of light emitting diodes to be in the first series light emitting diode current path and providing for the fourth segment of light emitting diodes to be in a third series light emitting diode current path in parallel with the third segment of light emitting diodes; with an increasing voltage level during the first part of the AC voltage interval, the controller is to provide for the second segment of light emitting diodes to be in the first series light emitting diode current path; and with an increasing voltage level during the first part of the AC voltage interval, the controller is to provide for the fourth segment of light emitting diodes to be in the first series light emitting diode current path.

56. The apparatus of claim 55, wherein with a decreasing voltage level during a second part of the AC voltage interval, the controller is to provide for the fourth segment of light emitting diodes to be in parallel with the third segment of light emitting diodes; with a decreasing voltage level during the second part of the AC voltage interval, the controller is to provide for the second segment of light emitting diodes to be in parallel with the first segment of light emitting diodes; and with a decreasing voltage level during the second part of the AC voltage interval, the controller is to provide for the third and fourth segments of light emitting diodes to be out of the first series light emitting diode current path.

57. An apparatus couplable to receive an AC voltage, the apparatus comprising:
a plurality of light emitting diodes coupled in series to form at least one segment of light emitting diodes;
a first current regulator coupled at a light emitting diode cathode of the at least one segment of light emitting diodes;
a second current regulator coupled at a light emitting diode anode of the at least one segment of light emitting diodes;
a current sensor;
a voltage regulator to provide a voltage or a current sufficient for at least one light emitting diode to be on and conducting; and
a controller coupled to the first and second current regulators and to the current sensor, the controller to monitor a current level through the at least one segment of light emitting diodes, to turn on the second current regulator to provide current through the at least one segment of light emitting diodes and to charge the voltage regulator, and to turn on the first current regulator to provide current through the at least one segment of light emitting diodes and to discharge the voltage regulator.
